(19) United States
(12) Patent Application Publication
(10) Pub. No.: US 2014/0184484 A1
(43) Pub. Date: Jul. 3, 2014

(54) DISPLAY DEVICE

(71) Applicant: Semiconductor Energy Laboratory Co., Ltd., Atsugi-shi (JP)

(72) Inventors: Hiroyuki MIYAKE, Atsugi (JP); Hajime KIMURA, Atsugi (JP); Yasuo NAKAMURA, Machida (JP); Eriko NISHIDA, Atsugi (JP)

(73) Assignee: Semiconductor Energy Laboratory Co., Ltd., Atsugi-shi (JP)

(21) Appl. No.: 14/138,970

(22) Filed: Dec. 23, 2013

(30) Foreign Application Priority Data
Dec. 28, 2012 (JP) 2012-286865

(51) Int. Cl. G09G 3/36

(52) U.S. Cl. CPC G09G 3/3611
USPC 345/87

(57) ABSTRACT

To provide a novel display device where display quality does not deteriorate. The display device includes a display portion configured to display a still image at a frame frequency of 30 Hz or lower. The display portion includes a driver circuit, a plurality of wirings, and a pixel portion. The pixel portion comprises a plurality of pixels. Each of the plurality of pixels comprises a transistor, a display element, and a capacitor. A channel is formed in an oxide semiconductor layer included in the transistor. A gate of the transistor is electrically connected to one of the plurality of wirings. The driver circuit performs scanning where the plurality of wirings in one of odd-numbered rows and even-numbered rows are sequentially selected and scanning where the plurality of wirings in the other of the odd-numbered rows and the even-numbered rows are sequentially selected.

### BACKGROUND OF THE INVENTION

1. Field of the Invention

The present invention relates to an object, a method, a manufacturing method, a process, a machine, manufacture, or a composition of matter. In particular, the present invention relates to, for example, a semiconductor device, a display device, a light-emitting device, a driving method thereof, or a manufacturing method thereof. In particular, the present invention relates to a semiconductor device including an oxide semiconductor, a display device including an oxide semiconductor, or a light-emitting device including an oxide semiconductor, for example.

2. Description of the Related Art

The information revolution has progressed rapidly with technological innovation, mainly with innovation in information processing, and the variety of uses of displays, for example, for personal computers and mobile devices has increased at workplaces and homes. Accordingly, the frequency and time of use of displays have increased dramatically.

There have been demands for higher resolution and lower power consumption of small and middle-sized displays used for mobile devices and the like.

For example, a conventional liquid crystal display device includes a transistor using amorphous silicon, polycrystalline silicon, or the like. Since the off-state current of such a transistor is about 1 pA, display can be held only for 20 ms to 30 ms. Thus, images need to be written 60 times or more per second. Such write operation is perceived as a flicker by a user and might cause eyestrain.

Moreover, a liquid crystal display device using an oxide semiconductor has been developed in recent years (see Patent Document 1).
[Patent Document 1] Japanese Published Patent Application No. 2011-237760

### SUMMARY OF THE INVENTION

In a general active matrix display device, a voltage applied to a pixel is required to be held without decay until the next write (refresh) operation.

However, a voltage corresponding to a signal written into each pixel changes with time. Once the amount of change in voltage written into a pixel exceeds an amount corresponding to the allowable variation range of gray level in one image (still image), a user perceives a flicker of the image, resulting in a reduction in display quality.

In view of the above, an object of one embodiment of the present invention is to provide a novel eye-friendly display device or the like. An object of one embodiment of the present invention is to provide a novel display device or the like causing less eye fatigue. An object of one embodiment of the present invention is to provide a novel display device or the like without deterioration of display quality. An object of one embodiment of the present invention is to provide a novel display device or the like with little influence of off-state current. An object of one embodiment of the present invention is to provide a novel display device or the like with little influence of display degradation. An object of one embodiment of the present invention is to provide a novel display device or the like with little influence of display flickers. An object of one embodiment of the present invention is to provide a novel display device or the like with less variation in display luminance. An object of one embodiment of the present invention is to provide a novel display device or the like capable of displaying a clear still image. An object of one embodiment of the present invention is to provide a novel display device or the like with low power consumption. An object of one embodiment of the present invention is to provide a novel display device or the like with little deterioration of a transistor. An object of one embodiment of the present invention is to provide a novel display device or the like including a transistor with low off-state current. An object of one embodiment of the present invention is to provide a novel display device or the like.

Note that the descriptions of these problems do not disturb the existence of other problems. Note that in one embodiment of the present invention, there is no need to achieve all the objects. Other objects will be apparent from and can be derived from the description of the specification, the drawings, the claims, and the like.

One embodiment of the present invention is a display device including a display portion configured to display a still image at a frame frequency of 30 Hz or lower. The display portion includes a driver circuit, a plurality of wirings, and a pixel portion. The pixel portion comprises a plurality of pixels. Each of the plurality of pixels comprises a transistor, a display element, and a capacitor. A channel is formed in an oxide semiconductor layer included in the transistor. A gate of the transistor is electrically connected to one of the plurality of wirings. The driver circuit performs scanning where the plurality of wirings in one of odd-numbered rows and even-numbered rows are sequentially selected and scanning where the plurality of wirings in the other of the odd-numbered rows and the even-numbered rows are sequentially selected.

With one embodiment of the present invention, a novel display device with high display quality can be provided.

### BRIEF DESCRIPTION OF THE DRAWINGS

FIGS. 1A to 1C illustrate a structure of a display device of an embodiment.

FIG. 2 illustrates a structure of a display device of an embodiment.

FIG. 3 is a timing chart showing an operation example of a display device of an embodiment.

FIG. 4 illustrates a structure of a display device of an embodiment.

FIG. 5 illustrates a structure of a display device of an embodiment.

FIG. 6 illustrates a structure of a display device of an embodiment.

FIG. 7 illustrates a structure of a display device of an embodiment.

FIG. 8 illustrates a structure of a display device of an embodiment.

FIG. 9 is a plan view of a pixel.

FIG. 10 is a block diagram illustrating a structure of a display device of an embodiment.

FIG. 11 shows emission spectra of a light source in a light supply portion.

FIG. 12 illustrates a structure of a display device of an embodiment.

FIG. 13A is a block diagram and FIG. 13B is a schematic diagram each illustrating a structure of a display device of an embodiment.

FIGS. 14A to 14C illustrate a structure of a shift register.

FIG. 15 is a timing chart of a shift register.

FIG. 16 is a timing chart of a shift register.

FIGS. 17A and 17B illustrate a structure of a display device of an embodiment.

FIGS. 18A and 18B illustrate a touch screen.

FIG. 19 illustrates a touch screen.

FIGS. 20A and 20B illustrate a structure example of a transistor.

FIGS. 21A to 21D illustrate an example of a method for manufacturing a transistor.

FIGS. 22A to 22C illustrate structure examples of a transistor.

FIGS. 23A to 23C illustrate structure examples of a transistor.

FIGS. 24A and 24B illustrate structure examples of a transistor.

FIGS. 25A to 25C illustrate electronic devices.

FIGS. 26A to 26D illustrate display of an image on a display device of an embodiment of the present invention.

FIG. 27 illustrates a display module.

FIGS. 28A and 28B illustrate nanobeam electron diffraction patterns of an oxide semiconductor films.

FIGS. 29A and 29B illustrate an example of a transmission electron diffraction measurement apparatus.

FIG. 30 illustrates an example of a structure analysis by transmission electron diffraction measurement.

### DETAILED DESCRIPTION OF THE INVENTION

Hereinafter, embodiments will be described with reference to drawings. However, the embodiments can be implemented with various modes. It will be readily appreciated by those skilled in the art that modes and details can be changed in various ways without departing from the spirit and scope of the present invention. Thus, the present invention should not be interpreted as being limited to the following description of the embodiments.

In the reference drawings, the size, the thickness of layers, and/or regions may be exaggerated for clarity in some cases. Therefore, embodiments of the present invention are not limited to such scales. Note that diagrams are perspective views of ideal examples, and shapes or values are not limited to those illustrated in the diagrams. For example, variation in signal, voltage, or current due to noise or difference in timing can be included.

Note that in this specification and the like, a transistor is an element having at least three terminals of a gate, a drain, and a source. In addition, the transistor has a channel region between a drain (a drain terminal, a drain region, or a drain electrode) and a source (a source terminal, a source region, or a source electrode), and current can flow through the drain, the channel region, and the source.

Here, since the source and the drain of the transistor change depending on the structure, the operating condition, and the like of the transistor, it is difficult to define which is a source or a drain. Thus, a portion which functions as the source and a portion which functions as the drain are not called a source and a drain and one of the source and the drain is referred to as a first electrode and the other thereof is referred to as a second electrode in some cases.

In this specification and the like, ordinal numbers such as first, second, and third are used in order to avoid confusion among components, and the terms do not limit the components numerically.

In this specification and the like, when it is described that “A and B are connected to each other”, the case where A and B are electrically connected to each other is included in addition to the case where A and B are directly connected to each other. Here, the description “A and B are electrically connected to each other” means the following case: when an object having any electrical function exists between A and B, an electric signal can be transmitted and received between A and B.

In this specification and the like, terms for describing arrangement, such as “over” and “under”, are used for convenience to indicate a positional relation between components with reference to drawings. Further, a positional relation between components is changed as appropriate in accordance with a direction in which each component is described. Thus, there is no limitation to terms used in this specification, and description can be made appropriately depending on the situation.

Note that positional relations of circuit blocks in block diagrams are specified for description, and even in the case where different circuit blocks have different functions, they may be provided in an actual circuit or region so that different functions are achieved in the same circuit or region. The functions of circuit blocks in block diagrams are specified for description, and even in the case where one circuit block is illustrated, blocks might be provided in an actual circuit or an actual region so that processing performed by one circuit block is performed by a plurality of circuit blocks.

Note that a pixel corresponds to a display unit controlling the brightness of one color component (e.g., any one of R (red), G (green), and B (blue)). Therefore, in a color display device, the minimum display unit of a color image is composed of three pixels of an R pixel, a G pixel and a B pixel. Note that the color of the color elements is not necessarily of three varieties and may be of three or more varieties or may include a color other than RGB.

Note that the display devices include display elements in this specification and the like. Examples of display elements are liquid crystal elements (also referred to as liquid crystal display elements), light-emitting elements (also referred to as light-emitting display elements), electrophoretic elements, and electrowetting elements. A light emitting element includes, in its scope, an element whose luminance is controlled by current or voltage, and specifically includes an inorganic electroluminescent (EL) element, an organic EL element, and the like. Furthermore, a display medium whose contrast is changed by an electric effect, such as electronic ink, can be used.

The display device includes in its category a panel in which a display element is sealed and a module in which an IC including a controller or the like is mounted on the panel. Furthermore, an element substrate, which corresponds to one embodiment before the display element is completed in a manufacturing process of the display device, is provided with a means for supplying current to the display element in each of a plurality of pixels. Specifically, the element substrate may be in a state in which only a pixel electrode of the display element is provided, a state after formation of a conductive film to be a pixel electrode and before etching of the conductive film to form the pixel electrode, or any other states.

Note that a display device in this specification and the like refers to an image display device or a light source (including a lighting device). Further, the display device includes any of the following modules in its category: a module including a connector such as an flexible printed circuit (FPC), a tape automated bonding (TAB) tape, or a tape carrier package (TCP); a module having a TAB tape provided with a printed wiring board at the end thereof; and a module having an integrated circuit (IC) directly mounted on a display panel (also referred to as display portion) by a chip-on-glass (COG) method.

### Embodiment 1

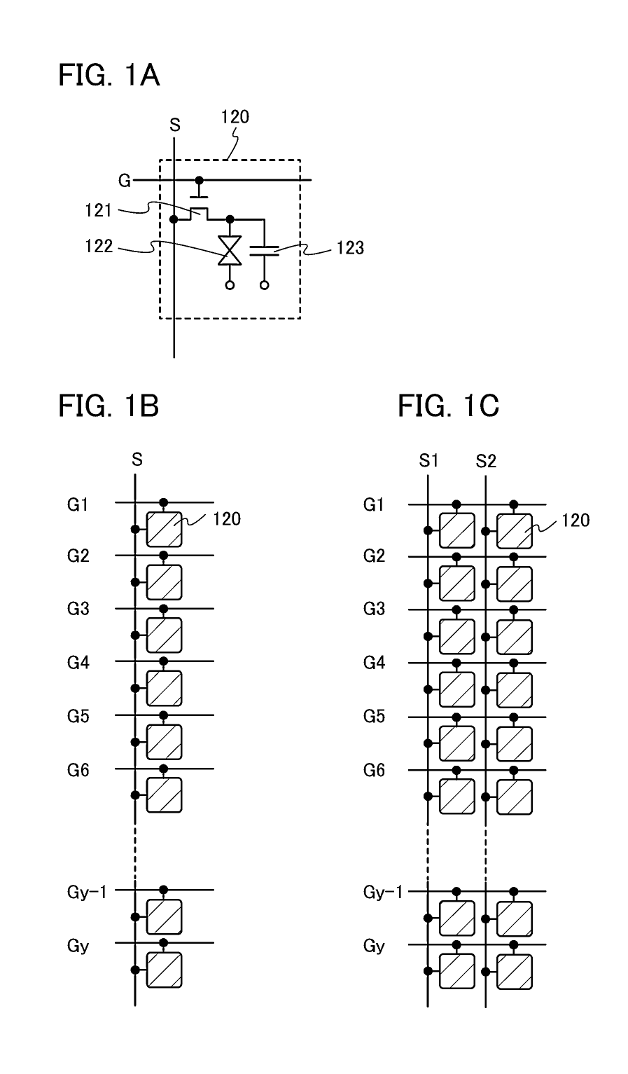

In this embodiment, a structure and a driving method of a display portion included in the display device of one embodiment of the present invention will be described with reference to FIGS. 1A to 1C, FIG. 2, FIG. 3, FIG. 4, FIG. 5, FIG. 6, FIG. 7, FIG. 8, and FIG. 9. Note that in this embodiment, as a display device, a liquid crystal display device including a liquid crystal element is described.

FIG. 1A shows one example of an equivalent circuit of a pixel provided in a display portion. As illustrated in FIG. 1A, the pixels 120 includes a transistor 121, a display element 122, and a capacitor 123. In addition to the transistor, the display element, and the capacitor, the pixel 120 may also include another transistor, a diode, a resistor, another capacitor, an inductor, and/or the like.

As illustrated in FIG. 1A, a gate of a transistor 121 is electrically connected to a first wiring G. One of a source and a drain of the transistor 121 is electrically connected to a second wiring S. The other of the source and the drain of the transistor 121 is electrically connected to a first electrode of a display element 122. A first driving signal is input to the first wiring G. The first driving signal is a scan signal, for example. A second driving signal is input to the second wiring S. The second driving signal is a data signal, for example.

The display element 122 can be a liquid crystal element or the like, for example. The liquid crystal element includes a first electrode, a second electrode, and a liquid crystal layer containing a liquid crystal material to which a voltage between the first electrode and the second electrode is applied. The transmittance of the liquid crystal element is changed in accordance with orientation of liquid crystal molecules that changes depending on a voltage applied between the first electrode and the second electrode. Thus, the transmittance is controlled by the potential of the second driving signal, so that an image can be displayed.

The transistor 121 controls whether to apply the potential of the first wiring G to the first electrode of the display element 122. As the transistor 121, a transistor including an oxide semiconductor can be used. Since the off-state current of this transistor is extremely low, the off-state current of the transistor is almost negligible. The transistor including an oxide semiconductor will be described in detail in a latter embodiment. However, one embodiment of the present invention is not limited thereto, depending on the case or the circumstance, the transistor 121 may be a transistor that does not include an oxide semiconductor, for example, a transistor including silicon.

The off-state current of the transistor including an oxide semiconductor is as extremely low as less than 1 zA. Using the transistor as the transistor 121 enables prevention of a leakage through the transistor 121. In this case, the pixel 120 can hold a signal for a long period of time. In the case of continuously displaying one image (still image), the frequency of rewriting the image can be reduced. For example, an image on a display portion is rewritten at a frequency of more than or equal to once per day and less than 0.1 times per second, preferably more than or equal to once per hour and less than once per second. This enables easy-on-the-eyes display.

Note that a method for driving the display device of one embodiment of the present invention is described.

FIG. 1B shows the second wiring S to which a plurality of pixels 120 are electrically connected. In one frame period, in the plurality of pixels 120, pixels in all of odd-numbered rows (or even-numbered rows) are sequentially selected, and an image signal with one polarity is written to the pixels; then, pixels in all of even-numbered rows (or odd-numbered rows) are sequentially selected, and an image signal with the other polarity is written to the pixels. In this embodiment, display at a frame frequency of 30 Hz or less, preferably 0.2 Hz or less will be described.

Note that it is possible that immediately after input of a signal to the pixels in all of the odd-numbered rows (or even-numbered rows), input of a signal to the pixels in all of the even-numbered rows (or odd-numbered rows) be started. This enables a reduction in display unevenness such as a smear. Note that an embodiment of the present invention is not limited thereto. For example, it is also possible that a certain period of time is set to pass after input of a signal to the pixels in all of the odd-numbered rows (or even-numbered rows), and then input of a signal to the pixels in all of the even-numbered rows (or odd-numbered rows) be started. The certain period of time enables a reduction in a frequency of inputting the signal to the pixels. Therefore, power consumption can be reduced. When a transistor with an active layer containing an oxide semiconductor is used, an influence of flickers of display can be reduced even with the certain period of time.

In the next frame period, the pixels in all of the odd-numbered rows (or even-numbered rows) are sequentially selected, and the image signal with the other polarity is written to the pixel; then, the pixels in all of the even-numbered rows (or odd-numbered rows) are sequentially selected, and the image signal with the one polarity is written to the pixels. Alternatively, in the frame period, the pixels in all of the even-numbered rows (or odd-numbered rows) are sequentially selected, and the image signal with the one polarity is written to the pixels; then, the pixels in all of the odd-numbered rows (or even-numbered rows) are sequentially selected, and the image signal with the other polarity is written to the pixels. Accordingly, the image signal with the one polarity and the image signal with the other polarity are input to one pixel within two frame periods, and thus, display defects can be reduced.

For example, in a first frame period, the second driving signal with the positive polarity (or the negative polarity) is input to the second wiring S while the pixels 120 in odd-numbered rows are sequentially selected and data of an image is written to the pixels; after that (or before that), the second driving signal with the negative polarity (or the positive polarity) is input to the second wiring S while the pixels 120 in the even-numbered rows are sequentially selected and data of the image is written to the pixels. According to the above driving method, a signal is sequentially input to the pixels with the same polarity in the second wirings S while the second driving signal is input to the pixels in the odd-numbered rows or the second driving signal is input to the pixels in the even-numbered rows. Therefore, the amplitude of the second driving signal becomes small, which results in a reduction in power consumption. Note that polarity is inverted at a timing when scan of the odd-numbered row (or even-numbered row) is switched to scan of the even-numbered row (or odd-numbered row). Accordingly, the frequency of polarity inversion of the second driving signal is markedly reduced, and thus, power consumption can be reduced. Note that after signals are input to the pixels in the odd-numbered rows and the pixels in the even-numbered rows, that is, after the first frame period, the polarity of voltage applied to pixels adjacent to each other among the plurality of pixels electrically connected to the second wiring S is inverted. In this manner, polarity of the second driving signal which is input to the pixels 120 adjacent to each other in the second wiring S can be inverted. As a result, noise is cancelled, so that display unevenness such as a smear can be reduced.

FIG. 1C shows the second wiring S1 to which the plurality of pixels 120 are electrically connected and the second wiring S2 to which the plurality of pixels 120 are electrically connected. As described with reference to FIG. 1B, in the plurality of pixels 120, the pixels in all of the odd-numbered rows (or even-numbered rows) are sequentially selected and data of an image is written to the pixels; then, the pixels in all of the even-numbered rows (or odd-numbered rows) is sequentially selected and data of the image is written to the pixels. The second driving signal with the positive polarity is input to the second wiring S1 while the pixels in the odd-numbered rows are sequentially selected and data of the image is written to the pixels; then, the second driving signal with the negative polarity is input to the second wiring S1 while the pixels in the even-numbered rows are sequentially selected and data of the image is written to the pixels. The second driving signal with the negative polarity is input to the second wiring S2 while the pixels in the odd-numbered rows are sequentially selected and data of the image is written to the pixels; then, the second driving signal with the positive polarity is input while the pixels in the even-numbered rows are sequentially selected and data of the image is written. The polarity of voltages applied to pixels adjacent to each other among the plurality of pixels electrically connected to the second wiring S1 or the second wiring S2 is inverted. In this manner, polarity of the second driving signal input to the pixels adjacent to each other in the first wiring G1 can be inverted, and polarities of the second driving signal input to the pixels adjacent to each other in the first wirings G in the odd-numbered rows and the first wirings G in the even-numbered rows can be inverted.

In the display device of one embodiment of the present invention, for example, after the pixels in all of the odd-numbered rows are sequentially selected and data of an image is written to the pixels, voltage applied to display elements can be held for several seconds. Then, after the pixels in all of the even-numbered rows are sequentially selected and data of the image is written to the pixels, voltage applied to display elements can be held for several seconds. In this manner, the frequency of rewriting a displayed still image can be reduced. Since it is unnecessary to keep a signal input to the plurality of pixels, power consumption of the display device can be reduced. A user is able to see the same image and perceive reduced flickers on a screen.

In this case, when the pixels in all of the odd-numbered rows (or even-numbered rows) are sequentially selected to display an image, power consumption can be reduced by inputting an image signal with the same polarity. Note that an embodiment of the present invention is not limited thereto. Depending on the case or the circumstance, it is possible to input an image signal with different polarity.

Alternatively, in the display device of one embodiment of the present invention, for example, immediately after the pixels in all of the odd-numbered rows are sequentially selected and data of an image is written to the pixels, the pixels in all of the even-numbered rows are sequentially selected and data of an image is written to the pixels. Then, voltage applied to display elements can be held for several seconds. In this manner, the frequency of rewriting a displayed still image can be reduced. Since it is unnecessary to keep a signal output to the plurality of pixels, power consumption of the display device can be reduced. A user is able to see the same image and perceive reduced flickers on a screen.

The display device is driven in the above manner and pixels adjacent to each other to which signals having different polarities are input are provided. Accordingly, luminance of the pixels is spatially averaged, and thus flickers in the display device can be reduced. The frequency of polarity inversion in the second wiring S is reduced and the frequency of charging and discharging the display elements are reduced. Accordingly, power consumption of the display device can be reduced.

Note that the frequency of rewriting an image is not limited to the above, and can be more than or equal to 30 times per second, preferably more than or equal to 60 times per second and less than 960 times per second. The frame frequency may be 60 Hz or more. In the display device of one embodiment of the present invention, in operating the display device, the frequency of rewriting the image can be changed.

Note that FIGS. 1A to 1C show the case where after the pixels in all of the odd-numbered rows are sequentially selected and data of an image is written to the pixels, the pixels in all of the even-numbered rows are sequentially selected and data of the image is written to the pixel. However, one embodiment of the present invention is not limited thereto. Depending on the case or the circumstance, it is also possible to select pixels in each row and write data of the image.

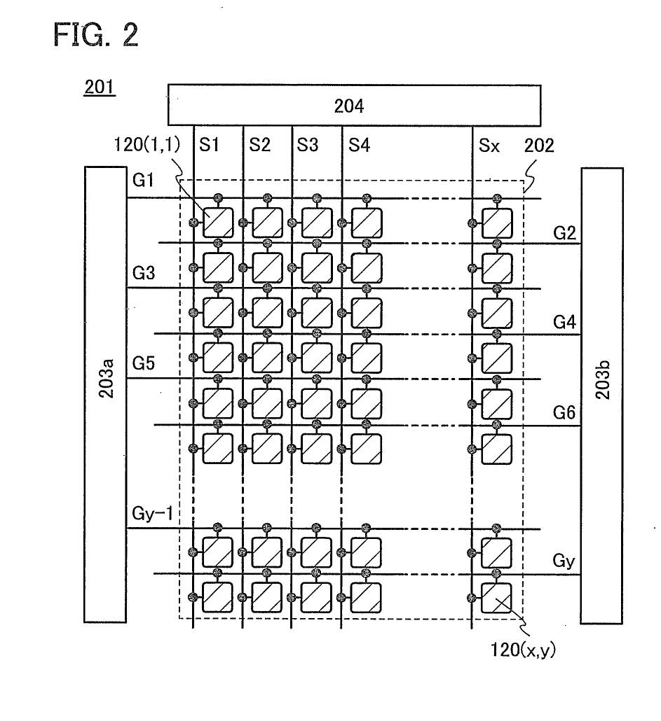

FIG. 2 is a circuit diagram of a display portion 201 (also referred to as a display panel) in the display device. As illustrated in FIG. 2, the display portion 201 includes a pixel portion 202, a first driver circuit 203a, a first driver circuit 203b, and a second driver circuit 204.

The pixel portion 202 includes a plurality of first wirings G1 to Gy, a plurality of second wirings S1 to Sx, and a plurality of pixels 120(1,1) to 120(x, y). The pixel portion 202 illustrated in FIG. 2 includes y first wirings G1 to Gy, x second wirings S1 to Sx, and the plurality of pixels 120(1,1) to 120(x, y) provided in matrix of y pixels in column and x pixels in row. The y first wirings G1 to Gy function as gate lines and the x second wirings S1 to Sx function as data lines. The first wirings provided in the odd-numbered rows among the y first wirings are electrically connected to the first driver circuit 203a. The first wirings provided in the even-numbered rows are electrically connected to the first driver circuit 203b. The x second wirings S1 to Sx are electrically connected to the second driver circuit 204.

The first driver circuits 203a and 203b have a function of outputting the first driving signal to the first wirings G1 to Gy. The first driver circuits 203a and 203b have a function as a scan signal line driver circuit and a function of outputting a scan signal as the first driving signal. The first driver circuits 203a and 203b each have a function of outputting the first driving signal for sequentially selecting the plurality of first wirings G1 to Gy to the plurality of first wirings G1 to Gy. The first driver circuit 203a in FIG. 2 has a function of outputting the first driving signal for sequentially selecting the first wirings in the odd-numbered rows to the first wirings in the odd-numbered rows. The first driver circuit 203b in FIG. 2 has a function of outputting the first driving signal for sequentially selecting the first wirings in the even-numbered rows to the first wirings in the even-numbered rows.

The second driver circuit 204 has a function of outputting the second driving signal to the second wirings S1 to Sx. The second driver circuit 204 has a function as a data signal line driver circuit or a video signal driver circuit, and a function of outputting a data signal as the second driving signal. The second driver circuit 204 has a function of outputting the second driving signal for writing data to the pixel portion 202 in the display portion 201 to the plurality of second wirings S1 to Sx.

Note that FIG. 2 shows an example where two first driver circuits are provided; however, one embodiment of the present invention is not limited thereto. For example, a display portion is driven focusing on pixels in multiples of N-th rows, N first driver circuits may be provided. This enables the structure of each driver circuit to be simple

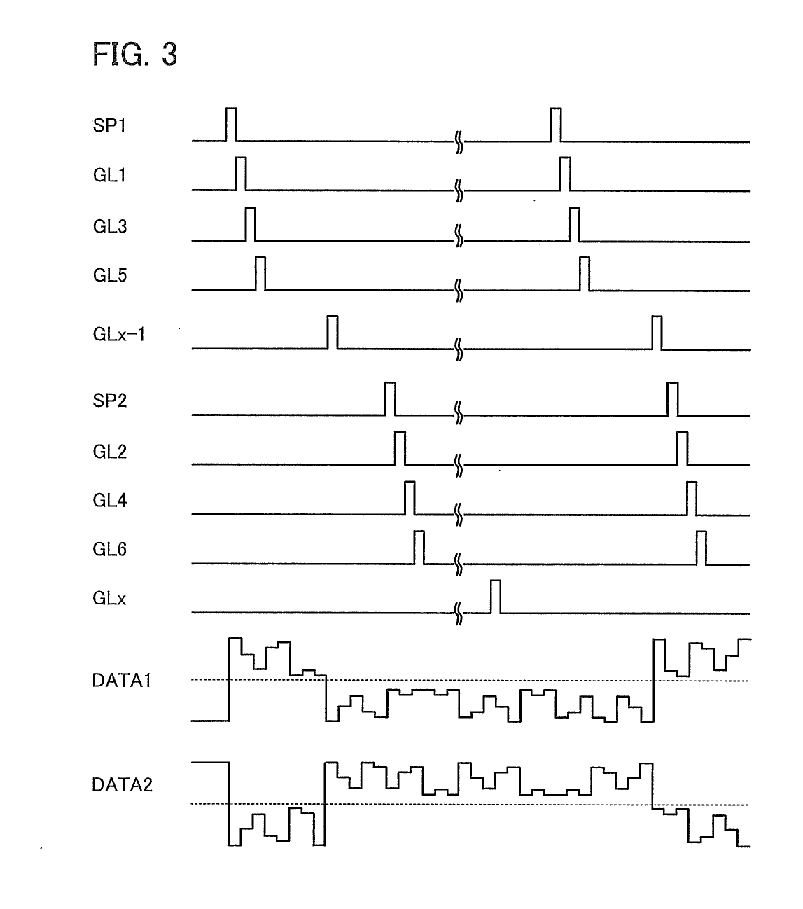

FIG. 3 shows waveforms of the first driver circuits 203a and 203b and the second driver circuit 204. In FIG. 3, SP1 is a start signal input to the first driver circuit 203a. GL1, GL3, GL5 . . . GLx−1 are the first driving signals which are output from the first driver circuit 203a to the first wirings G1, G3, G5 . . . Gx−1 in the odd-numbered rows. SP2 is a start signal input to the first driver circuit 203a. GL2, GL4, GL6 . . . GLx are the first driving signals which are output from the first driver circuit 203b to the first wirings G2, G4, G6 . . . Gx in the even-numbered rows. DATA1 is the second driving signal which is output from the second driver circuit 204 to the second wirings in odd-numbered columns. DATA2 is a data signal which is output from the second driver circuit 204 to the second wirings in even-numbered columns. A signal supplied from the second driver circuit 204 preferably has an analog value. Note that one embodiment of the present invention is not limited thereto, and the signal may have a digital value.

As illustrated in FIG. 3, when a high-level signal is input as SP1 to the first driver circuit 203a, the first driver circuit 203a sequentially outputs a high-level signal so as to sequentially select the first wirings in the odd-numbered rows such as G1, G3, G5 . . . Gx−1. After that, when a high-level signal is input as SP2 to the first driver circuit 203b, the first driver circuit 203b sequentially outputs a high-level signal so as to sequentially select the first wirings G in the even-numbered rows such as G2, G4, G6 . . . Gx. When a high-level signal is input as SP1 to the second driver circuit 204, the second driver circuit 204 outputs a positive (high-level) signal or a negative (low-level) signal as DATA1. When a positive (high-level) signal is input as SP2 to the second driver circuit 204, the second driver circuit 204 outputs a negative (low-level) signal or a positive (high-level) signal. Note that in the case where the display element performs analog gray scale driving, DATA1 and DATA2 are preferably analog values. Therefore, in accordance with a displayed image, the level of voltage changes in an analog manner.

In the above manner, an image can be displayed on the display portion 201.

In the display device of one embodiment of the present invention, with the first driving signal output from the first driver circuit 203a, the pixels in all of the odd-numbered rows (or even-numbered rows) are sequentially selected. Meanwhile a signal with the positive polarity (or negative polarity) is input as the second driving signal to the selected pixels and held for several seconds. Next, with the first driving signal output from the first driver circuit 203b, the pixels in all of the even-numbered rows (or odd-numbered rows) are sequentially selected. Meanwhile a signal with the negative polarity (or positive polarity) is input as the second driving signal to the selected pixels and held for several seconds. Then, with the first driving signal output from the first driver circuit 203a, the pixels in all of the odd-numbered rows (or even-numbered rows) are sequentially selected again.

In the plurality of first wirings G1 to Gy, scanning which enables the first wirings in the odd-numbered rows to sequentially operate and scanning which enables the first wirings in the even-numbered rows to sequentially operate are alternately performed. After the scanning which enables the first wirings in the odd-numbered rows to sequentially operate, the first driver circuit 203a stops outputting the first driving signal for a certain period. After that, the scanning which enables the first wirings in the even-numbered rows to sequentially operate, and the first driver circuit 203b stops outputting the first driving signal for a certain period. By driving the display device in this manner, the frequency of rewriting a displayed still image can be reduced. Since it is unnecessary to keep a signal output to the plurality of pixels, power consumption of the display device can be reduced. A user is able to see the same image and perceive reduced flickers on a screen.

In the display portion 201 illustrated in FIG. 2, a period in which the first driver circuit 203a stops outputting the first driving signal after the scanning which enables the first wirings in the odd-numbered rows to sequentially operate may overlap with a period in which the second driver circuit 203b stops outputting the first driving signal after the scanning which enables the first wirings in the even-numbered rows to sequentially operate. In the display device of one embodiment of the present invention, the pixel 120 can hold an inputted signal. Therefore, even when the period where supply of a signal outputted to the first wirings in the odd-numbered rows is stopped overlaps with the period where supply of a signal outputted to the first wirings in the even-numbered rows is stopped, a still image can be favorably displayed on the display portion 201.

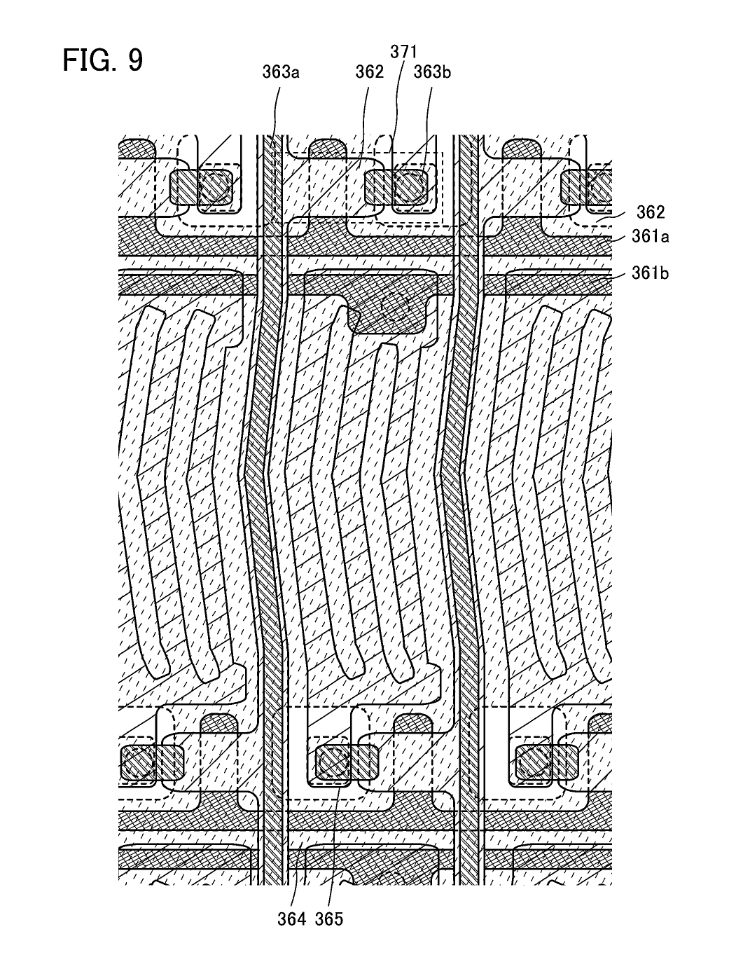

FIG. 9 is a top view of a structure example of the pixel 120 in the display portion 201 illustrated in FIG. 2. FIG. 9 shows a pixel structure in the FFS mode.

As illustrated in FIG. 9, the plurality of transistors 371 are provided in the pixel portion 202. A wiring 361a and a wiring 361b are provided over a substrate. A wiring 363a and an oxide semiconductor layer 362 are provided to intersect the wiring 361a and the wiring 361b. A gate insulating film is provided between the oxide semiconductor layer 362 and the wiring 361a and between the oxide semiconductor layer 362 and the wiring 361b. The oxide semiconductor layer 362 is in contact with the wiring 363a and an electrode 363b. Note that the wiring 361a corresponds to the first wiring G and the wiring 363a corresponds to the second wiring S.

Although not illustrated in FIG. 9, a protection film or a planarization film may be provided over the transistor 371. In this case, a common electrode 364 is provided over the protection film or the planarization film. The common electrode 364 has an opening, and is in contact with the electrode 363b via the opening. An insulating film (not illustrated) is provided over the common electrode 364. A pixel electrode 365 is provided over the insulating film. The pixel electrode 365 is in contact with the common electrode 364 via the opening penetrating the insulating film.

FIG. 9 shows an example of a pixel structure in the FFS mode. However, a pixel in the display device of one embodiment of the present invention is not limited thereto, and a variety of pixel structures can be used.

This embodiment can be combined with any of the other embodiments disclosed in this specification as appropriate.

### Embodiment 2

In this embodiment, various modes of a display portion in a display device will be described.

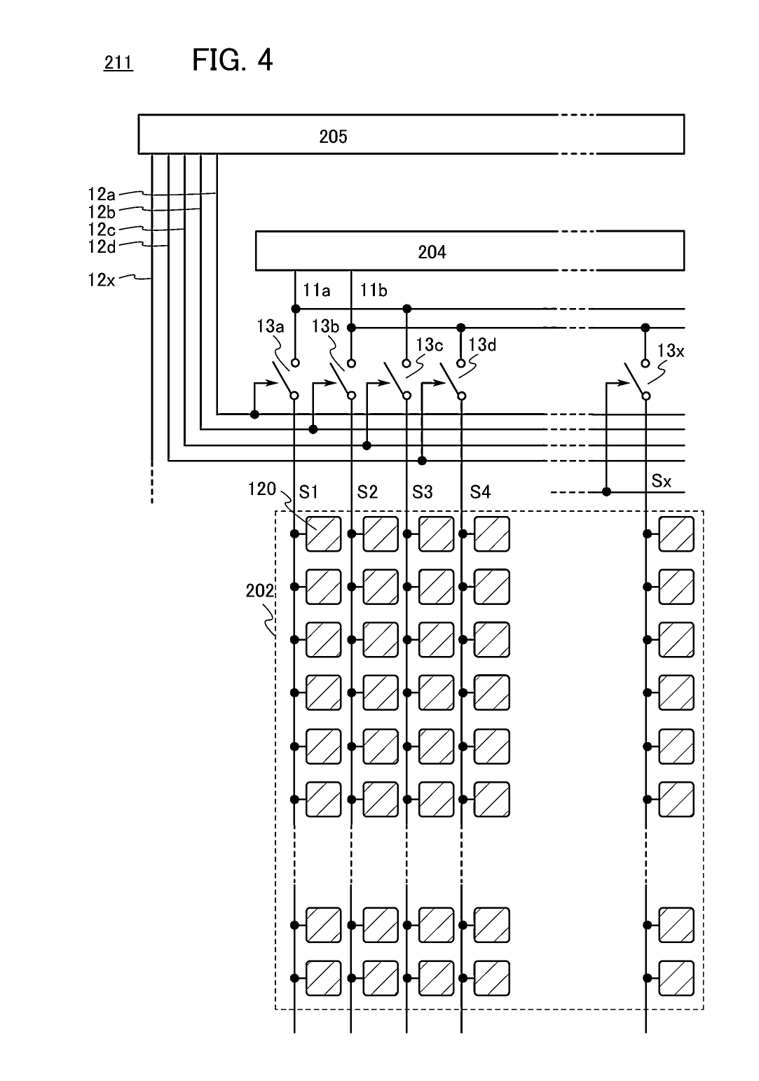

FIG. 4 illustrates one embodiment of a display portion. A display portion 211 illustrated in FIG. 4 includes the pixel portion 202, the second driver circuit 204, the control device 205, a plurality of wirings 12a to 12x, and switches 13a to 13x. Note that in FIG. 4, the first driver circuit, the plurality of first wirings G1 to Gy, and the like are omitted.

The pixel portion 202 includes the plurality of second wirings S1 to Sx and the plurality of pixels 120(1,1) to 120(x, y). In FIG. 4, the pixel portion 202 includes the x second wirings S1 to Sx and the plurality of pixels 120(1,1) to 120(x, y) provided in matrix of y pixels in column and x pixels in row.

In the display portion 211 illustrated in FIG. 4, in the plurality of second wirings S1 to Sx, the second wirings S in the odd-numbered columns are electrically connected to a wiring 11a through switches 13a, 13c . . . 13(x−1) individually, while the second wirings S in the even-numbered columns are electrically connected to a wiring 11b through switches 13b, 13d . . . 13x individually. The wiring 11a and the wiring 11b are electrically connected to the second driver circuit 204. The control device 205 is electrically connected to the wirings 12a to 12x.

Switching of the switches 13a to 13x electrically connected to the plurality of second wirings S1 to Sx, respectively, are controlled by signals input to the wirings 12a to 12x. For example, in the case where the second driving signal is output from the second driver circuit 204 to the second wirings S in the odd-numbered columns, the control device 205 outputs a signal (for example, a high-level potential) by which the switches 13a, 13c . . . 13(x−1) are turned on to the wirings 12a, 12c . . . 12(x−1) in the odd-numbered columns. In the case where the second driving signal is output from the second driver circuit 204 to the second wirings S in the even-numbered columns, the control device 205 outputs a signal (for example, a high-level potential) by which the switches 13b, 13d . . . 13x are turned on to the wirings 12b, 12d . . . 12x in the even-numbered columns.

In the structure, for a certain period, an image signal with one polarity is supplied to the wiring 11a and an image signal with the other polarity is supplied to the wiring 11b. Therefore, the image signals can have smaller amplitude, resulting in a reduction in power consumption.

Note that one wiring may function as the wiring 12a and the wiring 12b. In this case, the switch 13a and the switch 13b are switched at the same time. Similarly, one wiring may function as the wiring 12c and the wiring 12d. In this case, the switch 13c and the switch 13d are switched at the same time. Thus, the number of wirings can be reduced.

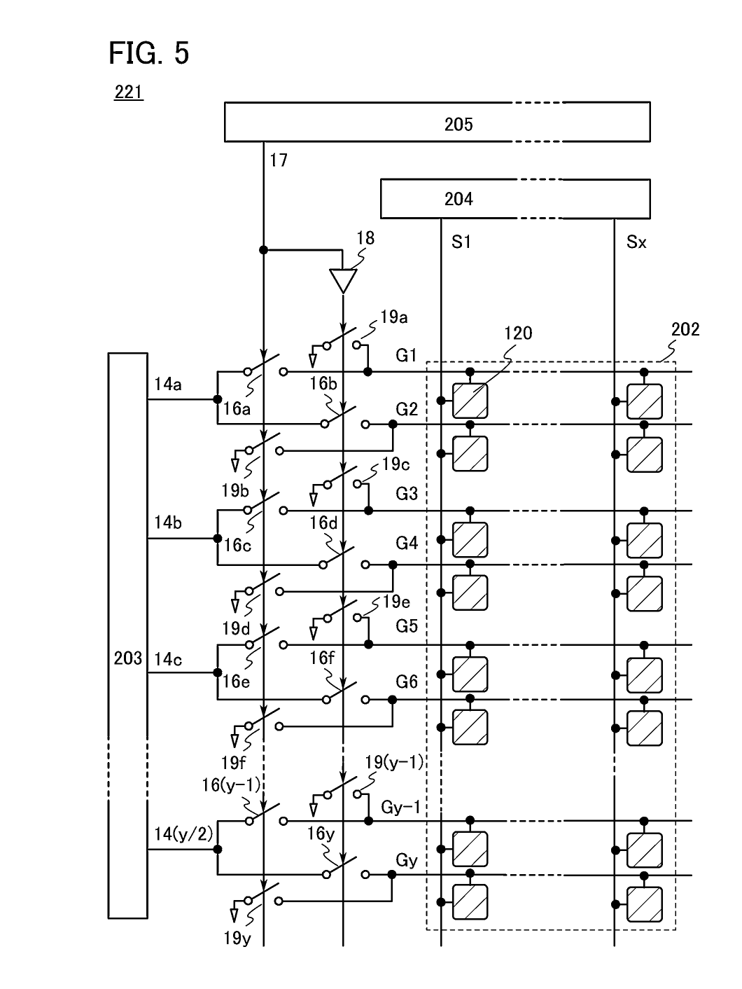

FIG. 5 shows one embodiment of a display portion different from that in FIG. 4. A display portion 221 illustrated in FIG. 5 includes the pixel portion 202, a first driver circuit 203, the second driver circuit 204, the control device 205, a plurality of wirings 14a to 14(y/2), a wiring 17, switches 16a to 16y, switches 19a to 19y, and an inverter 18.

The pixel portion 202 includes the plurality of first wirings G1 to Gy, the plurality of second wirings S1 to Sx, and the plurality of pixels 120. In FIG. 5, as in FIG. 4, the plurality of pixels 120(1,1) to 120(x, y) are provided in matrix of y pixels in column and x pixels in row.

In the display portion 221 illustrated in FIG. 5, in the plurality of first wirings G1 to Gy, the first wirings G in the odd-numbered rows and the first wirings G in the even-numbered rows are electrically connected to the wiring 14 through switches. The wirings 14a to 14(y/2) are electrically connected to the first driver circuit 203. For example, the first wiring G1 and the first wiring G2 are electrically connected to the wiring 14a through the switches 16a and 16b, respectively. The control device 205 is electrically connected to the wiring 17. The plurality of first wirings G1 to Gy are grounded through the switches 19a to 19y, respectively.

Switching of the switches 16a to 16y and the switches 19a to 19y which are electrically connected to the plurality of first wirings G1 to Gy are controlled by a signal input to the wiring 17. In the display portion 221 in FIG. 5, a signal PSW output from the control device 205 is input to the switches 16a, 16c, . . . 16(y−1) which are electrically connected to the first wirings G1, G3, . . . G(y−1) in the odd-numbered rows. In addition, a signal PSWB which is an inverted signal of the signal output from the control device 205 is input to the switches 16b, 16d . . . 16y which are electrically connected to the first wirings G2, G4, . . . Gy in the even-numbered rows. A signal output from the control device 205 are input to the switches 19a, 19c, . . . 19(y−1) which are electrically connected to the first wirings G1, G3, . . . G(y−1) in the odd-numbered row. A signal which is an inverted signal of the signal output from the control device 205 is input to the switches 19b, 19d, . . . 19y which are electrically connected to the first wirings G2, G4, . . . Gy in the even-numbered rows.

Accordingly, when a signal output from the control device 205, for example, is a high-level potential, the switches 16a and 19a are turned on and the switches 16b and 19b are turned off.

Note that in FIG. 5, for example, the wiring 14a branches into two wirings and the wirings are connected to two switches (the switches 16a and 16b). However, one embodiment of the present invention is not limited thereto. For example, the wiring 14a may branch into M wirings and be connected to M switches. Here, M is a natural number.

In the display portion 221 illustrated in FIG. 5, since the connection between the first driver circuit 203 and the plurality of first wirings G1 to Gy is controlled in the above manner, it is unnecessary to provide two or more the first driver circuits 203 like the display portion 201 illustrated in FIG. 2. Thus, the area of the circuit can be reduced. Further, since the number of driver circuits can be small, power consumption can be reduced.

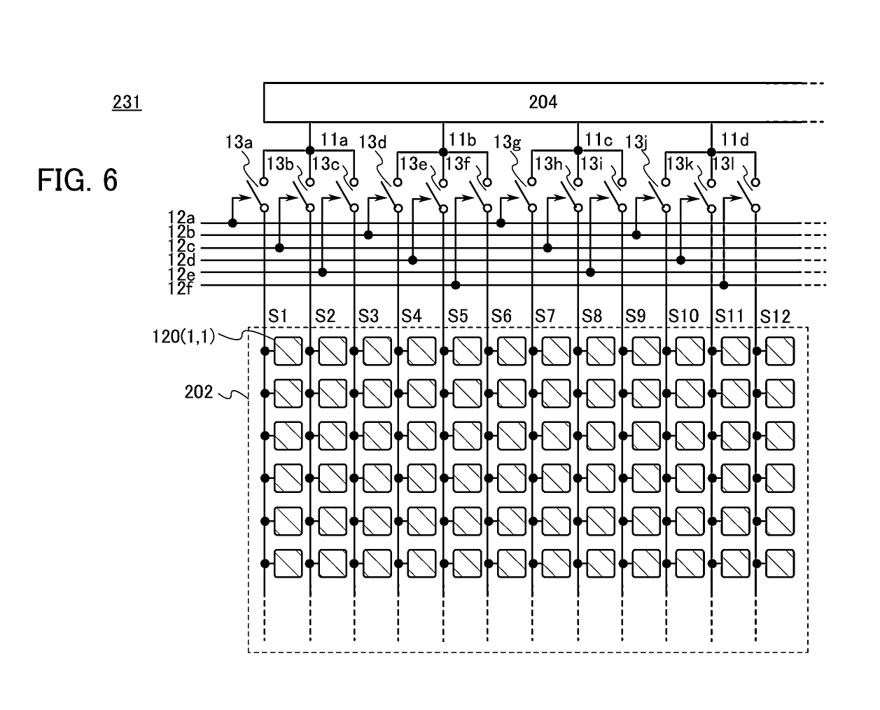

FIG. 6 shows one embodiment of a display portion different from those in FIG. 4 and FIG. 5. The display portion 231 illustrated in FIG. 6 includes the pixel portion 202, the second driver circuit 204, the second wirings S1 to Sx, the wirings 12a to 12f, and the switches 13a to 13x. Note that FIG. 6 shows the second wirings S1 to S12 and the switches 13a to 13f.

Note that it is possible that an image signal with the one polarity be supplied to the wirings 11a and 11c and an image signal with the other polarity be supplied to the wirings 11b and 11d. Alternatively, an image signal with one polarity may be supplied to the wirings 11a, 11b, 11c, and 11d. In this case, the amplitude of an image signal can be small and power consumption can be reduced. Note that it is also possible that image signals with different polarities be input to the second wirings S1 to Sx on column by column basis to reduce display unevenness and flickers.

In the display portion 231 illustrated in FIG. 6, the second wirings S1, S2, and S3 in the plurality of second wirings S1 to Sx are electrically connected to the wiring 11a through the switches 13a, 13b, and 13c, respectively. In addition, the second wirings S4, S5, and S6 in the plurality of second wirings S1 to Sx are electrically connected to the wiring 11b through the switches 13d, 13e, and 13f, respectively. The second wirings S7, S8, and S9 in the plurality of second wirings S1 to Sx are electrically connected to the wiring llc through the switches 13g, 13h, and 13i. The second wirings S10, S11, and S12 in the plurality of second wirings S1 to Sx are electrically connected to the wiring 11d through the switches 13j, 13k, and 13l.

Switching of the switches 13a to 13x which are electrically connected to the second wirings S1 to Sx, respectively is controlled by a signal input to the wirings 12a to 12f. In the display portion 231 illustrated in FIG. 6, a signal output from a control device (not illustrated in FIG. 6) is input to the switches which are electrically connected to the second wirings S1 to Sx.

For example, when a signal with a high-level potential is input to the wiring 12a, the switches 13a and 13g are turned on and the second driving signal are input to the second wirings S1 and S7. When a signal with a high-level potential are input to the wiring 12b, the switches 13b and 13h are turned on and the second driving signal is input to the second wirings S2 and S8. That is, in the second wirings S1 to Sx, the second driving signal is input to two wirings between which five wirings are provided.

The pixel portion 202 includes a transistor including an oxide semiconductor as the transistor 121, and therefore, voltage can be held for a long time in a display element. Accordingly, even when data is written to two wirings between which five wirings are provided, change in transmittance of the display element can be suppressed; therefore, flickers on the display portion 231 can be reduced.

The display portions of one embodiment of the present invention in FIG. 4, FIG. 5, and FIG. 6 can be used in appropriate combination with each other.

This embodiment can be combined with any of the other embodiments disclosed in this specification as appropriate.

### Embodiment 3

In this embodiment, various modes of a display portion in a display device will be described.

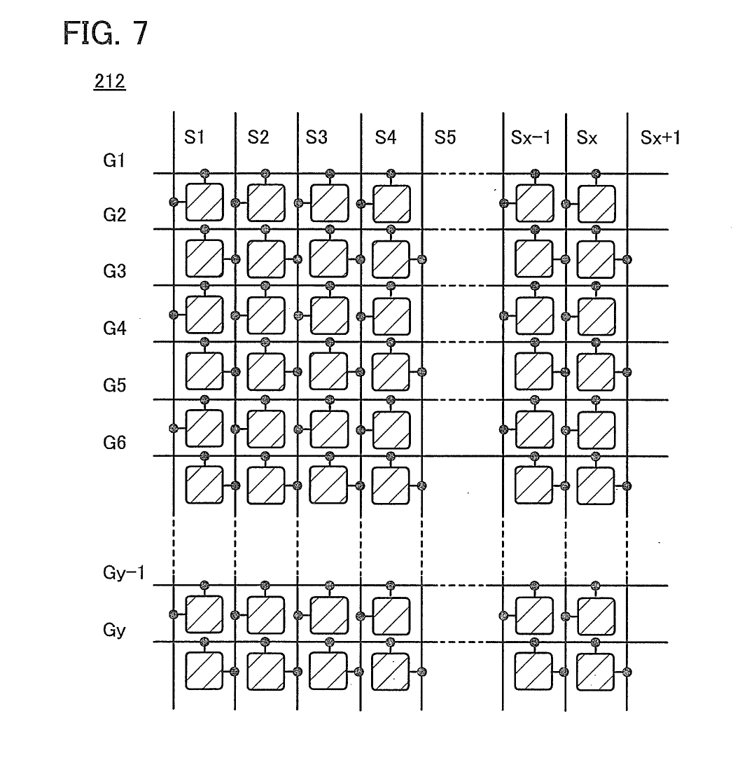

FIG. 7 illustrates one embodiment of a pixel portion. A pixel portion 212 illustrated in FIG. 7 includes the first wirings G1 to Gy, the second wirings S1 to Sx, and the plurality of pixels 120. A difference between the pixel portion 212 and the pixel portion described in the above embodiment is a connection relation between the second wirings S1 to Sx and the plurality of pixels 120.

In the pixel portion 212 illustrated in FIG. 7, the pixels 120 in the first wirings G in the odd-numbered rows are electrically connected to the second wirings S in the odd-numbered columns, while the pixels 120 in the first wirings G in the even-numbered rows are electrically connected to the first wirings S in the even-numbered columns.

In the pixel portion 212 illustrated in FIG. 7, like that in FIG. 1C, in the plurality of pixels 120, the pixels in all of the odd-numbered rows (or even-numbered rows) are sequentially selected and data of an image is written; then, the pixels in all of the even-numbered rows (or odd-numbered rows) are sequentially selected and data of the image is written. In the case where the second driving signal with the positive polarity, for example, is input to the second wirings S in the odd-numbered columns, the second driving signal with the negative polarity is input to the second wirings S in the even-numbered columns. The polarities of voltage applied to pixels adjacent to each other in the first wirings G1 to Gy can be also opposite to each other by such a method.

By driving the display portion in the above manner and by providing the pixels whose polarities of an inputted signal are different to be adjacent to each other, luminance of the pixels is spatially averaged, and thus flickers of the display device can be suppressed. The frequency of polarity inversion in the second wirings S1 to Sx is reduced, and thus, the frequency of charging and discharging the display elements are reduced. Accordingly, power consumption of the display device can be reduced.

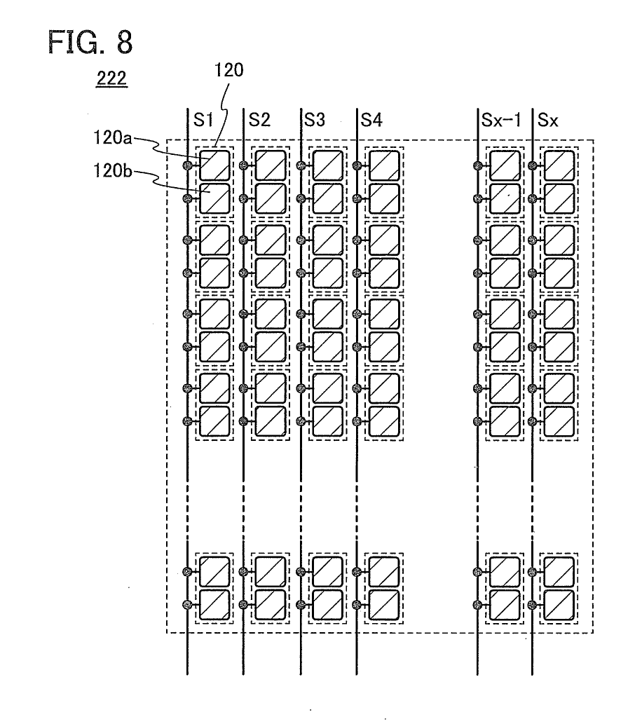

FIG. 8 illustrates another embodiment of a pixel portion. A pixel portion 222 illustrated in FIG. 8 includes the second wirings S1 to Sx and the plurality of pixels 120. In FIG. 8, the first wirings G1 to Gy are omitted. A difference between the pixel portion 222 and the pixel portion described in the above embodiment is the structure of the pixel 120.

The pixel 120 illustrated in FIG. 8 has a plurality of sub-pixels 120a and 120b. The pixel structure illustrated in FIG. 8 is an example of the case where the pixel 120 has two sub-pixels (the sub-pixels 120a and 120b). Note that the number of sub-pixels in the pixel 120 is not limited.

In the pixel portion 222 illustrated in FIG. 8, as shown in FIG. 1C, the pixels 120 in all of the odd-numbered rows (or even-numbered rows) are sequentially selected and data of an image is written; then, all of pixels in the even-numbered rows (or odd-numbered rows) are sequentially selected and data of the image is written. Alternatively, in the plurality of pixels 120, sub-pixels in odd-numbered rows (or even-numbered rows) are sequentially selected and data of an image is written; then, sub-pixels in even-numbered rows (or odd-numbered row) are sequentially selected and data of the image is written. That is, the sub-pixels 120a and 120b in the pixel 120 can be supplied with a signal with one polarity or signals with different polarities.

In FIG. 8, sub-pixels in one pixel are connected to one of the second wirings S1 to Sx; however, one embodiment of the present invention is not limited thereto. The sub-pixels in one pixel may be connected to different wirings. For example, the sub-pixels 120a and 120b are connected to the second wirings S1 and S2, respectively. In this manner, by supplying image signals with different polarities to the second wirings S1 and S2, the polarity of the image signal supplied to sub-pixels in one pixel can be different. In this manner, an influence of noise such as display unevenness can be reduced.

By providing the sub-pixels in each pixel in the pixel portion 222 in the above manner, luminance of the pixels is spatially averaged compared to that of the pixel portion illustrated in FIG. 7, and thus flickers of the display device can be suppressed. The frequency of polarity inversion in the second wirings S1 to Sx is reduced, and thus, the frequency of charging and discharging the display elements are reduced. Accordingly, power consumption of the display device can be reduced.

This embodiment can be combined with any of the other embodiments disclosed in this specification as appropriate.

### Embodiment 4

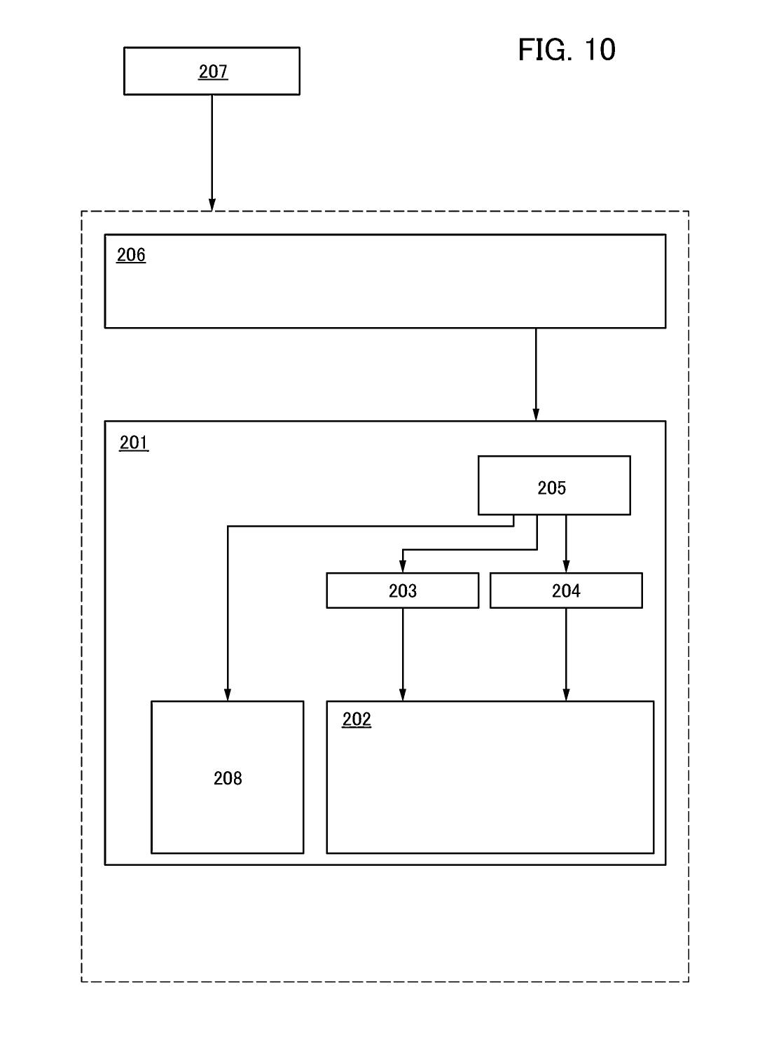

In this embodiment, a method for driving the display device will be described with reference to FIG. 10.

FIG. 10 shows a block diagram of the display device of one embodiment of the present invention. As illustrated in FIG. 10, the display device 200 of one embodiment of the present invention includes the display portion 201, a control device 205, an arithmetic device 206, an input unit 207, and the light supply portion 208. The display portion 201 has the pixel portion 202, the first driver circuits 203a and 203b, and the second driver circuit 204. Note that the display device may include an image processing circuit and the like.

Although the block diagram shows components classified by their functions in independent blocks, it is difficult to classify actual components according to their functions completely and it is possible for one component to have a plurality of functions.

In the display portion 201 illustrated in FIG. 10, the pixel portion 202, the first driver circuit 203, and the second driver circuit 204 are provided. For the structures of the pixel portion 202, the first driver circuit 203, and the second driver circuit 204 which are included in the display portion 201, the structures in the above embodiment can be used as appropriate. The display portion 201 includes the light supply portion 208. The light supply portion 208 supplies light to the pixel portion 202.

As the input unit 207, a touch screen, a touch pad, a mouse, a finger joystick, a trackball, a data glove, an imaging device, or the like can be used.

In the arithmetic device 206, an electric signal input from the input unit 207 can be associated with coordinates of the pixel portion 202 in the display portion 201. Accordingly, an instruction for processing information displayed on the display portion 201 is generated in the arithmetic device 206.

Examples of information that the user inputs with the input unit 207 are a drag instruction to change the position of an image displayed on the display portion, an instruction to scroll through an image, an instruction to select a particular image, a pinch instruction to change the size of a displayed image, and an instruction to perform handwriting input.

The arithmetic device 206 outputs a signal corresponding to an instruction for processing information to the control device 205. The control device 205 controls the first driver circuit 203, the second driver circuit 204, and the light supply portion 208 in accordance with an inputted signal.

A plurality of light sources are provided in the light supply portion 208. As the light sources of the light supply portion 208, a cold cathode fluorescent lamp, a light-emitting diode (LED), an organic EL element that generates luminescence (electroluminescence) by application of an electric field, a lighting device including the organic EL element, or the like can be used.

In a light source of the light supply portion 208, the intensity of blue light emitted by the light source is preferably low (weakened) compared to that of light of any other color. Since blue light included in light emitted from the light source is not absorbed by the cornea and lens of the eye and reaches the retina, this structure can reduce long-term effects of blue light on the retina (e.g., age-related macular degeneration), adverse effects of exposure to blue light until midnight on the circadian rhythm, and the like. The wavelength of the light emitted by the light source is preferably longer than 420 nm, more preferably longer than 440 nm.

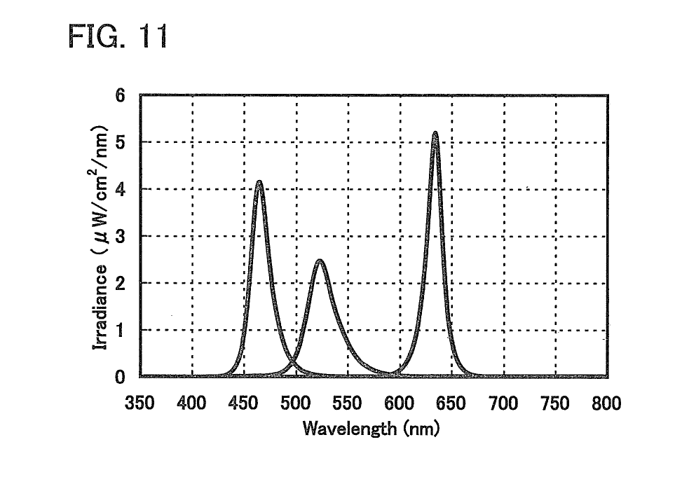

FIG. 11 shows preferable emission spectra of the light supply portion 208. FIG. 11 shows an example of spectra of light emitted from LEDs of three colors of R (red), G (green), and B (blue) used as the light source of the light supply portion 208. In FIG. 11, in the range where the wavelength is shorter than or equal to 420 nm, the irradiance is hardly observed. The display portion 201 with the light supply portion 208 for which these light sources are used can reduce eye strain of users.

In this program, the luminance of short-wavelength light is lowered in accordance with the user's fatigue condition detected by the condition of the user's eye. The program makes it possible to reduce the user's eye fatigue and damage to the retina and prevent harm to the user's health.

Next, an example of a method for driving the display device shown in FIG. 10 is described.

The display device illustrated in FIG. 10 has a first mode in which an image displayed on the display portion 201 is rewritten at a frequency of 30 or more times per second, preferably a frequency of 60 or more times and less than 960 times per second and a second mode in which an image displayed on the display portion 201 is rewritten at a frequency of one or more times per day and less than 0.1 times per second, preferably a frequency of one or more times per hour and less than once per second. For example, it is possible to use the first mode to display a moving image on the display portion 201 and to use the second mode to display a still image on the display portion 201. The second mode is used when a still image is displayed to reduce the frequency of rewriting the image, whereby the power consumption of the display device 200 can be reduced.

When a user selects an instruction for processing information from an image displayed on the display portion 201 by the input unit 207, the input unit 207 outputs an image switching signal to the arithmetic device 206 in accordance with the instruction. The arithmetic device 206 outputs an image signal and a control signal including the image switching signal to the display portion 201. Note that the control signal includes not only an image switching signal which the input unit 207 outputs, but also a start signal SP, a clock signal CLK, and a pulse width control signal PWC for the first driver circuit 203, a start signal SP, a clock signal CLK, a latch signal LP, for controlling the second driver circuit 204, and the like.

In the display portion 201, the control device 205 outputs the inputted control signal and the image signal to the first driver circuit 203 and the second driver circuit 204. The control device 205 outputs a start signal SP, a clock signal CLK, and a pulse width control signal PWC to the first driver circuit 203 and outputs a start signal SP, a clock signal CLK, a latch signal LP, and an image signal to the second driver circuit 204.

An example of a method for determining whether the image signal is a signal for a moving image or a signal for a still image is as follows. Signals for one frame included in the image signals are compared with signals for the pervious frame and signals for the next frame, whereby differences are obtained. It is determined that the image is a moving image when the differences are each greater than a predetermined difference, and it is determined that the image is a still image in other cases.

An inversion control circuit may be provided in the control device 205, in which case the control device 205 can have a function of inverting the polarity of the image signal in accordance with the timing informed by the inversion control circuit. Specifically, the polarity of the image signal may be inverted in the control device 205, or may be inverted in the display portion 201 in accordance with an instruction from the control device 205.

The inversion control circuit has a function of determining the timing of inverting the polarity of the image signal by using a synchronization signal. For example, the inversion control circuit includes a counter and a signal generator circuit.

The counter has a function of counting the number of frame periods by using the pulse of a horizontal synchronizing signal.

The signal generator circuit has a function of informing the control device 205 of the timing of inverting the polarity of the image signal so that the polarity of the image signal is inverted every several successive frame periods by using information on the number of frame periods obtained by the counter.

Such a control device 205, for example, generates a timing control signal at a frame frequency of 60 Hz and controls operation timing of the first driver circuit 203 and the second driver circuit 204 by regarding the 60 Hz as a reference value. Alternatively, the control device 205 generates a timing control signal at a frame frequency of 30 Hz or lower and controls operation timing of the first driver circuit 203 and the second driver circuit 204 with reference to the 30 Hz or lower. At a frame frequency of 60 Hz, 60 images are displayed on the display portion 201 every second. At a frame frequency of 30 Hz, 30 images are displayed on the display portion 201 every second. When the display device is driven at a frame frequency of 30 Hz, a user continues to watch one image in comparison with the case of a frame frequency of 60 Hz; thus, the user perceive reduced flickers on a screen. For the operation of the pixel portion 202 in the display portion 201, the above embodiments can be referred to; thus, detailed description thereof is omitted. As the display portion 201, the display portion 211, the display portion 221, or the display portion 231 in the above embodiments, or the like can be used.

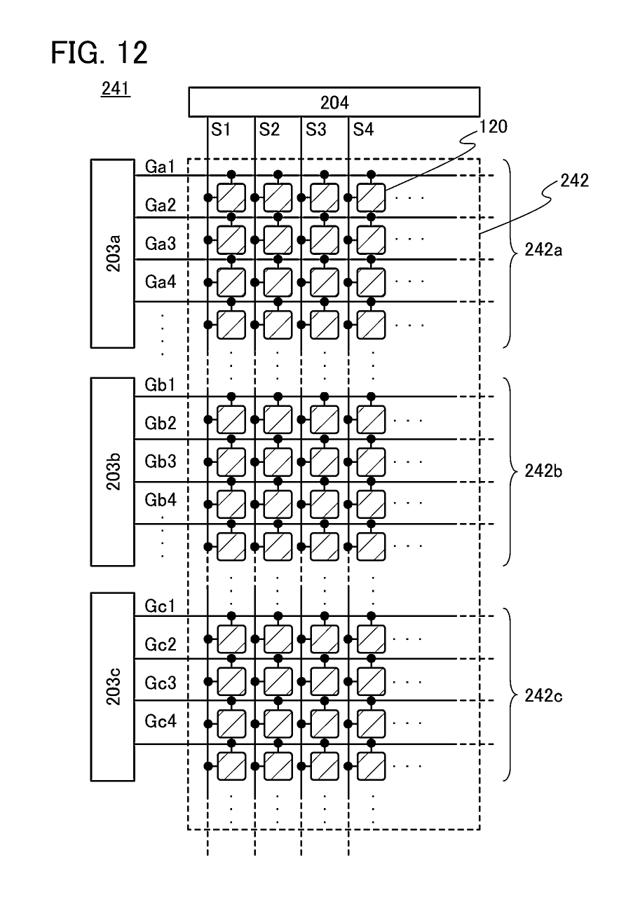

Next, a modification example of the structure of the display portion 201 is described with reference to FIG. 12.

A display portion 241 illustrated in FIG. 12 includes the plurality of first driver circuits 203 (in FIG. 12, the first driver circuits 203a, 203b, and 203c), a pixel portion 242, and the second driver circuit 204. The pixel portion 242 illustrated in FIG. 12 is divided into three regions (a first region 242a, a second region 242b, and a third region 242c). A plurality of first wirings Ga provided in the first region 242a are electrically connected to the first driver circuit 203a. A plurality of first wirings Gb provided in the second region 242b are electrically connected to the first driver circuit 203b. A plurality of first wirings Gc provided in the third region 242c are electrically connected to the first driver circuit 203c. FIG. 12 shows an example where the pixel portion 242 is divided into three regions; however, one embodiment of the present invention is not limited thereto. The pixel portion 242 may be divided into four or more regions.

The plurality of first driver circuits 203 (in FIG. 12, the first driver circuits 203a, 203b, and 203c) start driving in the order in which a start signal is input. For example, in the case where a start signal is input to the first driver circuit 203a, the first driver circuit 203b, and the first driver circuit 203c in this order, the first driver circuits start driving in this order. At that time, the frequency of rewriting an image in the display portion 241 may be either the first mode where the frequency of rewriting an image is high or the second mode where the frequency of rewriting an image.

The frequency of rewriting an image may be different depending on the first driver circuits 203a, 203b, and 203c. For example, the frequency of rewriting an image in the first driver circuits 203a and 203b may be higher than that in the first driver circuit 203c. That is, in the pixel portion 202, the frequency of rewriting an image in the first regions 242a, and 242b can be that in the first mode and the frequency of rewriting an image in the third region 242c can be that in the second mode. Accordingly, in the case where a moving image is displayed in the first region 242a and the second region 242b in the pixel portion 202 and a still image is displayed in the third region 242c, operation frequency of the first driver circuit 203c can be reduced. As a result, power consumption due to operation of the first driver circuit 203c can be reduced. Needless to say, all of the first driver circuits 203a, 203b, and 203c may be driven in the first mode or the second mode.

Next, switching between the first mode and the second mode will be described.

In the case where an image switching signal is input from the input unit 207 to the first driver circuit 203 through the control device 205 when the display portion 201 displays an image in the second mode, the second mode changes into the first mode.

For example, when the input unit 207 detects a page turning operation, the input unit 207 outputs an image switching signal to the arithmetic device 206. The arithmetic device 206 generates an image signal including an instruction for executing a page turning operation and outputs a control signal including an image switching signal, and an image signal.

The control device 205 outputs an image switching signal to the first driver circuit 203 and outputs an image signal including an instruction for executing a page turning operation to the second driver circuit 204.

Accordingly, the first driver circuit 203 switches from the second mode to the first mode, and outputs the first driving signal to the pixel portion 202. On the other hand, the second driver circuit 204 outputs the second driving signal generated from an image signal including an instruction for executing a page turning operation to the pixel portion 202.

Since the first driving signal are frequently input to the pixel portion 202, an image corresponding to an image signal including an instruction for executing a page turning operation can be displayed in detail. Specifically, a plurality of frames can be displayed in a short time; thus, images corresponding to the image signals including an instruction for executing a smooth page turning operation can be displayed.

Note that the response time of a liquid crystal from application of voltage to saturation of the change in transmittance is generally about ten milliseconds. Thus, the slow response of the liquid crystal tends to be perceived as a blur of a moving image. As a countermeasure, overdriving may be employed in which the voltage applied to the display element that is a liquid crystal element is temporarily increased so that the orientation of liquid crystal changes quickly. By overdriving, the response speed of the liquid crystal can be increased, a blur of a moving image can be prevented, and the quality of the moving image can be improved.

If in the pixel, the transmittance of the display element 122, which is the liquid crystal element, keeps changing without being saturated after the transistor 121 is turned off, the relative permittivity of the liquid crystal also changes; accordingly, the voltage held in the liquid crystal element as the display element 122 is likely to change.

For example, in the case where the capacitor 123 connected in parallel to the liquid crystal element as the display element 122 has small capacitance, the change in the voltage held in the liquid crystal element as the display element 122 tends to occur markedly. However, the overdriving can shorten the response time, thereby suppressing a change in the transmittance of the liquid crystal element as the display element 122 after the transistor 121 is turned off. Accordingly, even if the capacitor 123 connected in parallel with the display element 122 has small capacitance, the voltage held in the display element 122 can be prevented from changing after the transistor 121 is turned off.

This embodiment can be combined with any of the other embodiments disclosed in this specification as appropriate.

### Embodiment 5

Embodiment 5 will explain a method of producing an image that can be displayed on a display device of one embodiment of the present invention, and in particular, a method of switching images in an eye friendly way, that is, a method of switching images with less eye fatigue given to a user or a method of switching images without strain on the eyes of a user.

A user may have eyestrain when display is performed by switching images rapidly, for example, when scenes switch frequently in a moving image or when a still image switches to a different still image.

When display is performed by switching an image to a different image, it is preferable to switch images gradually (smoothly) and naturally, instead of instantaneously.

For example, when display switches from a first image to a different second image, fade-out images of the first image and/or fade-in images of the second image are preferably inserted between the first image and the second image. Moreover, it is possible to insert images obtained by overlapping the first image and the second image so that the first image fades out and the second image fades in at the same time (such effect is called cross-fading), or to insert a moving image for displaying a state where the first image is gradually changed into the second image (such effect is called morphing).

Specifically, a first still image is displayed at a low frame frequency, then an image for switching display is displayed at a high frame frequency, and after that, a second still image is displayed at a low frame frequency, for example.

An example of a method of switching display between an image A and an image B that are different from each other will be described below.

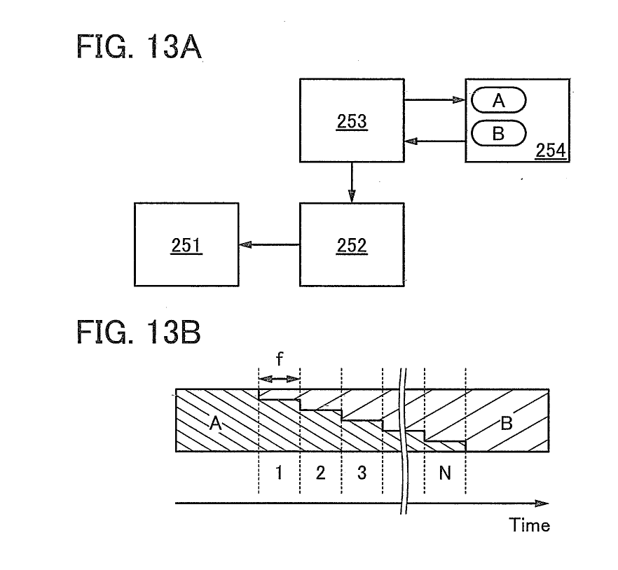

FIG. 13A is a block diagram illustrating the structure of a display device capable of switching images. The display device illustrated in FIG. 13A includes a display portion 251, an image processing unit 252, an arithmetic unit 253, and a memory device 254.

In a first step, the arithmetic unit 253 makes the memory device 254 store data of the image A and data of the image B from an external memory device or the like.

In a second step, the arithmetic unit 253 sequentially generates new image data based on the data of the image A and the data of the image B in accordance with the predetermined number into which the period is divided.

In a third step, the generated image data is output to the image processing unit 252. The image processing unit 252 makes the inputted image data displayed on the display portion 251.

FIG. 13B is a schematic diagram explaining image data generated for gradually switching display from the image A to the image B.

FIG. 13B shows the case where N pieces of image data (N is a natural number) are generated to be displayed between the image A and the image B and each piece of the image data is displayed for f frame periods (f is a natural number). Thus, it takes f×N frames to switch display from the image A to the image B.

Here, it is preferable that the above parameters such as N and f be capable of setting freely by a user. The arithmetic unit 253 obtains these parameters in advance and generates image data in accordance with the parameters.

Image data generated for the i-th time (i is an integer of 1 to N) can be generated by weighting the data of the image A and the data of the image B and adding the weighted data. For example, when the luminance (gray level) of a pixel displaying the image A is denoted by a and that of the pixel displaying the image B is denoted by b, the luminance (gray level) c of the pixel displaying an image corresponding to the image data generated for the i-th time is represented by Formula 1.

$$\begin{matrix}[ FORMULA 1 ] & \\ c = \frac{( N - i ) a + i b}{N} & ( 1 )\end{matrix}$$

Display switches from the image A to the image B with the use of the image data generated by the above method, whereby discontinuous image can be switched gradually (smoothly) and naturally.

Note that in Formula 1, the case where a=0 in all the pixels corresponds to fade-in by which a black image switches gradually to the image B. Moreover, the case where b=0 in all the pixels corresponds to fade-out by which the image A switches gradually to a black image.

Although the method of switching images by temporarily overlapping two images is described above, a method without overlapping operation may be employed.

In the case of not overlapping two images when display switches from the image A to the image B, a black image may be inserted between the image A and the image B. At this time, the above method of switching images may be employed when the image A changes into a black image and/or when a black image changes into the image B. Further, an image inserted between the image A and the image B is not limited to a black image, and may be a single-color image such as a white image or a multi-color image different from the image A and the image B.

When an image, particularly a single-color image such as a black image is inserted between the image A and the image B, the user can perceive that image switching is more natural, so that images can be switched without making the user feel stress.

### Embodiment 6

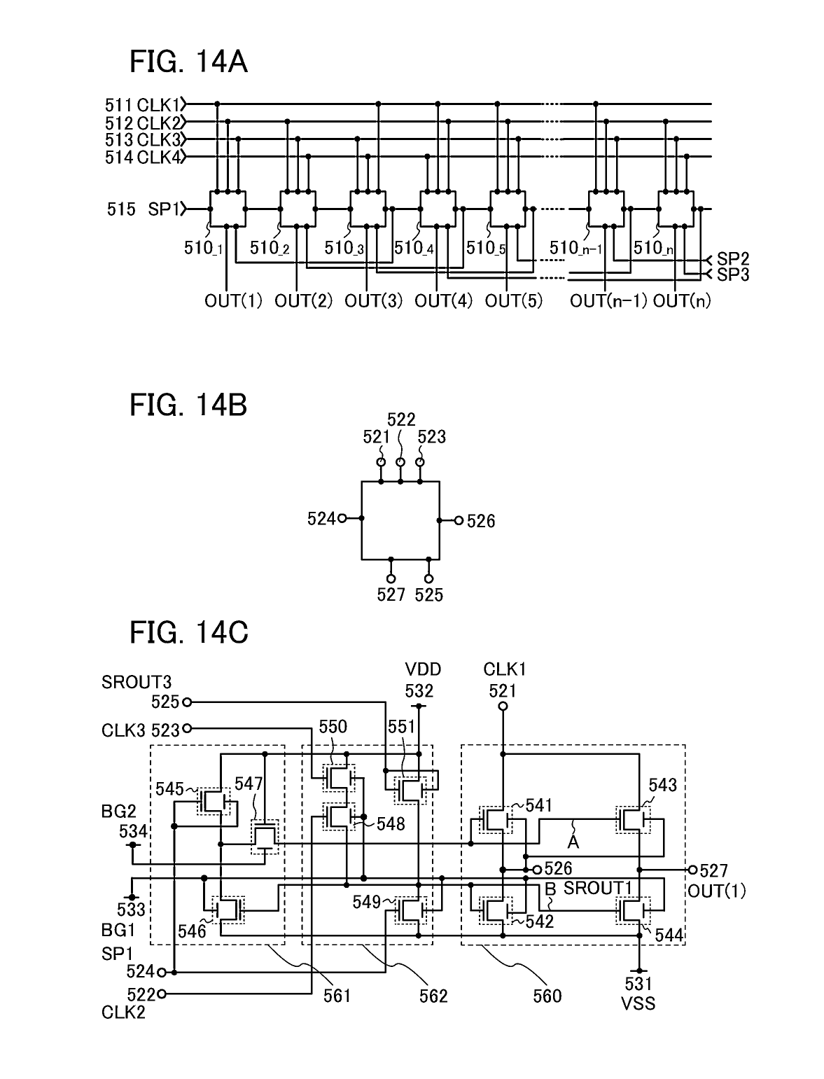

In this embodiment, a structure of a shift register included in the first driver circuit and the second driver circuit in the display portion described in the above embodiment will be described with reference to FIGS. 14A to 14C, FIG. 15, and FIG. 16.

### <Circuit Structure>

FIGS. 14A to 14C illustrate a structure example of the shift register in this embodiment.

The shift register illustrated in FIG. 14A includes a first pulse output circuit 510_{—1} to an n-th pulse output circuit 510_{—n} (n is a natural number greater than or equal to 2) and a wiring 511 to a wiring 514 transmitting clock signals. A clock signal CLK1 is supplied to the wiring 511. A clock signal CLK2 is supplied to the wiring 512. A clock signal CLK3 is supplied to the wiring 513. A clock signal CLK4 is supplied to the wiring 514.

The clock signal is a signal which alternates between a High signal with a high potential (hereinafter denoted by H-level signal) and a Low signal with a low potential (hereinafter denoted by L-level signal) at regular intervals. Here, the clock signals CLK1 to CLK4 are delayed by ¼ period sequentially. In this embodiment, by utilizing the clock signal, the first pulse output circuit 510_{—1} to the n-th pulse output circuit 510_{—n} are controlled, for example.

As illustrated in FIG. 14B, the first pulse output circuit 510_{—1} to the n-th pulse output circuit 510_{—n} each have an input terminal 521, an input terminal 522, an input terminal 523, an input terminal 524, an input terminal 525, an output terminal 526, and an output terminal 527.

The input terminals 521, 522, and 523 are electrically connected to any of the wirings 511 to 514. For example, in the first pulse output circuit 510_{—1}, the input terminal 521 is electrically connected to the wiring 511, the input terminal 522 is electrically connected to the wiring 512, and the input terminal 523 is electrically connected to the wiring 513. In the second pulse output circuit 510_{—2}, the input terminal 521 is electrically connected to the wiring 512, the input terminal 522 is electrically connected to the wiring 513, and the input terminal 523 is electrically connected to the wiring 514. Note that here the case where signal lines connected to the n-th pulse output circuit 510_{—n} are the wirings 512, 513, and 514 is described. However, the signal lines that are connected to the n-th pulse output circuit 510_{—n} is changed depending on the value of n. Thus, it is to be noted that the structure described herein is just an example.

In the m-th pulse output circuit (m is a natural number greater than or equal to 2) in the shift register in this embodiment, the input terminal 524 is electrically connected to the output terminal 526 of the (m−1)th pulse output circuit, the input terminal 525 is electrically connected to the output terminal 526 of the (m+2)th pulse output circuit, the output terminal 526 is electrically connected to the input terminal 524 of the (m+1)th pulse output circuit and the input terminal 525 of the (m−2)th pulse output circuit. The output terminal 527 outputs a signal to OUT(m).

For example, in the third pulse output circuit 510_{—3}, the input terminal 524 is electrically connected to the output terminal 526 of the second pulse output circuit 510_{—2}, the input terminal 525 is electrically connected to the output terminal 526 of the fifth pulse output circuit 510_{—5}, the output terminal 526 is electrically connected to the input terminal 524 of the fourth pulse output circuit 510_{—4} and the input terminal 525 of the first pulse output circuit 510_{—1}.

In addition, a start pulse (SP1) is input from a wiring 515 to the input terminal 524 in the first pulse output circuit 510_{—1}. Note that the start pulse is a clock signal. A pulse output from the previous stage is input to the input terminal 524 in the k-th pulse output circuit 510_{—k} (k is a natural number greater than or equal to 2 and less than or equal to n). The start pulse (SP2) is input to the input terminal 525 of the (n−1)th pulse output circuit 510_{—(n-1)}. In the n-th pulse output circuit 510_{—n}, the start pulse (SP3) is input to the input terminal 525. The start pulse (SP2) and the start pulse (SP3) may be input from the outside or generated inside the circuit.

Next, a specific structure of the first pulse output circuit 510_{—1} to the n-th pulse output circuit 510_{—n} will be described.

As illustrated in FIG. 14C, each of the first pulse output circuit 510_{—1} to the n-th pulse output circuit 510_{—n} includes a pulse signal generation circuit 560 including a transistor 541 to a transistor 544, a first input signal generation circuit 561 including a transistor 545 to a transistor 547, and a second input signal generation circuit 562 including a transistor 548 to a transistor 551.

Each of the transistors 541 to 551 includes a first gate and a second gate which are provided over and below a semiconductor film with insulating films laid therebetween, and one of a source and a drain (drain terminal) and the other of the source and the drain (source terminal) which are in contact with the semiconductor film.

Note that in the following description, the transistors 541 to 551 are all n-channel transistors.

The transistors 541 to 551 preferably each include an oxide semiconductor in semiconductor films. When an oxide semiconductor is included in the transistor, the off-state current of the transistor can be reduced. Further, the on-state current and field-effect mobility can be increased as compared with those in the case where amorphous silicon or the like is used. Furthermore, the deterioration of the transistor can be suppressed. Thus, an electronic circuit which consumes low power, can operate at high speed, and operates with higher accuracy is realized. Note that the description of the transistor including an oxide semiconductor is omitted here because it is described in detail in an embodiment below.

A structure of a pulse output circuit illustrated in FIG. 14C is described.

The one of the source and the drain of the transistor 541 is connected to the input terminal 521. The other of the source and the drain of the transistor 541 is connected to the output terminal 526. The first gate of the transistor 541 is connected to the other of the source and the drain of the transistor 547. The second gate of the transistor 541 is connected to the output terminal 526.

The one of the source and the drain of the transistor 542 is connected to the output terminal 526. The other of the source and the drain of the transistor 542 is connected to a power supply line 531. The first gate of the transistor 542 is connected to the other of the source and the drain of the transistor 548. The second gate of the transistor 542 is connected to a power supply line 533.

The one of the source and the drain of the transistor 543 is connected to the input terminal 521. The other of the source and the drain of the transistor 543 is connected to the output terminal 527. The first gate of the transistor 543 is connected to the other of the source and the drain of the transistor 547. The second gate of the transistor 543 is connected to the output terminal 526.

The one of the source and the drain of the transistor 544 is connected to the output terminal 527. The other of the source and the drain of the transistor 544 is connected to the power supply line 531. The first gate of the transistor 544 is connected to the other of the source and the drain of the transistor 548. The second gate of the transistor 544 is connected to the power supply line 533.

The one of the source and the drain of the transistor 545 is connected to a power supply line 532. The other of the source and the drain of the transistor 545 is connected to the one of the source and the drain of the transistor 546 and the one of the source and the drain of the transistor 547. The first gate and the second gate of the transistor 545 is connected to the input terminal 524.

The one of the source and the drain of the transistor 546 is connected to the other of the source and the drain of the transistor 545 and the one of the source and the drain of the transistor 547. The other of the source and the drain of the transistor 546 is connected to the power supply line 531. The first gate of the transistor 546 is connected to the other of the source and the drain of the transistor 548. The second gate of the transistor 546 is connected to the power supply line 533.

The one of the source and the drain of the transistor 547 is connected to the other of the source and the drain of the transistor 545 and the one of the source and the drain of the transistor 546. The other of the source and the drain of the transistor 547 is connected to the first gate of the transistor 541 and the first gate of the transistor 543.

The first gate of the transistor 547 is connected to the power supply line 532. The second gate of the transistor 547 is connected to a power supply line 534.

The one of the source and the drain of the transistor 548 is connected to the other of the source and the drain of the transistor 550. The other of the source and the drain of the transistor 548 is connected to the first gate of the transistor 542, the first gate of the transistor 544, and the first gate of the transistor 546. The first gate of the transistor 548 is connected to the input terminal 522. The second gate of the transistor 548 is connected to the power supply line 533.

The one of the source and the drain of the transistor 549 is connected to the other of the source and the drain of the transistor 548. The other of the source and the drain of the transistor 549 is connected to the power supply line 531. The first gate of the transistor 549 is connected to the input terminal 524. The second gate of the transistor 549 is connected to the power supply line 533.

The one of the source and the drain of the transistor 550 is connected to the power supply line 532. The other of the source and the drain of the transistor 550 is connected to the one of the source and the drain of the transistor 548. The first gate of the transistor 550 is connected to the input terminal 523. The second gate of the transistor 550 is connected to the power supply line 533.

The one of the source and the drain of the transistor 551 is connected to the power supply line 532. The other of the source and the drain of the transistor 551 is connected to the other of the source and the drain of the transistor 548. The first gate and the second gate of the transistor 551 are connected to the input terminal 525.

Note that components of the pulse output circuit (e.g., the pulse signal generation circuit 560, the first input signal generation circuit 561, and the second input signal generation circuit 562) are just examples, and one embodiment of the present invention is not limited thereto.

In the case where the pulse output circuit illustrated in FIG. 14C is the first pulse output circuit 510_{—1} illustrated in FIG. 14A, the clock signal CLK1, the clock signal CLK2, the clock signal CLK3, the start pulse SP1, and an output signal of the third first pulse output circuit 510_{—3} (denoted by SROUT3) are input to the input terminal 521, the input terminal 522, the input terminal 523, the input terminal 524, and the input terminal 525, respectively. In addition, an output signal of the first pulse output circuit 510_{—1} (denoted by SROUT1) is output from the output terminal 526 to the input terminal 524 of the second first pulse output circuit 510_{—2}. An output signal OUT(1) is output from the output terminal 527. Note that an H-level signal and an L-level signal which are supplied to each input terminal are VDD and VSS, respectively.

Further, VSS, VDD, BG1, and BG2 are supplied to the power supply line 531, the power supply line 532, the power supply line 533, and the power supply line 534, respectively. Note that BG1 is lower than GND (negative potential) and BG2 is higher than or equal to GND.

In the following description of this embodiment, in the pulse output circuit illustrated in FIG. 14C, a connection portion of the first gate of the transistor 541, the first gate of the transistor 543, and the other of the source and the drain of the transistor 547 is a node A. Further, a connection portion of the first gate of the transistor 542, the first gate of the transistor 544, the first gate of the transistor 546, the other of the source and the drain of the transistor 548, the one of the source and the drain of the transistor 549, and the other of the source and the drain of the transistor 551 is a node B.

A capacitor for favorably performing bootstrap operation may be provided between the node A and the output terminal 526. Further, a capacitor electrically connected to the node B may be provided in order to hold the potential of the node B.

In FIG. 14C, the ratio W/L of the channel width W to the channel length L of the transistor 541 and the ratio W/L of the channel width W to the channel length L of the transistor 543 are each preferably larger than the ratio W/L of the channel width W to the channel length L of the transistor 546.

In FIG. 14C, the ratio W/L of the channel width W to the channel length L of the transistor 545 is preferably larger than the ratio W/L of the channel width W to the channel length L of the transistor 546. The ratio W/L of the channel width W to the channel length L of the transistor 545 is preferably equal to the ratio W/L of the channel width W to the channel length L of the transistor 547. Alternatively, the ratio W/L of the channel width W to the channel length L of the transistor 545 is preferably larger than the ratio W/L of the channel width W to the channel length L of the transistor 547.

In FIG. 14C, the ratio W/L of the channel width W to the channel length L of the transistor 543 is preferably larger than the ratio W/L of the channel width W to the channel length L of the transistor 544.

In FIG. 14C, the channel width W of the transistor 548 and the channel width W of the transistor 550 are each preferably smaller than the channel width W of the transistor 551.

The operations of the transistor 541 and the transistor 543 affect the signal SROUT1 output from the output terminal 526 and the signal OUT(1) output from the output terminal 527.

Accordingly, the second gate of the transistor 541 and the second gate of the transistor 543 are connected to the output terminal 526 as illustrated in FIG. 14C. Thus, when the transistor 541 and the transistor 543 are in an on state, the threshold voltages shift in the negative direction; accordingly, the transistors function as normally-on transistors. As a result, on-state current is increased. In addition, when the transistor 541 and the transistor 543 are in an off state, the threshold voltages shift in the positive direction; accordingly, the transistors function as normally-off transistors. As a result, leakage current is decreased.

In addition, since current can be increased when the transistor 541 and the transistor 543 are in an on state, the channel widths W of the transistor 541 and the transistor 543 can be low in comparison with the case where the transistors do not include second gates. Thus, layout area and power consumption can be reduced.

The transistor 542, the transistor 544, the transistor 548, the transistor 549, and the transistor 550 control the potential of the node B. Accordingly, when the threshold voltages of these transistors are changed and leakage current is generated, the transistors cannot control the potential of the node B.

In view of the above problem, as illustrated in FIG. 14C, the second gate of the transistor 542, the second gate of the transistor 544, the second gate of the transistor 548, the second gate of the transistor 549, and the second gate of the transistor 550 are connected to the power supply line 533 supplying a negative potential. Thus, since the transistors in an off state can definitely function as normally-off transistors, leakage current can be reduced.

Further, the operation of the transistor 545 affects the operations of the transistor 541 and the transistor 543. The operation of the transistor 551 affects the operations of the transistor 542, the transistor 544, and the transistor 546.

Accordingly, as illustrated in FIG. 14C, the second gate of the transistor 545 is connected to the first gate of the transistor 545, and the second gate of the transistor 551 is connected to the first gate of the transistor 551. Thus, when the transistor 545 and the transistor 551 are in an on state, the threshold voltages shift in the negative direction; accordingly, the transistors can be function as normally-on transistors. As a result, on-state current is increased. In addition, when the transistor 545 and the transistor 551 are in an off state, the threshold voltages shift in the positive direction; accordingly, the transistors function as normally-off transistors. As a result, leakage current is decreased.

When the threshold voltage of the transistor 547 is too low (e.g., —10 V), a voltage of ((V_{A}−Vth₅₄₇)−VSS) is applied between the source and the drain of the transistor 546. Note that V_{A} is the potential of the node A. Therefore, the load of the transistor 546 might be large.

In view of the above problem, the second gate of the transistor 547 is connected to the power supply line 534, whereby a potential of BG2 which is lower than or equal to GND is supplied to the second gate of the transistor 547. Thus, the threshold voltage of the transistor 547 can be controlled to be approximately 0 V; therefore, the load of the transistor 546 can be prevented from being large.

### <Operation>

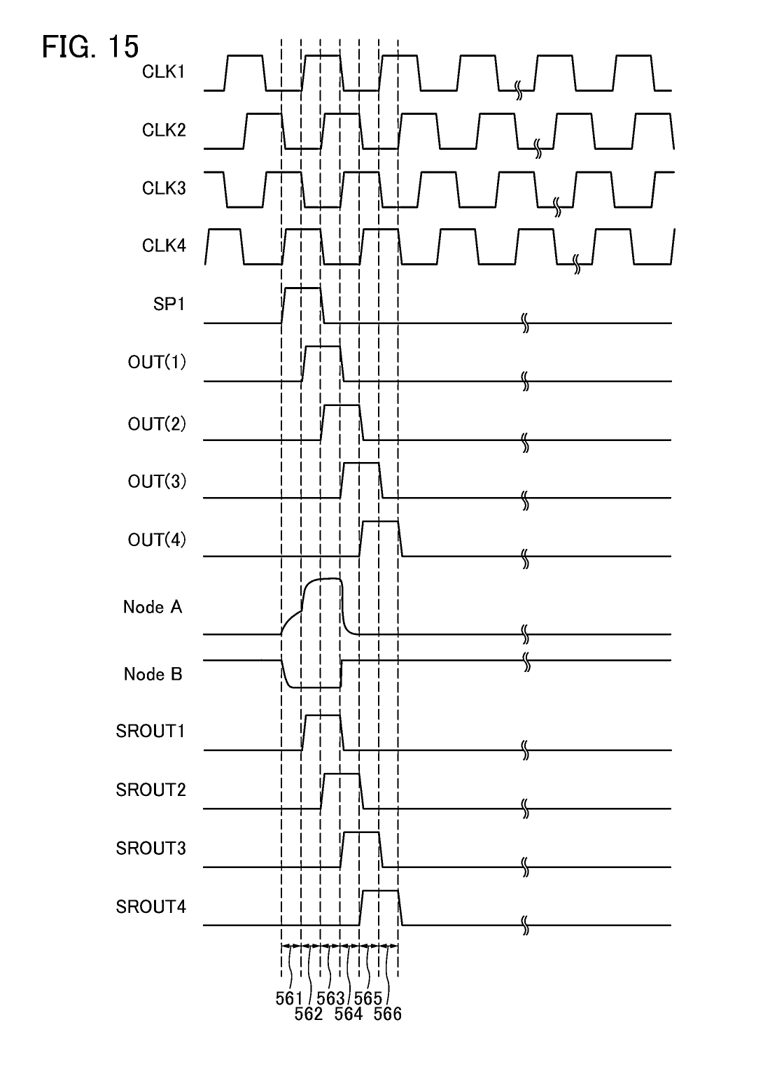

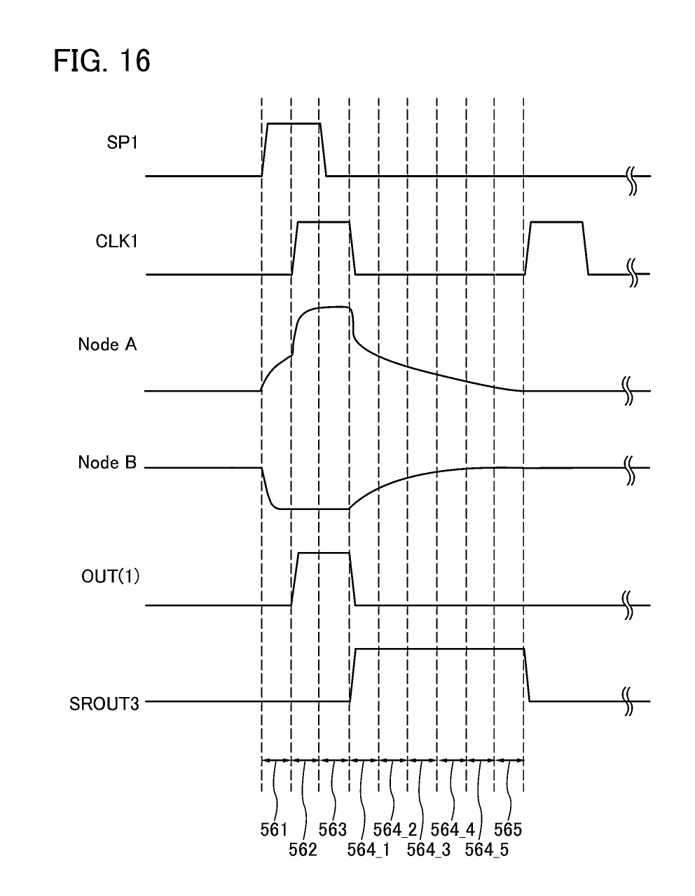

Next, the operation of the shift register illustrated in FIGS. 14A to 14C is described with reference to FIG. 15 and FIG. 16. Note that in a timing chart in FIG. 16, part of the periods shown in FIG. 15 is exaggerated; for example, the fourth period 564 is divided into five periods (periods 564_1 to 564_5). However, this timing chart is not largely different from the timing chart in FIG. 15. In the timing charts illustrated in FIG. 15 and FIG. 16, CLK1 to CLK4 denote clock signals; SP1 denotes a first start pulse; OUT(1) to OUT(4) denote outputs from the output terminals 527 in the first to fourth pulse output circuits 510_{—1} to 510_{—4}; node A and node B denote respective potentials at the node A and the node B; and SROUT1 to SROUT4 denote outputs from the output terminals 526 in the first to fourth pulse output circuits 510_{—1} to 510_{—4}.

Typically, the operation of the first pulse output circuit 510_{—1} is described. The configuration of the first pulse output circuit 510_{—1} is as illustrated in FIG. 14C. The relation among input signals and supplied potentials is also as illustrated in FIG. 14C.

In the first period 561, an H-level signal is input to the input terminal 524 as SP1, whereby VDD is supplied to the first gate of the transistor 545, the second gate of the transistor 545, and the first gate of the transistor 549; accordingly, the transistor 545 and the transistor 549 are turned on. Further, an H-level signal is input to the input terminal 523 as CLK3, whereby VDD is supplied to the first gate of the transistor 550; accordingly, the transistor 550 is also turned on. Furthermore, VDD is supplied from the power supply line 532 to the first gate of the transistor 547; accordingly, the transistor 547 is also turned on. In addition, BG1 (e.g., a negative potential) is supplied from the power supply line 533 to the second gate of the transistor 549 and the second gate of the transistor 550, and BG2 (e.g., GND) is supplied from the power supply line 534 to the second gate of the transistor 547. At that time, an H-level signal is input to the second gate of the transistor 545, whereby the threshold voltage of the transistor 545 shifts in the negative direction and thus the transistor 545 can function as a normally-on transistor; therefore, on-state current can be increased.

When the transistor 545 and the transistor 547 are turned on, the potential of the node A is increased. When the transistor 549 is turned on, the potential of the node B is decreased. The potential of the one of the source and the drain of the transistor 545 is VDD, and therefore, the potential of the other of the source and the drain of the transistor 545 is the value (VDD−Vth₅₄₅), in which the threshold voltage of the transistor 545 is subtracted from the potential of the one of the source and the drain of the transistor 545. Since the potential of the first gate of the transistor 547 is VDD, the potential of the node A is (VDD−Vth₅₄₇) when Vth₅₄₇ which is the threshold voltage of the transistor 547 is equal to or higher than Vth₅₄₅, whereby the transistor 547 is turned off. On the other hand, when Vth₁₀₇ is lower than Vth₅₄₅, the potential of the node A rises to VDD−Vth₅₄₅ while the transistor 547 is kept on. Hereinafter, a mark (the highest potential) of the node A in the first period 561 is denoted by V_{AH}.

When the potential of the node A is V_{AH}, the potential V_{AH} is input to the first gate of the transistor 541 and the first gate of the transistor 543, the transistor 541 and the transistor 543 are turned on. Here, an L-level signal is input to the input terminal 521 as CLK1, whereby VSS is output from the output terminal 526 and the output terminal 527 as SROUT1 and OUT(1), respectively.

In the second period 562, an H-level signal is input to the input terminal 521 as CLK1. Since the transistor 541 and the transistor 543 are in an on state, the potential of the output terminal 526 and the potential of the output terminal 527 are increased. Accordingly, the potentials input to the second gate of the transistor 541 and the second gate of the transistor 543 are also increased. Further, capacitance is generated between the first gate of the transistor 541 and the other of the source and the drain of the transistor 541, whereby the first gate and the other of the source and the drain of the transistor 541 are capacitively coupled. Similarly, capacitance is generated between the first gate of the transistor 543 and the other of the source and the drain of the transistor 543, whereby the first gate and the other of the source and the drain of the transistor 543 are capacitively coupled. Thus, the potential of the node A in a floating state is increased as the potential of the output terminal 526 and the potential of the output terminal 527 are increased (bootstrap operation). As a result, the potential of the node A becomes higher than VDD+Vth₅₄₁, and VDD is output from the output terminal 526 and the output terminal 527 as SROUT1 and OUT(1), respectively. At that time, the second gate of the transistor 541 and the second gate of the transistor 543 are connected to the output terminal 526, and therefore, VDD is supplied to the second gate of the transistor 541 and the second gate of the transistor 543.

Here, current is defined by the following formula. Salutation characteristics and liner characteristics are expressed by Formula 2 and Formula 3, respectively.

I=(½)β(Vg−Vth)² (Formula 2)

I=β((Vg−Vth)−½Vd)Vd (Formula 3)

As expressed by Formula 1 and Formula 2, current is proportional to (Vg−Vth)² or (Vg−Vth). Formula 1 and Formula 2 show that (Vg−Vth) is increased by negative shifts of the threshold voltages of the transistor 541 and the transistor 543, whereby the current is increased.

Therefore, by controlling the threshold voltages of the transistor 541 and the transistor 543, current can be increased when the transistor 541 and the transistor 543 are in an on state. Thus, time required for charging the output terminal 527 can be shorter. Further, layout area and power consumption can be reduced.

In the second period 562, the transistor 549 is in an on state; therefore, the node B is kept at VSS. Thus, variation in the potential of the node B due to capacitive coupling, which occurs when the potential of the output terminal 526 is changed from VSS to VDD, can be suppressed, so that a malfunction due to the variation in the potential can be prevented.

As described above, in the second period 562, in the case where the potential of the output terminal 527 is at VDD, a gate voltage (Vg) of the transistor 543 needs to be sufficiently high for turning on the transistor 543 in order to definitely increase the potential of the output terminal 527 to VDD. In the case where the gate voltage Vg of the transistor 543 is low, a drain current of the transistor 543 is small, so that it takes a long time to increase the potential of the output terminal 527 to VDD in the specified period (here, in the second period 562). Accordingly, a rising edge of a waveform of the potential of the output terminal 527 becomes rounded, which leads to a malfunction.

Note that the level of the gate voltage Vg of the transistor 543 in the second period 562 depends on the potential of the node A in the first period 561. Therefore, in order to increase the gate voltage Vg of the transistor 543, the potential of the node A should be as high as possible in the first period 561 (the maximum value is VDD−Vth₅₄₅ or VDD−Vth₅₄₇ in consideration of the circuit design). The same can be said also for the output terminal 526 and the gate voltage Vg of the transistor 541.

Therefore, the ratio W/L of the channel width W to the channel length L of the transistor 545 is preferably larger than the ratio W/L of the channel width W to the channel length L of the transistor 546. When the ratio W/L of the channel width W to the channel length L of the transistor 545 is larger than the ratio W/L of the channel width W to the channel length L of the transistor 546, the potential of the node A in the first period 561 can be increased to VDD−Vth₅₄₅ or VDD−Vth₅₄₇ in a shorter time. Note that in the first period 561, the transistor 546 is in an off state. When the ratio W/L of the channel width W to the channel length L of the transistor 545 is made larger than the ratio W/L of the channel width W to the channel length L of the transistor 546, leakage current (Ioff) in the transistor 546 can be small, and thus the potential of the node A can be increased to VDD−Vth₅₄₅ in a shorter time.

When the channel length L becomes short due to miniaturization of the transistor, the threshold voltage shifts to the negative direction and the transistor 546 functions as a normally-on transistor in some cases. Even in such a case, when the ratio W/L of the channel width W to the channel length L of the transistor 546 is made smaller than the ratio W/L of the channel width W to the channel length L of the transistor 545, the on resistance of the transistor 546 can be larger than the on resistance of the transistor 545. Accordingly, the potential of the node A can be made to be a potential close to VDD−Vth₅₄₅ or VDD−Vth₅₄₇.

The ratio W/L of the channel width W to the channel length L of the transistor 545 is preferably almost equal to the ratio W/L of the channel width W to the channel length L of the transistor 547. The expression “almost equal” can be used in the case where it would be understood that two objects had the same value in consideration of a slight difference due to an error in manufacturing or variation. When the ratio W/L of the channel width W to the channel length L of the transistor 545 and the ratio W/L of the channel width W to the channel length L of the transistor 547 are equal to each other, the current supply capability of the transistor 545 and that of the transistor 547 can be equal to each other; thus, the potential of the node A can be efficiently increased. As described above, the threshold voltage Vth₅₄₅ of the transistor 545 and Vth₅₄₇ of the transistor 547 are preferably almost equal to each other.

Note that the ratio W/L of the channel width W to the channel length L of the transistor 545 can be determined in consideration of the transistor characteristics, the clock frequency, the gate capacitance of the transistor 541, the gate capacitance of the transistor 543, the operating voltage of the shift register, or the like.

When the channel width W of the transistor 546 is large, leakage current is increased in the case where the transistor 546 functions as a normally-on transistor; accordingly, the potential of the node A is decreased. Further, charge of the node A by the transistor 545 is prevented. In the case where high-speed operation is required, the potential of the node B needs to be decreased in a short time in order to charge the node A in a short time. In such a case, the potential of the transistor 546 needs to be decreased in a short time.

Therefore, when the channel width W of the transistor 546 is smaller than that of the transistor 545, the leakage current of the transistor 546 can be reduced and a change in potential of the node A can be prevented. Further, a load of the node B can be reduced. In such a manner, the sizes of the transistor 545, the transistor 546, and the transistor 547 are determined in consideration of the transistor characteristics and the driving specification, whereby a shift register with high efficiency can be obtained.

In addition, as described above, BG2 is supplied from the power supply line 534 to the second gate of the transistor 547. Thus, the threshold voltage of the transistor 547 can be controlled to be approximately 0 V; therefore, the load of the transistor 546 can be prevented from being large even when a voltage of ((V_{A}−Vth₅₄₇)−VSS) is applied between the source and the drain of the transistor 546. Note that V_{A} is the potential of the node A.

In the third period 563, an L-level signal is input to the input terminal 524 as SP1, whereby VSS is supplied to the first gate of the transistor 545, the second gate of the transistor 545, and the first gate of the transistor 549; accordingly, the transistor 545 and the transistor 549 are turned off. Further, CLK1 input to the input terminal 521 is kept at an H-level signal and the potential of the node A is not changed, and therefore, VDD is output from the output terminal 526 and the output terminal 527 as SROUT1 and OUT(1), respectively. Note that in the third period 563, although the node B is in a floating state, the potential of the output terminal 526 is not changed; therefore, a malfunction due to the capacitive coupling is negligible.

In the fourth period 564, an H-level signal is input to the input terminal 522 as CLK2 and an H-level signal is input to the input terminal 523 as CLK3, whereby VDD is supplied to the first gate of the transistor 548 and the first gate of the transistor 550; accordingly, the transistor 548 and the transistor 550 are turned on. Further, an H-level signal is input to the input terminal 525 as SROUT3 and VDD is input to the first gate of the transistor 551 and the second gate of the transistor 551, whereby the transistor 551 is turned on. The transistor 551 is turned on, whereby the potential of the node B is charged to VDD−Vth₅₅₁ in a short time. Thus, the transistor 542, the transistor 544, and the transistor 546 are turned on. An L-level signal is input to the input terminal 521 as CLK1, whereby the transistor 541 and the transistor 543 are turned off. As a result, VSS is output from the output terminal 526 and the output terminal 527 as SROUT1 and OUT(1), respectively. Here, an H-level signal is input to the second gate of the transistor 551, whereby the threshold voltage of the transistor 551 shifts in the negative direction and thus the transistor 551 can function as a normally-on transistor; therefore, on-state current can be increased.

At this time, the node B is charged through the transistor 550 and the transistor 548 in addition to the transistor 551. The first gate of the transistor 550 and the first gate of the transistor 548 are connected to the input terminal 523 and the input terminal 522, respectively, and the gate capacitance of the transistor 550 and the gate capacitance of the transistor 548 correspond to the load of the input terminal 523 and the load of the input terminal 522, respectively.

In the fourth period 564, the potential of the node A should be decreased to VSS before CLK1 becomes H-level signal in the sixth period (that is, during the fourth period 564 and the fifth period 565). When the potential of the node A is not decreased to VSS during the fifth period 565, the potential of the node A is increased again because of the capacitive coupling between the gate and the source of the transistor 543; thus, the transistor 541 and the transistor 543 are turned on, and current flows through the output terminal 526 and the output terminal 527, so that a malfunction might occur.

Therefore, a relation among the transistor 541, the transistor 543, and the transistor 546 is determined as the following formulae (4) to (10), whereby the operation malfunction due to a load is reduced and stabilization of the operation can be achieved.

$$\begin{matrix}[ FORMULA 4 ] & \\ {i}_{546} = \frac{( {C}_{546} + {C}_{543} ) \times {V}_{f}}{{t}_{offf}} & ( 4 ) \\ [ FORMULA 5 ] & \\ {i}_{546} = \frac{{W}_{546}}{2 {L}_{546}} \times μ \times Cox \times {( {Vgs}_{546} - {Vth}_{546} )}^{2} & ( 5 ) \\ [ FORMULA 6 ] & \\ \frac{1}{{f}_{clk}} = T = {t}_{CKH} + {t}_{CKL} & ( 6 ) \\ [ FORMULA 7 ] & \\ {t}_{off} = {t}_{CKL} - {t}_{α} & ( 7 ) \\ [ FORMULA 8 ] & \\ {C}_{541} = {L}_{541} \times {W}_{541} \times Cox & ( 8 ) \\ [ FORMULA 9 ] & \\ {C}_{543} = {L}_{543} \times {W}_{543} \times Cox ( Cox = \frac{{ɛ}_{o} \times {ɛ}_{r}}{tox} ) & ( 9 ) \\ [ FORMULA 10 ] & \\ {V}_{f} = ( VDD - {Vth}_{545} ) + VDD & ( 10 )\end{matrix}$$

In the above formulae, t_{CKH} corresponds to a period during which CLK1 is a H-level signal, that is, the second period 562 and the third period 563; t_{cKE}, corresponds to a period during which CLK1 is an L-level signal, that is, the fourth period 564 and the fifth period 565; and t_{off} corresponds to a time required for decreasing the potential of the node A to VSS. That is, in t_{CKL}, the potential of the node A is decreased to VSS in t_{off}. t_{off} is not particularly limited as long as it is spent in a period from the fourth period 564 through the fifth period 565; for example, t_{off} may be spent in the period 564_1, in a period from the period 564_1 to the period 564_3, or in the period from the period 564_1 to the period 564_5 (see FIG. 16). In particular, the period from the period 564_1 to the period 564_3 corresponding to ½ of the period from the fourth period 564 to the fifth period 565 is preferable. The reason of this is as follows: when t_{off} is set too short with respect to t_{cKL}, the channel width W of the transistor 546 needs to be set large in order to decrease the potential of the node A quickly, and in contrast, when t_{off} is set long, the potential of the node A cannot be decreased to VSS by the time a next H-level clock signal is input and a malfunction might occur. That is, t_{off} needs to be determined in consideration of the frequency of the clock signal or the like.

C₅₄₁ and C₅₄₃ denote the gate capacitance of the transistor 541 and the gate capacitance of the transistor 543, respectively. V_{f} denotes the potential of the node A in the third period 563.

i₅₄₆ in the formula (3) denotes the drain current of the transistor 546. With the use of this, the size (e.g., W/L) of the transistor 546 can be determined. In other words, the size of the transistor 546 can be determined in consideration of the operating frequency of CLK1, the size of the transistor 541, the size of the transistor 543, and the potential of the node A.

For example, in the case where the operating frequency of CLK1 is high, the potential of the node A needs to be decreased quickly; thus, t_{off} should be short as seen from the formula (2). Therefore, i₅₄₆ needs to be large. W₅₄₆ is calculated in accordance with i₅₄₆ from the formula (3) and can be determined.

On the other hand, in the case where the size of the transistor 541 and the size of the transistor 543 are small, i₅₄₆ may be small; thus, W₅₄₆ becomes small from the formula (3). Note that the transistor 543 is used for charge and discharge of an output load. When the size of the transistor 543 is increased, not only the transistor 544 but also the transistor 543 can be discharged at the time of discharge. Accordingly, the output potential can be decreased in a short time. Therefore, when the potential of the node A is gradually decreased, the output potential can be decreased in a short time as compared with that in the case where only the transistor 544 is discharged, because the transistor 543 is in an on state. In such a manner, the size of the transistor 546 is determined in consideration of the transistor characteristics and the driving specification, whereby a shift register with high efficiency can be obtained.

Note that in the shift register described in this embodiment, loads of the transistors connected to a clock line are expressed as “the total number of the stages of the shift register÷4×(Lₒᵥ of the transistor 543+Lₒᵥ of the transistor 541+the gate capacitance of the transistor 550+the gate capacitance of the transistor 548)”. Note that the gate capacitance is expressed as “ε₀×ε×(L×W)/tox”. Note that Lₒᵥ represents the length of a region where a source electrode layer or a drain electrode layer of a transistor overlaps with a semiconductor layer in a channel length direction.

In order to reduce the gate capacitance connected to the clock line, the channel width W of the transistor 548 and the channel width W of the transistor 550 are each preferably smaller than the channel width W of the transistor 551. With such a structure, the load of the clock line can be reduced, whereby the high-speed operation can be achieved. When the channel width W of the transistor 550 and that of the transistor 548 are reduced, layout area can be decreased.

In the fifth period 565, an H-level signal is input to the input terminal 525 as SROUT3, whereby the potential of the node B is kept. Thus, the on states of the transistor 542, the transistor 544, and the transistor 546 are kept and the potentials output from the output terminal 526 and the output terminal 527 as SROUT1 and OUT(1), respectively are kept at VSS.

In the sixth period 566, an L-level signal is input to the input terminal 525 as SROUT3, whereby VSS is input to the first gate of the transistor 551 and the second gate of the transistor 551; accordingly, the transistor 551 is turned off. At this time, the node B is brought into a floating state while keeping its potential. Thus, the on states of the transistor 542, the transistor 544, and the transistor 546 are kept.

Note that the potential of the node B usually falls due to the off-state current of a transistor, for example. In contrast, a transistor with a sufficiently small off-state current (e.g., a transistor including an oxide semiconductor) does not have such a problem. Note that in order to suppress the fall in the potential of the node B, a capacitor may be provided. The capacitor provided in this case is electrically connected to the first gate of the transistor 542, the first gate of the transistor 544, the first gate of the transistor 546, the one of the source and the drain of the transistor 548, and the one of the source and the drain of the transistor 549.

Note that when CLK2 input to the input terminal 522 and CLK3 input to the input terminal 523 become H-level signals in the subsequent period, VDD is supplied to the first gate of the transistor 548 and the first gate of the transistor 550, whereby the transistor 548 and the transistor 550 are turned on; accordingly, a potential is regularly supplied to the node B. Therefore, even when a transistor having a comparatively large off-state current is used, malfunctions of the pulse output circuit can be prevented.

Note that as for the outputs (such as OUT(1) to OUT(4)) from the shift register, there are the case where the time when the potential is increased is valued and the case where the time when the potential is decreased is valued. For example, in the case where data is determined by a potential increase (e.g., when data is written), the time when the potential is increased is valued. In the case where data is determined by a potential decrease, the time when the potential is decreased is valued.

In the case where data is determined by the potential increase, the time required for increasing the potential needs to be short. For that purpose, the ratio W/L of the channel width W to the channel length L of the transistor 543 is preferably larger than the ratio W/L of the channel width W to the channel length L of the transistor 544.

In the case where data is determined by the potential decrease, the time required for decreasing the potential needs to be short. For that purpose, the ratio W/L of the channel width W to the channel length L of the transistor 543 is preferably larger than the ratio W/L of the channel width W to the channel length L of the transistor 544.

Note that in one embodiment of the present invention, the potential of the node A is increased to a predetermined potential by bootstrap operation that utilizes the capacitive coupling between the gate and the source of the transistor 543. Accordingly, the transistor 543 is turned on, and an H-level signal is output. Therefore, when the ratio W/L of the channel width W to the channel length L of the transistor 543 is not sufficiently large, a problem might arise in that an H-level potential output from the shift register is not increased to VDD. Thus, it is preferable that the ratio W/L of the channel width W to the channel length L of the transistor 543 be sufficiently large.

In one embodiment of the present invention, the second gate of the transistor 541 and the second gate of the transistor 543 are connected to the output terminal 526. Thus, when the transistor 541 and the transistor 543 are in an on state, the threshold voltages shift in the negative direction; accordingly, the transistors function as normally-on transistors. As a result, on-state current is increased. In addition, when the transistor 541 and the transistor 543 are in an off state, the threshold voltages shift in the positive direction; accordingly, the transistors function as normally-on transistors. As a result, leakage current can be decreased. Thus, in comparison with the case where the transistors do not have second gates, the channel widths W of the transistor 541 and the transistor 543 can be small; accordingly, layout area and power consumption can be reduced.

Further, in one embodiment of the present invention, the second gate of the transistor 542, the second gate of the transistor 544, the second gate of the transistor 548, the second gate of the transistor 549, and the second gate of the transistor 550 are connected to the power supply line 533 supplying a negative potential. Thus, since the transistors in an off state can definitely function as normally-off transistors, leakage current can be reduced.

In one embodiment of the present invention, the second gate of the transistor 545 is connected to the first gate of the transistor 545, and the second gate of the transistor 551 is connected to the first gate of the transistor 551. Thus, when the transistor 545 and the transistor 551 are in an on state, the threshold voltages shift in the negative direction; accordingly, the transistors function as normally-on transistors. As a result, on-state current is increased. In addition, when the transistor 545 and the transistor 551 are in an off state, the threshold voltages shift in the positive direction; accordingly, the transistors can function as normally-off transistors. As a result, leakage current can be decreased.

In addition, in one embodiment of the present invention, the second gate of the transistor 547 is connected to the power supply line 534. Thus, the threshold voltage of the transistor 547 can be controlled to be approximately 0 V; therefore, the load of the transistor 546 can be prevented from being large even when a voltage of ((V_{A}−Vth₅₄₇)−VSS) is applied between the source and the drain of the transistor 546. Note that V_{A} is the potential of the node A.

According to one embodiment of the present invention, even when the threshold voltages of the plurality of transistors included in the pulse output circuit are varied, the threshold voltage of each transistor can be controlled. Further, even when the degrees of variations of the threshold voltages of transistors are different, the threshold voltage of each transistor can be controlled regardless of degree of variation of the threshold voltage.

With the structure, by reducing leakage current and preventing malfunction, a pulse output circuit which can stably operate with low power consumption can be formed.

Note that, the shift register of this embodiment is driven by a driving method in which a pulse output from the m-th pulse output circuit overlaps with half of a pulse output from the (m+1)th pulse output circuit. Therefore, a wiring can be charged for a longer period of time as compared to the case where the driving method is not used. That is to say, with the driving method, a pulse output circuit which withstands a heavy load and operates at high frequency is provided.

Note that in the shift register described in this embodiment, transistors having the second gate electrode are shown as the transistors 541 to 551; however, one embodiment of the present invention is not limited thereto. The transistors 541 to 551 may be transistors not having the second gate electrode. The shift register may have both a transistor having the second gate electrode and a transistor not having the second gate electrode. Note that the shift register may include the transistor 550. It is also possible for the shift register not to include the transistor 550. The number of the output terminals is not limited to two, and may be one. That is, the output terminal 526 or the output terminal 527 may be omitted. Note that in this case, a transistor attached to the output terminal that is to be omitted (for example, in the case where the output terminal 527 is omitted, the transistor 543 and the transistor 544) may be omitted as appropriate.

This embodiment can be combined with any of the other embodiments disclosed in this specification as appropriate.

### Embodiment 7

In Embodiment 7, an example of the structure of a panel module that can be used as a display means of a liquid crystal display device in one embodiment of the present invention will be described with reference to drawings.

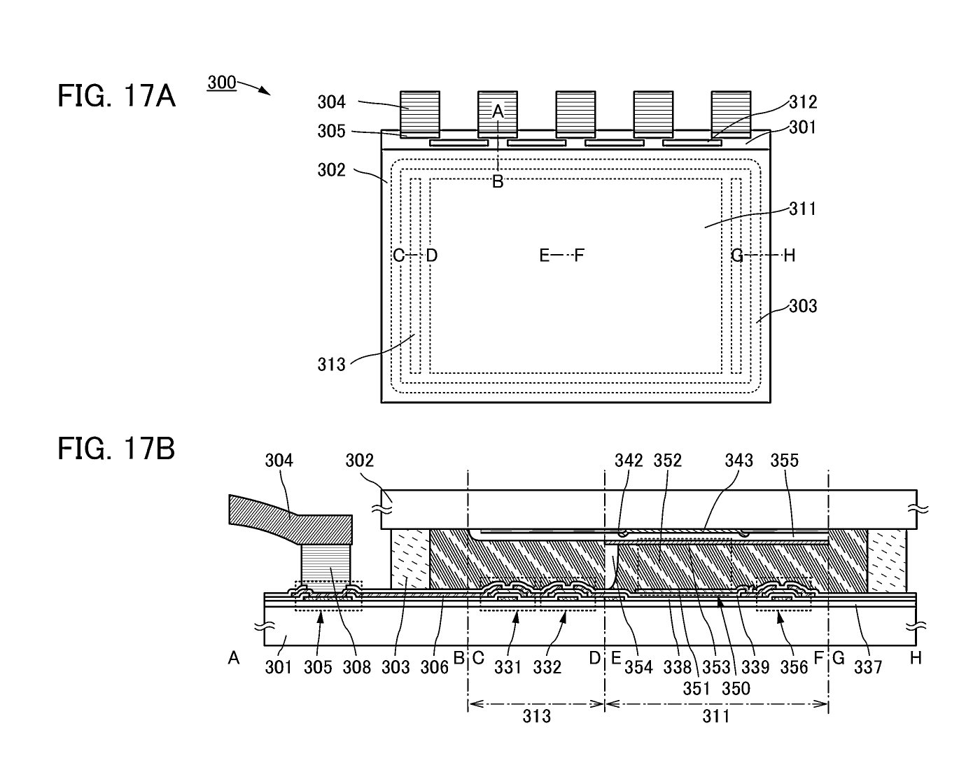

FIG. 17A is a top schematic diagram of a panel module 300 described in this embodiment.

The panel module 300 includes a pixel portion 311 including a plurality of pixels and a first driver circuit 313 in a sealed region surrounded by a first substrate 301, a second substrate 302, and a sealant 303. The first driver circuit 313 has a function as a scan signal line driver circuit. The panel module 300 also includes an external connection electrode 305 and an IC 312 functioning as a second driver circuit in a region outside the sealed region over the first substrate 301. The second driver circuit has functions as a data signal line driver circuit and a video signal driver circuit. Power and signals for driving the pixel portion 311, the first driver circuit 313, the IC 312, and the like can be input from an FPC 304 electrically connected to the external connection electrode 305.

FIG. 17B is a cross-sectional schematic diagram of a region including the FPC 304 and the sealant 303 along line A-B, a region including the first driver circuit 313 along line C-D, a region including the pixel portion 311 along line E-F, and a region including the sealant 303 along line G-H in FIG. 17A.

The first substrate 301 and the second substrate 302 are bonded to each other at their outer edge regions with the sealant 303. In the region surrounded by the first substrate 301, the second substrate 302, and the sealant 303, at least the pixel portion 311 is provided

FIGS. 17A and 17B illustrate an example where the first driver circuit 313 includes a circuit composed of n-channel transistors 331 and 332. Note that the first driver circuit 313 is not limited to having this structure and may include various CMOS circuits, in which an n-channel transistor and a p-channel transistor are used in combination, or a circuit composed of p-channel transistors. In this structure example, the panel module is a driver-integrated module in which the first driver circuit 313 is formed over the first substrate 301; however, one or both of the gate driver circuit and the second driver circuit may be provided over another substrate. For example, a driver circuit IC may be mounted by a COG method, or a flexible substrate (FPC) mounted with a driver circuit IC by a COF method may be mounted. In this structure example, the IC 312, which serves as the second driver circuit, is provided over the first substrate 301 by a COG method.

Note that there is no particular limitation on the structures of the transistors included in the pixel portion 311 and the first driver circuit 313. For example, a forward staggered transistor or an inverted staggered transistor may be used. Further, a top-gate transistor or a bottom-gate transistor may be used. As a semiconductor material used for the transistors, a semiconductor material such as silicon or germanium or an oxide semiconductor containing at least one of indium, gallium, and zinc may be used, for example.

Further, there is no particular limitation on the crystallinity of a semiconductor used for the transistors, and an amorphous semiconductor or a semiconductor having crystallinity (a microcrystalline semiconductor, a polycrystalline semiconductor, a single crystal semiconductor, or a semiconductor partly including crystal regions) may be used. The use of a semiconductor having crystallinity is preferable because deterioration of transistor characteristics can be reduced.

A typical example of an oxide semiconductor containing at least one of indium, gallium, and zinc is an In—Ga—Zn-based metal oxide. An oxide semiconductor having a wider band gap and lower carrier density than silicon is preferably used because off-state leakage current can be reduced. The details of preferred oxide semiconductors will be described in embodiments below.

For the panel module 300, a twisted nematic (TN) mode, an in-plane-switching (IPS) mode, a fringe field switching (FFS) mode, an axially symmetric aligned micro-cell (ASM) mode, an optical compensated birefringence (OCB) mode, a ferroelectric liquid crystal (FLC) mode, an anti-ferroelectric liquid crystal (AFLC) mode, or the like can be used.

Alternatively, a normally black panel module such as a transmissive panel module utilizing a vertical alignment (VA) mode may be used. The vertical alignment mode is a method of controlling alignment of liquid crystal molecules of a display portion (display panel), in which liquid crystal molecules are aligned perpendicularly to a panel surface when no voltage is applied. Some examples are given as the vertical alignment mode. For example, a multi-domain vertical alignment (MVA) mode, a patterned vertical alignment (PVA) mode, an Advanced Super View (ASV) mode, and the like can be used. Moreover, it is possible to use a method called domain multiplication or multi-domain design, in which a pixel is divided into some regions (subpixels) and molecules are aligned in different directions in their respective regions.

In this embodiment, a panel module using a vertical alignment (VA) mode is described.

One pixel includes at least a switching transistor 356 and may also include a storage capacitor (not shown). A first electrode 351 electrically connected to a source electrode or a drain electrode of the transistor 356 is provided over an insulating layer 339.

The liquid crystal element 350 provided in the pixel includes the first electrode 351 over the insulating layer 339, a second electrode 353 on the second substrate 302, and liquid crystal 352 sandwiched between the first electrode 351 and the second electrode 353.

The first electrode 351 and the second electrode 353 are formed using a light-transmitting conductive material. As the light-transmitting conductive material, a conductive oxide such as indium oxide, indium tin oxide, indium zinc oxide, zinc oxide, zinc oxide to which gallium is added, or graphene can be used.

A color filter 343 and a black matrix 342 are provided on the second substrate 302 in at least a region overlapping with the pixel portion 311.

The color filter 343 is provided in order to adjust the color of light transmitted through a pixel to increase the color purity. For example, in a full-color panel module using a white backlight, a plurality of pixels provided with color filters of different colors are used. In this case, the color filters may be those of three colors of red (R), green (G), and blue (B) or four colors (yellow (Y) in addition to these three colors). Further, a white (W) pixel may be added to R, G, and B pixels (and a Y pixel). That is, color filters of four colors (or five colors) may be used.

The black matrix 342 is provided between the adjacent color filters 343. The black matrix 342 blocks light entering from adjacent pixels, thereby preventing color mixture between the adjacent pixels. The black matrix 342 may be provided only between adjacent pixels of different emission colors and not between pixels of the same emission color. When the color filter 343 is provided so that its end portion overlaps with the black matrix 342, light leakage can be reduced. The black matrix 342 can be formed using a material that blocks light transmitted through the pixel, for example, a metal material or a resin material including a pigment.

An overcoat 355 is provided to cover the color filter 343 and the black matrix 342. The overcoat 355 can suppress diffusion of impurities included in the color filter 343 and the black matrix 342, such as a pigment, into the liquid crystal 352. For the overcoat 355, a light-transmitting material is used, and an inorganic insulating material or an organic insulating material can be used.

The second electrode 353 is provided over the overcoat 355.

A spacer 354 is provided in a region where the overcoat 355 overlaps with the black matrix 342. The spacer 354 is preferably formed using a resin material because it can be formed thick. For example, the spacer 354 can be formed using a positive or negative photosensitive resin. When a light-blocking material is used for the spacer 354, the spacer 354 blocks light entering from adjacent pixels, thereby preventing color mixture between the adjacent pixels. Although the spacer 354 is provided on the second substrate 302 side in this structure example, the spacer 354 may be provided on the first substrate 301 side. Alternatively, for the spacer 354, spherical particles of silicon oxide or the like may be used and scattered in a region where the liquid crystal 352 is provided.

An image can be displayed in such a manner that by application of voltage between the first electrode 351 and the second electrode 353, an electric field is generated in a direction vertical to surfaces of the electrodes and controls orientation of the liquid crystal 352, and polarization of light from a backlight provided outside the panel module is controlled in each pixel.

An alignment film for controlling orientation of the liquid crystal 352 may be provided on a surface in contact with the liquid crystal 352. A light-transmitting material is used for the alignment film.

In the display device illustrated in FIGS. 17A and 17B, the color filter is provided in a region overlapping with the liquid crystal element 350, so that a full-color image with higher color purity can be displayed. With the use of a plurality of light-emitting diodes (LEDs) that emit light of different colors as a backlight, a time-division display method (a field sequential driving method) can be employed. In the case of employing a time-division display method, the aperture ratio of the pixel or the number of pixels per unit area can be increased because neither color filters nor subpixels from which light of red (R), green (G), or blue (B), for example, is obtained are needed.

As the liquid crystal 352, a thermotropic liquid crystal, a low molecular weight liquid crystal, a polymer liquid crystal, a ferroelectric liquid crystal, an anti-ferroelectric liquid crystal, or the like can be used. Moreover, a liquid crystal exhibiting a blue phase is preferably used because an alignment film is not necessary and the viewing angle is wide. It is possible to use a polymer stabilized liquid crystal material obtained by adding a monomer and a polymerization initiator to any of the above liquid crystals and polymerizing the monomer after injection or dropping and sealing.

Although the liquid crystal element 350 in VA mode is described in the display device illustrated in FIGS. 17A and 17B, the liquid crystal element 350 is not limited to having this structure and can employ a different mode.

The first substrate 301 is provided with an insulating layer 337 in contact with an upper surface of the first substrate 301, an insulating layer 338 functioning as a gate insulating layer of the transistors, and an insulating layer 339 covering the transistors.

The insulating layer 337 is provided in order to prevent diffusion of impurities included in the first substrate 301. The insulating layers 338 and 339, which are in contact with semiconductor layers of the transistors, are preferably formed using a material preventing diffusion of impurities that promote degradation of the transistors. For these insulating layers, oxide, nitride, or oxynitride of a semiconductor such as silicon or a metal such as aluminum can be used, for example. Alternatively, a stack of such inorganic insulating materials or a stack of such an inorganic insulating material and an organic insulating material may be used. Note that the insulating layers 337 and 339 are not necessarily provided when not needed.

An insulating layer may be provided between the insulating layer 339 and the first electrode 351 as a planarization layer that covers steps due to a transistor, a wiring, or the like placed below the insulating layer 339. For such an insulating layer, a resin material such as polyimide or acrylic is preferably used. An inorganic insulating material may be used as long as high planarity is obtained.

With the structure illustrated in FIG. 17B, the number of photomasks necessary for forming the transistor and the first electrode 351 of the liquid crystal element 350 over the first substrate 301 can be reduced. Specifically, only five photomasks are necessary for the following respective steps: a step of processing a gate electrode, a step of processing a semiconductor layer, a step of processing source and drain electrodes, a step of forming an opening in the insulating layer 339, and a step of processing the first electrode 351.

A wiring 306 over the first substrate 301 is provided to extend to the outside of the region sealed with the sealant 303 and is electrically connected to the first driver circuit 313. Part of an end portion of the wiring 306 is included in the external connection electrode 305. In this structure example, the external connection electrode 305 is formed by a stack of a conductive film used for the source and drain electrodes of the transistor and a conductive film used for the gate electrode of the transistor. The external connection electrode 305 is preferably formed by a stack of a plurality of conductive films as described above because mechanical strength against a pressure bonding step performed on the FPC 304 or the like can be increased.

Although not illustrated, a wiring and an external connection electrode that electrically connect the IC 312 and the pixel portion 311 can have the same structures as the wiring 306 and the external connection electrode 305.

A connection layer 308 is provided in contact with the external connection electrode 305. The FPC 304 and the external connection electrode 305 are electrically connected to each other through the connection layer 308. For the connection layer 308, a known anisotropic conductive film, various kinds of anisotropic conductive paste, or the like can be used.

The end portions of the wiring 306 and the external connection electrode 305 are preferably covered with an insulating layer so that surfaces thereof are not exposed because oxidation of the surfaces and defects such as undesired short circuits can be suppressed.

The shift register of one embodiment of the present invention can stably operate. The shift register of one embodiment of the present invention consumes less power.

In the panel module described in this embodiment, the frame frequency of a still image can be reduced, so that a user can see the same image as long as possible, and screen flickers perceived by the user are reduced. Furthermore, the size of one pixel is small and thus high resolution display is possible, so that precise and smooth display can be achieved. Moreover, at the time of still image display, deterioration of image quality caused by a change in gray level can be reduced.

From the above reasons, a panel module provided with the shift register in this embodiment and the display portion of the above embodiment consumes less power.

Forming such a shift register and a display portion using an oxide semiconductor enables simplification of a manufacturing process.

This embodiment can be combined with any of the other embodiments disclosed in this specification as appropriate.

### Embodiment 8

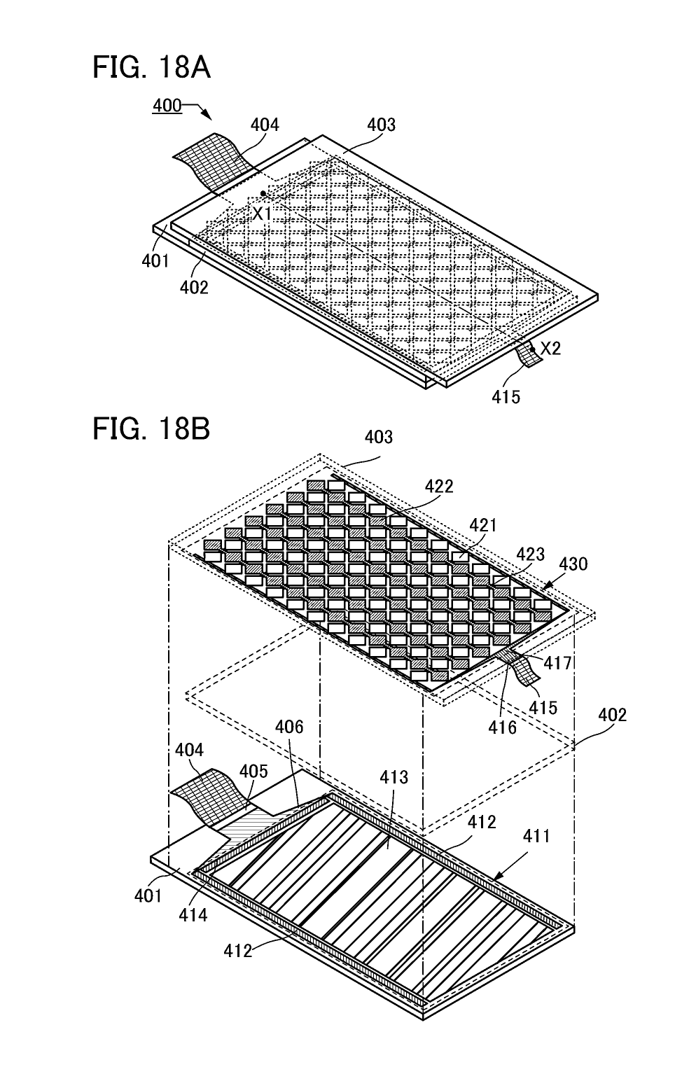

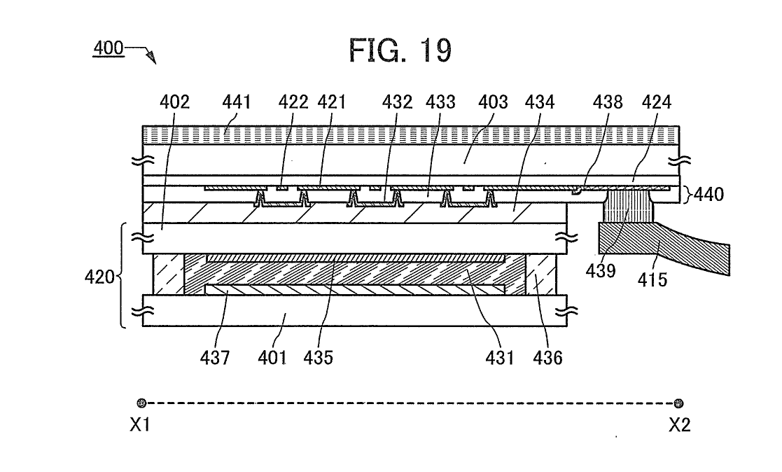

The panel module in the above embodiment provided with a touch sensor (contact detector) can function as a touch screen. In this embodiment, a touch screen will be described with reference to FIGS. 18A and 18B and FIG. 19. Hereinafter, the description of the same portions as the above embodiments is omitted in some cases.

FIG. 18A is a perspective schematic diagram of a touch screen 400 shown in this embodiment. Note that FIGS. 18A and 18B illustrate only major components for simplicity. FIG. 18B is a perspective schematic diagram of the dismantled touch screen 400.

The touch screen 400 includes a display portion 411 sandwiched between a first substrate 401 and a second substrate 402, and a touch sensor 430 sandwiched between the second substrate 402 and a third substrate 403.

The first substrate 401 is provided with the display portion 411 and a plurality of wirings 406 electrically connected to the display portion 411. The plurality of wirings 406 are led to the outer edge portion of the first substrate 401, and part of the wirings 406 forms part of an external connection electrode 405 electrically connected to an FPC 404.

The display portion 411 includes a pixel portion 413 including a plurality of pixels, a second driver circuit 412, and a first driver circuit 414 and is sealed between the first substrate 401 and the second substrate 402. Although FIG. 18B illustrates a structure in which two second driver circuits 412 are positioned on both sides of the pixel portion 413, one second driver circuit 412 may be positioned along one side of the pixel portion 413.

As a display element that can be used in the pixel portion 413 of the display portion 411, any of a variety of display elements such as an organic EL element, a liquid crystal element, and a display element performing display with electrophoresis, electronic liquid powder, or the like can be used. In this embodiment, a liquid crystal element is used as the display element.

The third substrate 403 is provided with the touch sensor 430 and a plurality of wirings 417 electrically connected to the touch sensor 430. The touch sensor 430 is provided on a surface of the third substrate 403 facing the second substrate 402. The plurality of wirings 417 are led to the outer edge portion of the third substrate 403, and part of the wirings 417 forms part of an external connection electrode 416 electrically connected to an FPC 415. Note that in FIG. 18B, electrodes, wirings, and the like of the touch sensor 430 that are provided on the back side of the third substrate 403 (the side facing the second substrate 402) are shown by solid lines for clarity.

The touch sensor 430 illustrated in FIG. 18B is an example of a projected capacitive touch sensor. The touch sensor 430 includes an electrode 421 and an electrode 422. Each of the electrodes 421 and 422 is electrically connected to any one of the plurality of wirings 417.

Here, the electrode 422 is in the form of a series of quadrangles arranged in one direction as illustrated in FIGS. 18A and 18B. Each of the electrodes 421 is in the form of a quadrangle. The plurality of electrodes 421 arranged in a line in a direction intersecting with the direction of extension of the electrode 422 are electrically connected to each other by a wiring 423. The electrode 422 and the wiring 423 are preferably arranged so that the area of the intersections of the electrode 422 and the wiring 423 is as small as possible. Such shapes of the electrodes can reduce the area of a region where the electrodes are not provided and decrease luminance unevenness of light passing through the touch sensor 430 due to a difference in transmittance depending on existence of the electrodes.

Note that the shapes of the electrodes 421 and the electrode 422 are not limited to the above and can be a variety of shapes. For example, it is possible that a plurality of electrodes 421 be arranged so that the gaps therebetween are reduced as much as possible, and a plurality of electrodes 422 are provided over the electrodes 421 with an insulating layer therebetween to be spaced apart from each other and have regions not overlapping with the electrodes 421. In this case, it is preferable to provide, between two adjacent electrodes 422, a dummy electrode electrically insulated from these electrodes because the area of regions having different transmittances can be reduced.

FIG. 19 is a cross-sectional view of the touch screen 400 along X1-X2 in FIG. 18A.

A switching element layer 437 is provided over the first substrate 401. The switching element layer 437 includes at least a transistor. The switching element layer 437 may also include a capacitor or the like in addition to the transistor. Further, the switching element layer 437 may include a driver circuit (a first driver circuit and a second driver circuit), a wiring, an electrode, and/or the like.

A color filter layer 435 is provided on one surface of the second substrate 402. The color filter layer 435 includes a color filter that overlaps with the liquid crystal element. When the color filter layer 435 includes color filters of three colors of red (R), green (G), and blue (B), a full-color liquid crystal display device is obtained.

For example, the color filter layer 435 is formed using a photosensitive material including a pigment by a photolithography process. In the color filter layer 435, a black matrix may be provided between color filters of different colors. Further, an overcoat that covers the color filters and the black matrix may be provided.

Note that one of electrodes of the liquid crystal element may be formed on the color filter layer 435 depending on the structure of the liquid crystal element. Note that the electrode serves as part of the liquid crystal element to be formed later. An alignment film may be provided on the electrode.

Liquid crystal 431 sandwiched between the first substrate 401 and the second substrate 402 is sealed by a sealant 436. The sealant 436 is provided to surround the switching element layer 437 and the color filter layer 435.

For the sealant 436, a thermosetting resin or an ultraviolet curable resin can be used, and an organic resin such as an acrylic resin, a urethane resin, an epoxy resin, or a resin having a siloxane bond can be used. The sealant 436 may be formed using glass frit including low-melting-point glass. Alternatively, the sealant 436 may be formed with a combination of any of the above organic resins and glass frit. For example, the organic resin may be provided in contact with the liquid crystal 431 and glass frit may be provided on the outer surface of the organic resin, in which case water or the like can be prevented from being mixed into the liquid crystal from the outside.

The touch sensor is provided over the second substrate 402. In the touch sensor, a sensor layer 440 is provided on one surface of the third substrate 403 with an insulating layer 424 placed therebetween and is bonded to the second substrate 402 with a bonding layer 434. A polarizing plate 441 is provided on the other surface of the third substrate 403.

The touch sensor can be provided over the liquid crystal display device 420 in such a manner that the sensor layer 440 is formed over the third substrate 403 and then attached to the second substrate 402 with the bonding layer 434 provided over the sensor layer 440.

The insulating layer 424 can be formed using oxide such as silicon oxide, for example. The light-transmitting electrodes 421 and 422 are provided in contact with the insulating layer 424. The electrodes 421 and 422 are formed in such a manner that a conductive film is formed by sputtering over the insulating layer 424 formed over the third substrate 403 and then unnecessary portions of the conductive film are removed by various kinds of patterning technique such as photolithography. As a light-transmitting conductive material, conductive oxide such as indium oxide, indium tin oxide, indium zinc oxide, zinc oxide, or zinc oxide to which gallium is added can be used.

A wiring 438 is electrically connected to the electrode 421 or the electrode 422. Part of the wiring 438 serves as an external connection electrode electrically connected to the FPC 415. The wiring 438 can be formed using a metal material such as aluminum, gold, platinum, silver, nickel, titanium, tungsten, chromium, molybdenum, iron, cobalt, copper, or palladium or an alloy material containing any of these metal materials.

The electrodes 422 are provided in the form of stripes extending in one direction. The electrodes 421 are arranged so that one electrode 422 is placed between a pair of electrodes 421. A wiring 432 that electrically connects the electrodes 421 is provided to cross the electrode 422. Here, one electrode 422 and a plurality of electrodes 421 electrically connected to each other by the wiring 432 do not necessarily cross orthogonally and may form an angle of less than 90°.

An insulating layer 433 is provided to cover the electrodes 421 and 422. Examples of a material for the insulating layer 433 are a resin such as an acrylic resin, an epoxy resin, and a resin having a siloxane bond and an inorganic insulating material such as silicon oxide, silicon oxynitride, and aluminum oxide. An opening reaching the electrode 421 is formed in the insulating layer 433, and the wiring 432, which is electrically connected to the electrode 421, is provided in the opening. The wiring 432 is preferably formed using a light-transmitting conductive material similar to that of the electrodes 421 and 422, in which case the aperture ratio of the touch screen can be increased. Although the wiring 432 may be formed using the same material as the electrodes 421 and 422, it is preferably formed using a material having higher conductivity than the material of the electrodes 421 and 422.

An insulating layer that covers the insulating layer 433 and the wiring 432 may be provided. The insulating layer can function as a protection layer.

An opening reaching the wiring 438 is formed in the insulating layer 433 (and the insulating layer serving as the protection layer), and the FPC 415 and the wiring 438 are electrically connected to each other with a connection layer 439 provided in the opening. For the connection layer 439, various kinds of anisotropic conductive film (ACF), a known anisotropic conductive paste (ACP), or the like can be used.

The bonding layer 434 for bonding the sensor layer 440 and the second substrate 402 preferably has light-transmitting properties. For example, a thermosetting resin or an ultraviolet curable resin can be used, and specifically an acrylic resin, a urethane resin, an epoxy resin, a resin having a siloxane bond, or the like can be used.

The polarizing plate 441 is various kinds of polarizing plate and is formed using a material capable of producing linearly polarized light from natural light or circularly polarized light. For example, a material whose optical anisotropy is obtained by disposing dichroic substances in one direction can be used. The polarizing plate 441 can be formed, for example, in such a manner that an iodine-based compound or the like is adsorbed to a film of polyvinyl alcohol or the like and the film is stretched in one direction. As the dichroic substance, a dye-based compound or the like as well as an iodine-based compound is used. A film-like, sheet-like, or plate-like material can be used for the polarizing plate 441.

Although this embodiment shows the example where a projected capacitive touch sensor is used for the sensor layer 440, the sensor layer 440 is not limited to this, and it is possible to use a sensor functioning as a touch sensor that senses proximity or touch of a conductive object to be sensed, such as a finger, on the outer side of the polarizing plate. As the touch sensor provided in the sensor layer 440, a capacitive touch sensor is preferably used. Examples of a capacitive touch sensor are a surface capacitive touch sensor and a projected capacitive touch sensor. Examples of a projected capacitive touch sensor are a self capacitive touch sensor and a mutual capacitive touch sensor, which differ mainly in the driving method. The use of a mutual capacitive touch sensor is preferable because multiple points can be sensed simultaneously.

In a panel module provided with the touch screen described in this embodiment, the frame frequency of a still image can be reduced, so that a user can see the same image as long as possible, and screen flickers perceived by the user are reduced. In addition, high-resolution display can be performed with smaller-size pixels, whereby a precise and smooth image can be displayed. Further, degradation of image quality due to change in gray level can be reduced and power consumed by the panel module can be reduced during still image display.

This embodiment can be implemented in appropriate combination with any of the other embodiments described in this specification.

### Embodiment 9

In Embodiment 8, examples of the structure of a transistor that can be used in a pixel of a display device will be described with reference to drawings.

Note that the structure of a transistor is not particularly limited and can be a given structure. As the switching element, a bottom gate transistor or a top gate transistor which are described below can be employed, for example. A transistor may have a single-gate structure in which one channel formation region is formed or a multi-gate structure such as a double-gate structure in which two channel formation regions are formed or a triple-gate structure in which three channel formation regions are formed. In addition, a transistor may have a structure in which two gate electrodes are provided above and below a channel formation region with gate insulating films laid therebetween (in this specification and the like, this structure is referred to as a dual-gate structure).

### <Structure Example of Transistor>

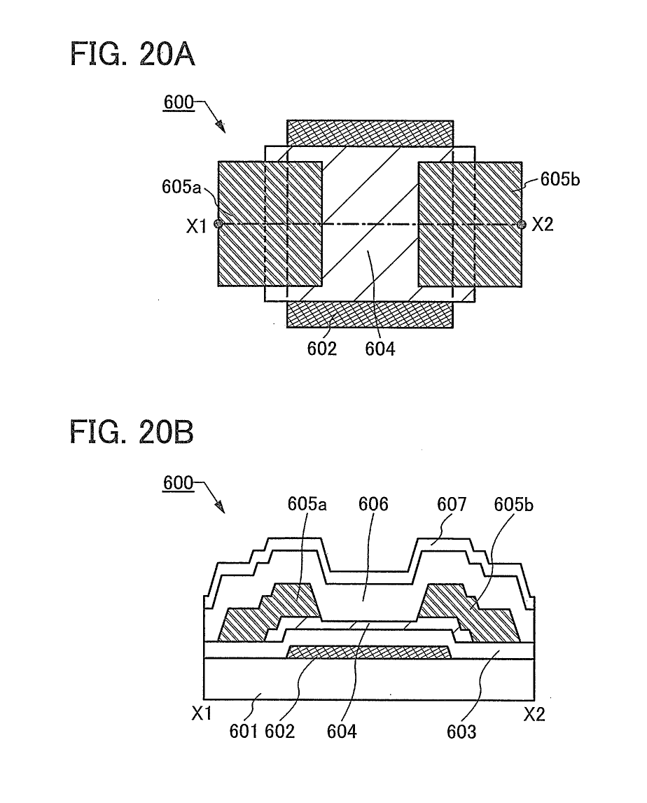

FIGS. 20A and 20B illustrate a structure example of a transistor 600 having a bottom-gate top-contact structure, which is one kind of bottom-gate transistor. FIG. 20A is a plan view of the transistor 600. FIG. 20B is a cross-sectional view taken along the long dashed short dashed line X1-X2 in FIG. 20A.

The transistor 600 includes a gate electrode 602 over a substrate 601, an insulating layer 603 over the substrate 601 and the gate electrode 602, an oxide semiconductor layer 604 placed over the insulating layer 603 to overlap with the gate electrode 602, and a pair of electrodes 605a and 605b in contact with the top surface of the oxide semiconductor layer 604. An insulating layer 606 covers the insulating layer 603, the oxide semiconductor layer 604, and the pair of electrodes 605a and 605b. An insulating layer 607 is placed over the insulating layer 606.

In this specification and the like, a channel length refers to the distance between one electrode and the other electrode of a pair of electrode in a region overlapping with the gate electrode. Note that a channel formation region refers to a region of an oxide semiconductor layer, which overlaps with a gate electrode and which is between the one electrode and the other electrode of the pair of electrode. A channel refers to a main path through which current flows in the channel formation region.

There is no particular limitation on the properties of a material and the like of the substrate 601 as long as the material has heat resistance high enough to withstand at least heat treatment performed later. For example, a glass substrate, a ceramic substrate, a quartz substrate, a sapphire substrate, or an yttria-stabilized zirconia (YSZ) substrate may be used as the substrate 601. Alternatively, a single crystal semiconductor substrate or a polycrystalline semiconductor substrate made of silicon, silicon carbide, or the like, a compound semiconductor substrate made of silicon germanium or the like, an SOI substrate, or the like can be used as the substrate 601. Still alternatively, any of these substrates provided with a semiconductor element may be used as the substrate 601.

A flexible substrate such as a plastic substrate may be used as the substrate 601, and the transistor 600 may be formed directly on the flexible substrate. Alternatively, a separation layer may be provided between the substrate 601 and the transistor 600. The separation layer can be used when part or the whole of the transistor formed over the separation layer is formed and separated from the substrate 601 and transferred to another substrate. Thus, the transistor 600 can be transferred to a substrate having low heat resistance or a flexible substrate.

The gate electrode 602 can be formed using a metal selected from aluminum, chromium, copper, tantalum, titanium, molybdenum, and tungsten; an alloy containing any of these metals as a component; an alloy containing any of these metals in combination; or the like. Further, one or both of manganese and zirconium may be used. The gate electrode 602 may have a single-layer structure or a stacked structure of two or more layers. For example, the gate electrode 602 can have a single-layer structure of an aluminum film containing silicon, a two-layer structure in which a titanium film is stacked over an aluminum film, a two-layer structure in which a titanium film is stacked over a titanium nitride film, a two-layer structure in which a tungsten film is stacked over a titanium nitride film, a two-layer structure in which a tungsten film is stacked over a tantalum nitride film or a tungsten nitride film, a three-layer structure in which a titanium film, an aluminum film, and a titanium film are stacked in this order, or the like. Alternatively, an alloy film or a nitride film that contains aluminum and one or more metals selected from titanium, tantalum, tungsten, molybdenum, chromium, neodymium, and scandium may be used.

The gate electrode 602 can also be formed using a light-transmitting conductive material such as indium tin oxide, indium oxide containing tungsten oxide, indium zinc oxide containing tungsten oxide, indium oxide containing titanium oxide, indium tin oxide containing titanium oxide, indium zinc oxide, or indium tin oxide to which silicon oxide is added. The gate electrode 602 can have a stacked structure using the above light-transmitting conductive material and the above metal.

Further, an In—Ga—Zn-based oxynitride semiconductor film, an In—Sn-based oxynitride semiconductor film, an In—Ga-based oxynitride semiconductor film, an In—Zn-based oxynitride semiconductor film, a Sn-based oxynitride semiconductor film, an In-based oxynitride semiconductor film, a film of metal nitride (such as InN or ZnN), or the like may be provided between the gate electrode 602 and the insulating layer 603. These films each have a work function of 5 eV or higher, preferably 5.5 eV or higher, which is higher than the electron affinity of an oxide semiconductor; thus, the threshold voltage of a transistor including the oxide semiconductor can be shifted in the positive direction. Accordingly, a switching element having what is called normally-off characteristics is obtained. For example, in the case of using an In—Ga—Zn-based oxynitride semiconductor film, an In—Ga—Zn-based oxynitride semiconductor film having a higher nitrogen concentration than at least the oxide semiconductor layer 604, specifically, an In—Ga—Zn-based oxynitride semiconductor film having a nitrogen concentration of 7 atomic % or higher is used.

The insulating layer 603 functions as a gate insulating film. The insulating layer 603 in contact with the bottom surface of the oxide semiconductor layer 604 is preferably an amorphous film.

The insulating layer 603 has a single-layer structure or a stacked structure using silicon oxide, silicon oxynitride, silicon nitride oxide, silicon nitride, aluminum oxide, hafnium oxide, gallium oxide, or Ga—Zn-based metal oxide, for example.

The insulating layer 603 may be formed using a high-k material such as hafnium silicate (HfSiOₓ), hafnium silicate to which nitrogen is added (HfSiₓO_{y}N_{z}), hafnium aluminate to which nitrogen is added (HfAlₓO_{y}N_{z}), hafnium oxide, or yttrium oxide, in which case gate leakage current of the transistor can be reduced.

The pair of electrodes 605a and 605b function as a source electrode and a drain electrode of the transistor.

The pair of electrodes 605a and 605b can be formed to have a single-layer structure or a stacked structure using, as a conductive material, any of metals such as aluminum, titanium, chromium, nickel, copper, yttrium, zirconium, molybdenum, silver, tantalum, and tungsten or an alloy containing any of these metals as its main component. For example, the pair of electrodes 605a and 605b can have a single-layer structure of an aluminum film containing silicon; a two-layer structure in which a titanium film is stacked over an aluminum film; a two-layer structure in which a titanium film is stacked over a tungsten film; a two-layer structure in which a copper film is formed over a copper-magnesium-aluminum alloy film; a three-layer structure in which a titanium film or a titanium nitride film, an aluminum film or a copper film, and a titanium film or a titanium nitride film are stacked in this order; or a three-layer structure in which a molybdenum film or a molybdenum nitride film, an aluminum film or a copper film, and a molybdenum film or a molybdenum nitride film are stacked in this order. Note that a transmitting conductive material containing indium oxide, tin oxide, or zinc oxide may be used.

As the insulating layer 606, a silicon oxide film, a silicon oxynitride film, or the like can be used. Note that in this specification, a silicon oxynitride film refers to a film that includes more oxygen than nitrogen, and a silicon nitride oxide film refers to a film that includes more nitrogen than oxygen.

The insulating layer 606 is preferably an oxide insulating film containing oxygen at a higher proportion than oxygen in the stoichiometric composition. Part of oxygen is released by heating from the oxide insulating film containing oxygen at a higher proportion than oxygen in the stoichiometric composition. The oxide insulating film containing oxygen at a higher proportion than oxygen in the stoichiometric composition is an oxide insulating film in which the amount of released oxygen converted into oxygen atoms is 1.0×10¹⁸ atoms/cm³ or more, preferably 3.0×10²⁰ atoms/cm³ or more in thermal desorption spectroscopy (TDS) analysis.

Note that the insulating layer 606 also functions as a film that relieves damage to the oxide semiconductor layer 604 at the time of forming the insulating layer 607 later.

Moreover, an oxide film transmitting oxygen may be provided between the insulating layer 606 and the oxide semiconductor layer 604.

As the oxide film transmitting oxygen, a silicon oxide film, a silicon oxynitride film, or the like can be used.

The insulating layer 607 can be an insulating film having a blocking effect against oxygen, hydrogen, water, and the like. Providing the insulating layer 607 over the insulating layer 606 can prevent outward diffusion of oxygen from the oxide semiconductor layer 604 and entry of hydrogen, water, or the like into the oxide semiconductor layer 604 from the outside. Examples of the insulating film having a blocking effect against oxygen, hydrogen, water, and the like are a silicon nitride film, a silicon nitride oxide film, an aluminum oxide film, an aluminum oxynitride film, a gallium oxide film, a gallium oxynitride film, an yttrium oxide film, an yttrium oxynitride film, a hafnium oxide film, and a hafnium oxynitride film.

Next, an example of a method of fabricating the transistor 600 in FIGS. 20A to 20B will be described.

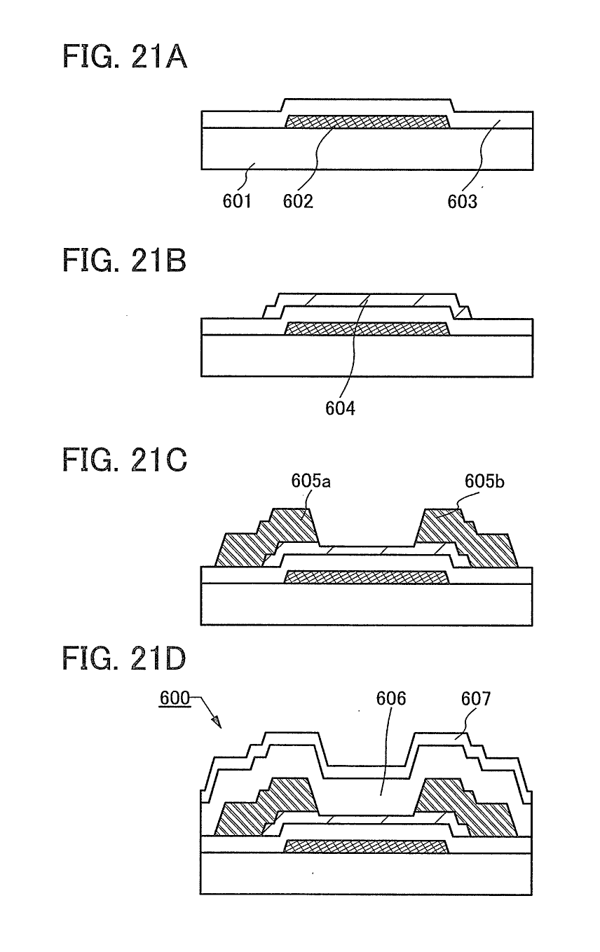

First, as illustrated in FIG. 21A, the gate electrode 602 is formed over the substrate 601, and the insulating layer 603 is formed over the gate electrode 602.

Here, a glass substrate is used as the substrate 601.

First, a conductive film is formed by sputtering, CVD, evaporation, or the like and then a resist mask is formed over the conductive film using a photomask by a photolithography process. Next, part of the conductive film is etched using the resist mask to form the gate electrode 602. After that, the resist mask is removed.

Note that the gate electrode 602 may be formed by electrolytic plating, printing, inkjet, or the like instead of the above formation method.

The insulating layer 603 is formed by sputtering, CVD, evaporation, or the like. The insulating layer 603 can be formed using a silicon oxide film, a silicon oxynitride film, a silicon nitride oxide film, a silicon nitride film, or the like.

When a silicon oxide film, a silicon oxynitride film, or a silicon nitride oxide film is formed as the insulating layer 603, a deposition gas containing silicon and an oxidizing gas are preferably used as a source gas. Typical examples of the deposition gas containing silicon include silane, disilane, trisilane, and silane fluoride. Examples of the oxidizing gas include oxygen, ozone, dinitrogen monoxide, and nitrogen dioxide.

When a silicon nitride film is formed as the insulating layer 603, it is preferable to use a two-step formation method. First, a first silicon nitride film with few defects is formed by plasma CVD using a mixed gas of silane, nitrogen, and ammonia as a source gas. Then, a second silicon nitride film that has low hydrogen concentration and can block hydrogen is formed by switching the source gas to a mixed gas of silane and nitrogen. With such a formation method, a silicon nitride film having few defects and a blocking property against hydrogen can be formed as the gate insulating layer 603.

When a gallium oxide film is formed as the insulating layer 603, metal organic chemical vapor deposition (MOCVD) can be employed.

Note that in the insulating layer 603, a region to be in contact with the oxide semiconductor layer 604 which is formed later is preferably an oxide insulating film and preferably has a region (also referred to as oxygen excess region) containing oxygen in excess of the stoichiometric composition. For example, the oxygen excess region may be formed by introduction of oxygen into the insulating layer 603 after the film formation. As a method for introducing oxygen, an ion implantation method, an ion doping method, a plasma immersion ion implantation method, plasma treatment, or the like may be used.

By oxygen is introduced into the insulating layer 603, oxygen can be supplied to the oxide semiconductor layer 604 from the insulating layer 603 by performing heat treatment after the oxide semiconductor layer 604 is formed. Thus, oxygen vacancies contained in the oxide semiconductor layer 604 can be reduced.

Next, as illustrated in FIG. 21B, the oxide semiconductor layer 604 is formed over the insulating layer 603.

First, an oxide semiconductor film is formed by a sputtering method and then a resist mask is formed over the oxide semiconductor film using a photomask by a photolithography process. Then, part of the oxide semiconductor film is etched using the resist mask to form the oxide semiconductor layer 604. After that, the resist mask is removed. The oxide semiconductor film can be formed by a sputtering method, a molecular beam epitaxy (MBE) method, a CVD method such as a LPCVD method, a PECVD method, or a mist CVD method, a pulsed laser deposition method, an atomic layer deposition (ALD) method, or the like as appropriate.

After the formation of the oxide semiconductor layer 604, heat treatment may be performed. By performing the heat treatment, hydrogen, water, and the like contained in the oxide semiconductor layer 604 can be removed. The heat treatment can be called dehydration treatment or dehydrogenation treatment. The temperature of the heat treatment is higher than or equal to 300° C. and lower than or equal to 700° C., or lower than the strain point of the substrate. The heat treatment can be performed under reduced pressure, a nitrogen atmosphere, an oxygen atmosphere, or the like.

Note that the heat treatment may be performed at any timing in the manufacturing process of the transistor as long as it is performed after the formation of the oxide semiconductor layer 604. For example, the heat treatment may be performed after the formation of the oxide semiconductor film. The heat treatment may be performed plural times, and may also serve as heat treatment for another purpose. A laser irradiation apparatus may be used for the heat treatment.

Next, as illustrated in FIG. 21C, the pair of electrodes 605a and 605b are formed.

First, a conductive film is formed by sputtering, CVD, evaporation, or the like. Next, a resist mask is formed over the conductive film using a photomask by a photolithography process. Then, part of the conductive film is etched using the resist mask to form the pair of electrodes 605a and 605b. After that, the resist mask is removed.

Note that as illustrated in FIG. 21C, the upper part of the oxide semiconductor layer 604 is partly etched and thinned by the etching of the conductive film in some cases. For this reason, the thickness of the oxide semiconductor film large may be set in advance at the time of forming the oxide semiconductor layer 604.

Next, as illustrated in FIG. 21D, the insulating layer 606 is formed over the oxide semiconductor layer 604 and the pair of electrodes 605a and 605b, and the insulating layer 607 is successively formed over the insulating layer 606.

When a silicon oxide film or a silicon oxynitride film is formed as the insulating layer 606, a deposition gas containing silicon and an oxidizing gas are preferably used as a source gas. Typical examples of the deposition gas containing silicon include silane, disilane, trisilane, and silane fluoride. Examples of the oxidizing gas include oxygen, ozone, dinitrogen monoxide, and nitrogen dioxide.

For example, a silicon oxide film or a silicon oxynitride film is formed under the following conditions: the substrate placed in an evacuated treatment chamber of a plasma CVD apparatus is held at a temperature ranging from 180° C. to 260° C., preferably from 200° C. to 240° C.; the pressure of the treatment chamber into which the source gas is introduced is set in the range from 100 Pa to 250 Pa, preferably from 100 Pa to 200 Pa; and an electrode provided in the treatment chamber is supplied with a high-frequency power ranging from 0.17 W/cm² to 0.5 W/cm², preferably from 0.25 W/cm² to 0.35 W/cm².

As the film formation conditions, the high-frequency power with the above power density is supplied to the treatment chamber having the above pressure, whereby the degradation efficiency of the source gas in plasma is increased, oxygen radicals are increased, and oxidation of the source gas is promoted; therefore, oxygen is contained in the oxide insulating film at a higher proportion than oxygen in the stoichiometric composition. However, when the substrate temperature is within the above temperature range, the bond between silicon and oxygen is weak, and accordingly, part of oxygen is released by heating. Thus, it is possible to form an oxide insulating film which contains oxygen at a higher proportion than the stoichiometric composition and from which part of oxygen is released by heating.

In the case where an oxide insulating film is provided between the oxide semiconductor layer 604 and the insulating layer 606, the oxide insulating film serves as a protection film of the oxide semiconductor layer 604 in the step of forming the insulating layer 606. Thus, the insulating layer 606 can be formed using the high-frequency power with high power density while damage to the oxide semiconductor layer 604 is reduced.

For example, a silicon oxide film or a silicon oxynitride film can be formed as the oxide insulating film under the following conditions: the substrate placed in an evacuated treatment chamber of the plasma CVD apparatus is held at a temperature ranging from 180° C. to 400° C., preferably from 200° C. to 670° C.; the pressure of the chamber into which the source gas is introduced is set in the range from 20 Pa to 250 Pa, preferably from 100 Pa to 250 Pa; and high-frequency power is supplied to the electrode provided in the treatment chamber. Setting the pressure in the treatment chamber in the range from 100 Pa to 250 Pa can reduce damage to the oxide semiconductor layer 604 at the time of forming the oxide insulating film.

A deposition gas containing silicon and an oxidizing gas are preferably used as a source gas of the oxide insulating film. Typical examples of the deposition gas containing silicon are silane, disilane, trisilane, and silane fluoride. Examples of the oxidizing gas are oxygen, ozone, dinitrogen monoxide, and nitrogen dioxide.

The insulating layer 607 can be formed by sputtering, CVD, or the like. The insulating layer 607 can be formed using a silicon nitride film or a silicon nitride oxide film, for example.

When a silicon nitride film or a silicon nitride oxide film is formed as the insulating layer 607, a deposition gas containing silicon, an oxidizing gas, and a gas containing nitrogen are preferably used as a source gas. Typical examples of the deposition gas containing silicon are silane, disilane, trisilane, and silane fluoride. Examples of the oxidizing gas are oxygen, ozone, dinitrogen monoxide, and nitrogen dioxide. Examples of the gas containing nitrogen are nitrogen and ammonia.

Through the above steps, the transistor 600 can be formed.

Examples of the structure of a transistor that is partly different from the transistor 600 will be described below.

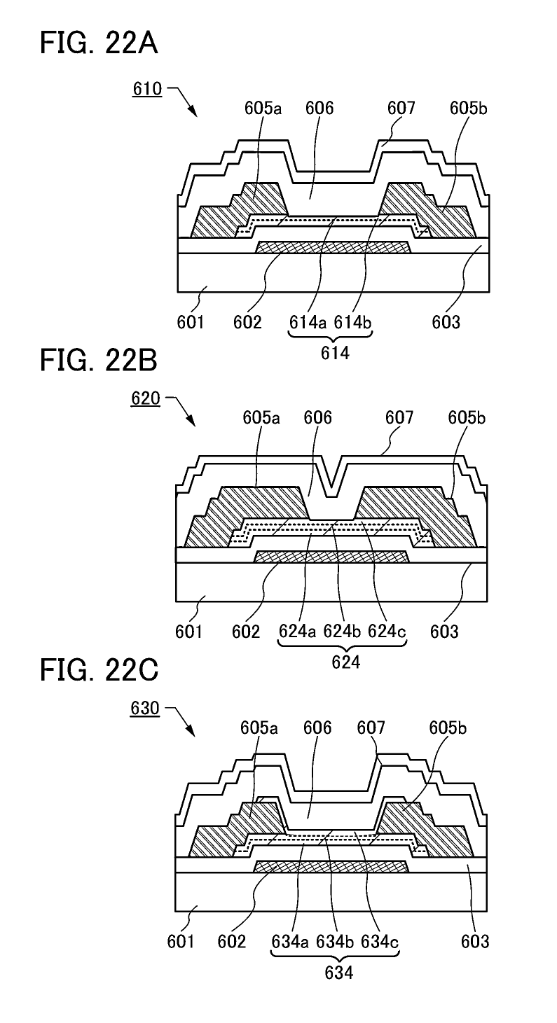

FIG. 22A is a cross-sectional diagram of a transistor 610 described below. The transistor 610 differs from the transistor 600 in the structure of the oxide semiconductor layer.

An oxide semiconductor layer 614 included in the transistor 610 is a stack of an oxide semiconductor layer 614a and an oxide semiconductor layer 614b.

In the case where a plurality of oxide semiconductor layers are stacked to form a transistor, a boundary between the oxide semiconductor layers is unclear in some cases. For example, a boundary between the oxide semiconductor layers 614a and 614b is shown by broken lines in FIG. 22A and the like because the boundary is not clear in some cases. In such a case, the oxide semiconductor layers 614a and 614b can be regarded as one layer. Alternatively, in the case where a plurality of oxide semiconductor layers are stacked and a boundary between the oxide semiconductor layers is clear, the oxide semiconductor layer can be regarded as a plurality of layers.

Typical examples of a material of the oxide semiconductor layer 614a are In—Ga oxide, In—Zn oxide, and In-M-Zn oxide (M represents Al, Ti, Ga, Y, Zr, La, Ce, Nd, or Hf). When the oxide semiconductor layer 614a is In-M-Zn oxide, the atomic ratio of In to M is preferably as follows: the percentage of In is lower than 50 atomic % and the percentage of M is 50 atomic % or higher, and preferably the percentage of In is lower than 25 atomic % and the percentage of M is 75 atomic % or higher. In addition, the oxide semiconductor layer 614a is formed using a material having an energy gap of 2 eV or higher, preferably 2.5 eV or higher, more preferably 3 eV or higher, for example.

For example, the oxide semiconductor layer 614b contains In or Ga, and typically contains In—Ga oxide, In—Zn oxide, or In-M-Zn oxide (M represents Al, Ti, Ga, Y, Zr, La, Ce, Nd, or Hf). The energy at the conduction band bottom of the oxide semiconductor layer 614b is closer to a vacuum level than that of the oxide semiconductor layer 614a, and typically, the difference in the energy at the conduction band bottom between the oxide semiconductor layer 614b and the oxide semiconductor layer 614a is preferably 0.05 eV or more, 0.07 eV or more, 0.1 eV or more, or 0.15 eV or more and 2 eV or less, 1 eV or less, 0.5 eV or less, or 0.4 eV or less.

For example, when the oxide semiconductor layer 614b is In-M-Zn oxide, the atomic ratio of In to M is preferably as follows: the percentage of In is 25 atomic % or higher and the percentage of M is lower than 75 atomic %, and preferably the percentage of In is 34 atomic % or higher and the percentage of M is lower than 66 atomic %.

For example, for the oxide semiconductor layer 614a, In—Ga—Zn oxide with an atomic ratio of In:Ga:Zn=1:1:1 or 6:1:2 can be used. For the oxide semiconductor layer 614b, In—Ga—Zn oxide with an atomic ratio of In:Ga:Zn=1:3:2, 1:6:4, or 1:9:6 can be used. Note that the atomic ratio of each of the oxide semiconductor layers 614a and 614b may vary within a margin of ±20% of the corresponding atomic ratio.

The oxide with a high content of Ga serving as a stabilizer is used for the oxide semiconductor layer 614b placed over the oxide semiconductor layer 614a, thereby preventing release of oxygen from the oxide semiconductor layers 614a and 614b.

Note that without limitation to the materials given above, a material with an appropriate composition depending on intended semiconductor characteristics and electrical characteristics (e.g., field-effect mobility and threshold voltage) of a transistor can be used. In order to obtain intended semiconductor characteristics of the transistor, it is preferable to set appropriate carrier density, impurity concentration, defect density, atomic ratio of a metal element to oxygen, interatomic distance, density, and the like of the oxide semiconductor layers 614a and 614b.

Although the oxide semiconductor layer 614 is a stack of two oxide semiconductor layers in the above structure, it may be a stack of three or more oxide semiconductor layers.

FIG. 22B is a cross-sectional view of a transistor 620 including an oxide semiconductor layer 624 which has a three-layer structure.

In an oxide semiconductor layer 624, an oxide semiconductor layer 624a, an oxide semiconductor layer 624b, and an oxide semiconductor layer 624c are stacked in this order.

For example, a boundary between the oxide semiconductor layers 624a and 624b and a boundary between the oxide semiconductor layers 624b and 624c are shown by broken lines in FIG. 22B and the like because the boundary is not clear in some cases. In such a case, the oxide semiconductor layers 624a, 624b, and 624c can be regarded as one layer.

The oxide semiconductor layers 624a and 624c can have a structure similar to that of the oxide semiconductor layer 614a shown in the transistor 610, for example. Moreover, the oxide semiconductor layer 624b can have a structure similar to that of the oxide semiconductor layer 614b shown in the transistor 610, for example.

For example, when an oxide with a high content of Ga serving as a stabilizer is used for the oxide semiconductor layer 624a placed below the oxide semiconductor layer 624b and the oxide semiconductor layer 624c placed over the oxide semiconductor layer 624b, oxygen can be prevented from being released from the oxide semiconductor layers 624a to 624c.

For example, in the case where a channel is formed mainly in the oxide semiconductor layer 624b, the on-state current of the transistor 620 can be increased when an oxide with a high content of In is used for the oxide semiconductor layer 624b and the pair of electrodes 605a and 605b is provided in contact with the oxide semiconductor layer 624b.

FIG. 22C is a cross-sectional schematic diagram of a transistor 630 described below. The transistor 630 differs from the transistors 600 and 610 in the structure of the oxide semiconductor layer.

In an oxide semiconductor layer 634 included in the transistor 630, an oxide semiconductor layer 634a, an oxide semiconductor layer 634b, and an oxide semiconductor layer 634c are stacked in this order.

The oxide semiconductor layers 634a and 634b are stacked over the insulating layer 603. The oxide semiconductor layer 634c is provided in contact with a top surface of the oxide semiconductor layer 634b and top and side surfaces of the pair of electrodes 605a and 605b.

The oxide semiconductor layers 634a and 634c can have a structure similar to that of the oxide semiconductor layer 614a shown in the transistor 610, for example. The oxide semiconductor layer 624b can have a structure similar to that of the oxide semiconductor layer 614b shown in the transistor 610, for example.

For example, when an oxide with a high content of Ga serving as a stabilizer is used for the oxide semiconductor layer 634a placed below the oxide semiconductor layer 634b and the oxide semiconductor layer 634c placed over the oxide semiconductor layer 634b, oxygen can be prevented from being released from the oxide semiconductor layers 634a to 634c.

For example, in the case where a channel is formed mainly in the oxide semiconductor layer 634b, the on-state current of the transistor 630 can be increased when an oxide with a high content of In is used for the oxide semiconductor layer 634b and the pair of electrodes 605a and 605b is provided in contact with the oxide semiconductor layer 634b.

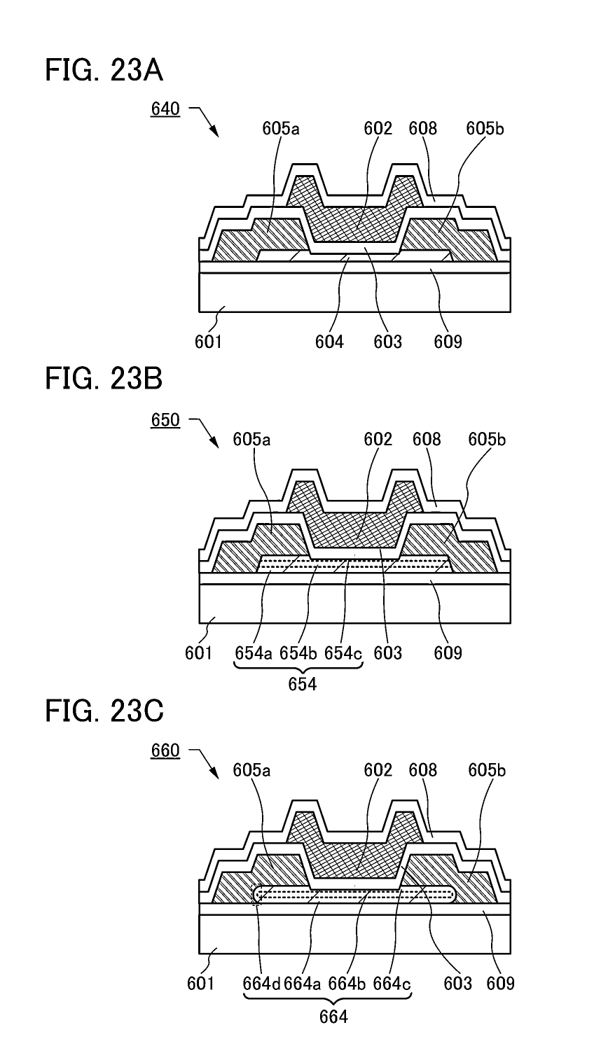

FIGS. 23A to 23C illustrate a top-gate top-contact transistor, which is one kind of top-gate transistor. Note that components having structures or functions similar to the above are denoted by the same reference numerals used above, and the description thereof is omitted below.

The transistor 640 illustrated in FIG. 23A includes the oxide semiconductor layer 604 over the substrate 601 provided with an insulating layer 609, the pair of electrodes 605a and 605b in contact with the top surface of the oxide semiconductor layer 604, the insulating layer 603 over the oxide semiconductor layer 604 and the pair of electrodes 605a and 605b, and the gate electrode 602 placed over the insulating layer 603 to overlap with the oxide semiconductor layer 604. An insulating layer 608 is provided to cover the insulating layer 603 and the gate electrode 602.

As the insulating layer 609, a silicon nitride film or a silicon nitride oxide film can be used, for example. The insulating layer 609 has a function of suppressing diffusion of impurities from the substrate 601 to the oxide semiconductor layer 604. Note that the insulating layer 609 is not necessarily provided when not needed.

As the insulating layer 608, a silicon nitride film or a silicon nitride oxide film can be used, for example. Like the insulating layer 607, the insulating layer 608 can be an insulating film having a blocking effect against oxygen, hydrogen, water, and the like. Note that the insulating layer 608 is not necessarily provided when not needed.

Examples of the structure of a transistor that is partly different from the transistor 640 will be described below.

FIG. 23B is a cross-sectional diagram of a transistor 650. The transistor 650 differs from the transistor 640 in the structure of the oxide semiconductor layer.

In an oxide semiconductor layer 654 included in the transistor 650, an oxide semiconductor layer 654a, an oxide semiconductor layer 654b, and an oxide semiconductor layer 654c are stacked in this order.

The oxide semiconductor film of one embodiment of the present invention can be used as at least one of the oxide semiconductor layers 654a to 654c.

The oxide semiconductor layer 654b can have a structure similar to that of the oxide semiconductor layer 614b, for example. The oxide semiconductor layers 654a and 654c can have a structure similar to that of the oxide semiconductor layer 614a, for example.

For example, when an oxide with a high content of Ga serving as a stabilizer is used for the oxide semiconductor layer 654a placed below the oxide semiconductor layer 654b and the oxide semiconductor layer 654c placed over the oxide semiconductor layer 654b, oxygen can be prevented from being released from the oxide semiconductor layers 654a to 654c.

When the oxide semiconductor layer 654 is formed in such a manner that the oxide semiconductor layers 654b and 654c are processed by etching so that an oxide semiconductor film to be the oxide semiconductor layer 654a is exposed and then the oxide semiconductor film is processed by dry etching to form the oxide semiconductor layer 654a, reaction products of the oxide semiconductor film are reattached to side surfaces of the oxide semiconductor layers 654b and 654c to form sidewall protection layers (also called rabbit ears) in some cases. Note that the reaction products may be reattached due to a sputtering phenomenon or plasma in the dry etching.

FIG. 23C is a cross-sectional schematic diagram of a transistor 660 in which a sidewall protection layer 664d is formed as a side surface of the oxide semiconductor layer 664 as described above.

The sidewall protection layer 664d mainly contains the same material as the oxide semiconductor layer 664a. Moreover, the sidewall protection layer 664d may contain a component (e.g., silicon) of a layer provided below the oxide semiconductor layer 664a (here, the insulating layer 609). A boundary between the oxide semiconductor layers 664a to 664c and the sidewall protection layer 664d is unclear in some cases. In such a case, the oxide semiconductor layers 664a to 664c and the sidewall protection layer 664d can be regarded as one layer. Alternatively, in the case where the boundary between the oxide semiconductor layers 664a to 664c and the sidewall protection layer 664d is clear, the oxide semiconductor layer can be regarded as a plurality of layers.

With a structure illustrated in FIG. 23C in which the side surface of the oxide semiconductor layer 664b is covered with the sidewall protection layer 664d so as not to be in contact with the pair of electrodes 605a and 605b, unintended off-state leakage current of a transistor is prevented from being generated particularly when a channel is formed mainly in the oxide semiconductor layer 664b; thus, a transistor with excellent off-state characteristics is achieved. In addition, with the use of a material with a high content of Ga serving as a stabilizer for the sidewall protection layer 664d, release of oxygen from the side surface of the oxide semiconductor layer 664b can be effectively suppressed, and a transistor with stable electrical characteristics can be provided.

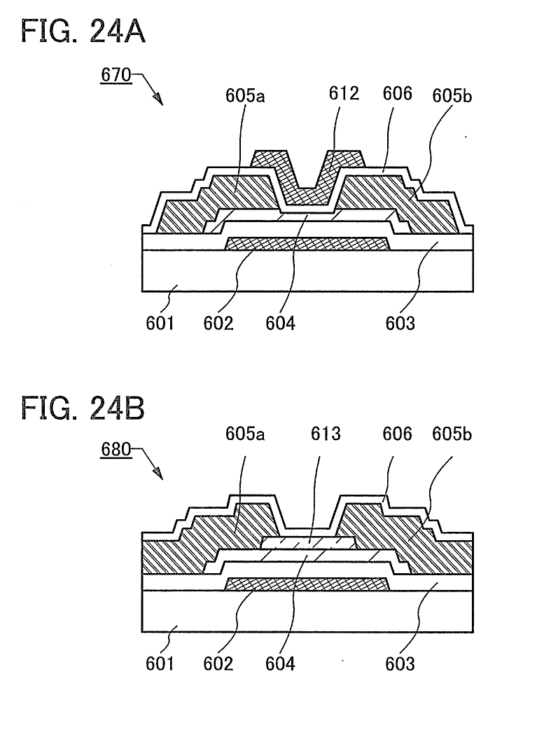

FIG. 24A illustrates a transistor 670 including a pair of gate electrodes with the oxide semiconductor layer 604 laid therebetween.

The transistor 670 includes the gate electrode 602 provided over the substrate 601, the insulating layer 603 provided over the substrate 601 and the gate electrode 602, the oxide semiconductor layer 604 overlapping with the gate electrode 602 with the insulating layer 603 laid therebetween, the pair of electrodes 605a and 605b provided in contact with the top surface of the oxide semiconductor layer 604, the insulating layer 606 covering the insulating layer 603, the oxide semiconductor layer 604, and the pair of electrodes 605a and 605b, and a gate electrode 612 overlapping with the oxide semiconductor layer 604 with the insulating layer 606 laid therebetween. The insulating layer 606 functions as a gate insulating film.

One of the gate electrodes 602 and 612 may be supplied with a signal for controlling whether to turn on or off the transistor, and the other gate electrode may be supplied with a ground potential or a fixed potential such as a negative potential. By controlling the level of the potential supplied to the other gate electrode, the threshold voltage of the transistor 660 can be controlled. By controlling the potentials of both gate electrodes as described above, a change in threshold voltage of the transistor can be further reduced. Thus, for example, the transistor can be prevented from becoming normally on.

FIG. 24B illustrates a transistor 680 including an insulating layer 613 which is in contact with the oxide semiconductor layer 604.

The transistor 680 includes the gate electrode 602 provided over the substrate 601, the insulating layer 603 provided over the substrate 601 and the gate electrode 602, the oxide semiconductor layer 604 overlapping with the gate electrode 602 with the insulating layer 603 laid therebetween, the insulating layer 613 provided to be in contact with the top surface of the oxide semiconductor layer 604, and the pair of electrodes 605a and 605b provided over the oxide semiconductor layer 604 and the insulating layer 613. The insulating layer 606 covering the insulating layer 603, the oxide semiconductor layer 604, the insulating layer 613, and the pair of electrodes 605a and 605b may be provided.

As the insulating layer 613, it is preferable to use an insulating film similar to the insulating layer 606, for example. As the insulating layer 613, an oxide insulating film containing oxygen at a proportion exceeding that of the stoichiometric composition is used. By heat treatment, part of oxygen contained in the insulating layer 613 can be released to be supplied to the oxide semiconductor layer 604. Accordingly, oxygen vacancies in the oxide semiconductor layer 604 can be filled with the oxygen, so that oxygen vacancies in the oxide semiconductor layer 604 can be reduced.

The insulating layer 613 prevents the oxide semiconductor layer 604 from being removed by etching for forming the pair of electrodes 605a and 605b, and prevents an impurity such as etching residue from entering into the oxide semiconductor layer 604.

The transistor 670 illustrated in FIG. 24A and the transistor 680 illustrated in FIG. 24B include a single-layer oxide semiconductor layer 604, for example. However, the oxide semiconductor layer 604 may be a stacked-layer oxide semiconductor layer as illustrated in FIGS. 22A to 22C.

This embodiment can be combined with any of the other embodiments disclosed in this specification as appropriate.

### Embodiment 10

Examples of a semiconductor and a semiconductor film that are preferably used for a channel formation region in the transistor exemplified in the above embodiment will be described below.

An oxide semiconductor has a wide energy gap of 3.0 eV or more. The energy gap is very wide compared to the band gap of silicon (1.1 eV). A transistor including an oxide semiconductor film obtained by formation of the oxide semiconductor in an appropriate condition and a sufficient reduction in carrier density of the oxide semiconductor can have much lower leakage current between a source and a drain in an off state (off-state current) than a conventional transistor including silicon.

When an oxide semiconductor film is used for the transistor, the thickness of the oxide semiconductor film ranges preferable from 2 nm to 40 nm.

An applicable oxide semiconductor preferably contains at least indium (In) or zinc (Zn). In particular, the oxide semiconductor preferably contains In and Zn. In addition, as a stabilizer for reducing variation in electrical characteristics of transistors using the oxide semiconductor, one or more elements selected from gallium (Ga), tin (Sn), hafnium (Hf), zirconium (Zr), titanium (Ti), scandium (Sc), yttrium (Y), and lanthanoid (such as cerium (Ce), neodymium (Nd), or gadolinium (Gd)) is preferably contained.

As the oxide semiconductor, any of the following can be used, for example: indium oxide, tin oxide, zinc oxide, In—Zn-based oxide, Sn—Zn-based oxide, Al—Zn-based oxide, Zn—Mg-based oxide, Sn—Mg-based oxide, In—Mg-based oxide, In—Ga-based oxide, In—Ga—Zn-based oxide (also referred to as IGZO), In—Al—Zn-based oxide, In—Sn—Zn-based oxide, Sn—Ga—Zn-based oxide, Al—Ga—Zn-based oxide, Sn—Al—Zn-based oxide, In—Hf—Zn-based oxide, In—Zr—Zn-based oxide, In—Ti—Zn-based oxide, In—Sc—Zn-based oxide, In—Y—Zn-based oxide, In—La—Zn-based oxide, In—Ce—Zn-based oxide, In—Pr—Zn-based oxide, In—Nd—Zn-based oxide, In—Sm—Zn-based oxide, In—Eu—Zn-based oxide, In—Gd—Zn-based oxide, In—Tb—Zn-based oxide, In—Dy—Zn-based oxide, In—Ho—Zn-based oxide, In—Er—Zn-based oxide, In—Tm—Zn-based oxide, In—Yb—Zn-based oxide, In—Lu—Zn-based oxide, In—Sn—Ga—Zn-based oxide, In—Hf—Ga—Zn-based oxide, In—Al—Ga—Zn-based oxide, In—Sn—Al—Zn-based oxide, In—Sn—Hf—Zn-based oxide, and In—Hf—Al—Zn-based oxide.

Here, an In—Ga—Zn-based oxide refers to an oxide containing In, Ga, and Zn as its main components and there is no particular limitation on the ratio of In, Ga, and Zn. The In—Ga—Zn-based oxide may contain a metal element other than In, Ga, and Zn.

Alternatively, a material represented by InMO₃(ZnO)ₘ (m is larger than 0 and is not an integer) may be used as the oxide semiconductor. Note that M represents one or more metal elements selected from Ga, Fe, Mn, and Co, or any of the above-described elements as a stabilizer. Alternatively, as the oxide semiconductor, a material expressed by In₂SnO₅(ZnO)ₙ (n is larger than 0 and is a natural number) may be used.

For example, it is possible to use an In—Ga—Zn-based oxide with an atomic ratio of In:Ga:Zn=1:1:1, In:Ga:Zn=1:3:2, In:Ga:Zn=3:1:2, or In:Ga:Zn=2:1:3, or an oxide whose atomic ratio is in the neighborhood of the above compositions.

If the oxide semiconductor film contains a large amount of hydrogen, the hydrogen and the oxide semiconductor are bonded to each other, so that part of the hydrogen serves as a donor and causes generation of an electron which is a carrier. As a result, the threshold voltage of the transistor shifts in the negative direction. Therefore, after formation of the oxide semiconductor film, dehydration treatment (dehydrogenation treatment) is preferably performed to remove hydrogen or moisture from the oxide semiconductor film so that the oxide semiconductor film is highly purified to contain impurities as little as possible.

Note that oxygen in the oxide semiconductor film is also reduced by the dehydration treatment (dehydrogenation treatment) in some cases. Accordingly, it is preferable that oxygen be added to the oxide semiconductor film to fill oxygen vacancies increased by the dehydration treatment (dehydrogenation treatment). In this specification and the like, supplying oxygen to an oxide semiconductor film may be expressed as oxygen adding treatment, and making the oxygen content of an oxide semiconductor film in excess of that in the stoichiometric composition may be expressed as treatment for making an oxygen-excess state.

In this manner, hydrogen or moisture is removed from the oxide semiconductor film by the dehydration treatment (dehydrogenation treatment) and oxygen vacancies therein are repaired by the oxygen adding treatment, so that the oxide semiconductor film can be an i-type (intrinsic) oxide semiconductor film or a substantially i-type (intrinsic) oxide semiconductor film which is extremely close to an i-type oxide semiconductor film. Note that “substantially intrinsic” means that the oxide semiconductor film includes extremely few (close to zero) carriers derived from a donor and has a carrier density of 1×10¹⁷/cm³ or lower, 1×10¹⁶/cm³ or lower, 1×10¹⁵/cm³ or lower, 1×10¹⁴/cm³ or lower, or 1×10¹³/cm³ or lower.

Thus, the transistor including an i-type or substantially i-type oxide semiconductor film can have excellent off-state current characteristics. For example, the drain current of the transistor including an oxide semiconductor film in an off state can be 1×10⁻¹⁸ A or less, preferably 1×10⁻²¹ A or less, more preferably 1×10⁻²⁴ A or less at room temperature (about 25° C.) or 1×10⁻¹⁵ A or less, preferably 1×10⁻¹⁸ A or less, more preferably 1×10⁻²¹ A or less at 85° C. Note that the off state of an n-channel transistor refers to a state where the gate voltage is sufficiently lower than the threshold voltage. Specifically, the transistor is in an off state when the gate voltage is lower than the threshold voltage by 1 V or more, 2 V or more, or 3 V or more.

A structure of an oxide semiconductor film will be described below.

An oxide semiconductor film is classified roughly into a single-crystal oxide semiconductor film and a non-single-crystal oxide semiconductor film. The non-single-crystal oxide semiconductor film includes any of a c-axis aligned crystalline oxide semiconductor (CAAC-OS) film, a polycrystalline oxide semiconductor film, a microcrystalline oxide semiconductor film, an amorphous oxide semiconductor film, and the like.

First, a CAAC-OS film will be described.

The CAAC-OS film is one of oxide semiconductor films having a plurality of c-axis aligned crystal parts.

In a transmission electron microscope (TEM) image of the CAAC-OS film, a boundary between crystal parts, that is, a grain boundary is not clearly observed. Thus, in the CAAC-OS film, a reduction in electron mobility due to the grain boundary is less likely to occur.

According to the TEM image of the CAAC-OS film observed in a direction substantially parallel to a sample surface (cross-sectional TEM image), metal atoms are arranged in a layered manner in the crystal parts. Each layer of metal atoms has a morphology reflected by a surface over which the CAAC-OS film is formed (hereinafter, a surface over which the CAAC-OS film is formed is referred to as a formation surface) or a top surface of the CAAC-OS film, and is arranged in parallel to the formation surface or the top surface of the CAAC-OS film.

In this specification, the term “parallel” indicates that the angle formed between two straight lines ranges from −10° to 10°, and accordingly also includes the case where the angle ranges from −5° to 5°. In addition, the term “perpendicular” indicates that the angle formed between two straight lines ranges from 80° to 100°, and accordingly includes the case where the angle ranges from 85° to 95°.

In this specification, the trigonal and rhombohedral crystal systems are included in the hexagonal crystal system.

On the other hand, according to the TEM image of the CAAC-OS film observed in a direction substantially perpendicular to the sample surface (plan TEM image), metal atoms are arranged in a triangular or hexagonal configuration in the crystal parts. However, there is no regularity of arrangement of metal atoms between different crystal parts.

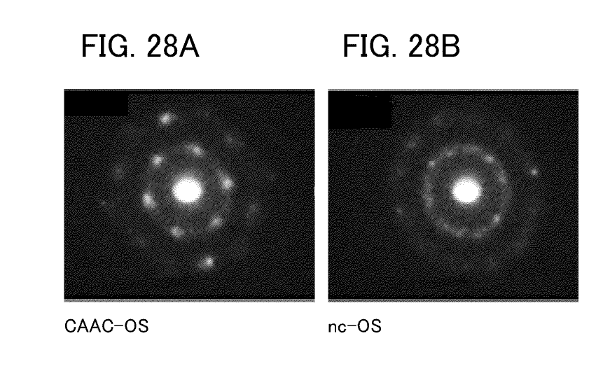

Note that in an electron diffraction pattern of the CAAC-OS film, spots (luminescent spots) having alignment are shown. Meanwhile, spots are shown in a nanobeam electron diffraction pattern of the top surface of the CAAC-OS film obtained by using an electron beam having a probe diameter ranging from 1 nm to 30 nm, for example (see FIG. 28A).

From the results of the cross-sectional TEM image and the plan TEM image, alignment is found in the crystal parts in the CAAC-OS film.

Most of the crystal parts included in the CAAC-OS film each fit inside a cube whose one side is less than 100 nm Thus, there is a case where a crystal part included in the CAAC-OS film fits inside a cube whose one side is less than 10 nm, less than 5 nm, or less than 3 nm Note that when a plurality of crystal parts included in the CAAC-OS film are connected to each other, one large crystal region is formed in some cases. For example, a crystal region with an area of 2500 nm² or more, 5 μm² or more, or 1000 μm² or more is observed in some cases in the plan TEM image.

A CAAC-OS film is subjected to structural analysis with an X-ray diffraction (XRD) apparatus. For example, when a CAAC-OS film including an InGaZnO₄ crystal is analyzed by an out-of-plane method, a peak appears frequently when the diffraction angle (2θ) is around 31°. This peak is derived from the (009) plane of the InGaZnO₄ crystal, which indicates that crystals in the CAAC-OS film have c-axis alignment, and that the c-axes are aligned in a direction substantially perpendicular to the formation surface or the top surface of the CAAC-OS film.

On the other hand, when the CAAC-OS film is analyzed by an in-plane method in which an X-ray enters a sample in a direction substantially perpendicular to the c-axis, a peak appears frequently when 2θ is around 56°. This peak is derived from the (110) plane of the InGaZnO₄ crystal. Here, analysis (φ scan) is performed under conditions where the sample is rotated around a normal vector of a sample surface as an axis (φ axis) with 2θ fixed at around 56°. In the case where the sample is a single-crystal oxide semiconductor film of InGaZnO₄, six peaks appear. The six peaks are derived from crystal planes equivalent to the (110) plane. On the other hand, in the case of a CAAC-OS film, a peak is not clearly observed even when φ scan is performed with 2θ fixed at around 56°.

According to the above results, in the CAAC-OS film having c-axis alignment, while the directions of a-axes and b-axes are different between crystal parts, the c-axes are aligned in a direction parallel to a normal vector of a formation surface or a normal vector of a top surface. Thus, each metal atom layer arranged in a layered manner observed in the cross-sectional TEM image corresponds to a plane parallel to the a-b plane of the crystal.

Note that the crystal part is formed concurrently with deposition of the CAAC-OS film or is formed through crystallization treatment such as heat treatment. As described above, the c-axis of the crystal is aligned in a direction parallel to a normal vector of a formation surface or a normal vector of a top surface. Thus, for example, in the case where the shape of the CAAC-OS film is changed by etching or the like, the c-axis might not be necessarily parallel to a normal vector of a formation surface or a normal vector of a top surface of the CAAC-OS film.

Distribution of c-axis aligned crystal parts in the CAAC-OS film is not necessarily uniform. For example, in the case where crystal growth leading to the crystal parts of the CAAC-OS film occurs from the vicinity of the top surface of the film, the proportion of the c-axis aligned crystal parts in the vicinity of the top surface is higher than that in the vicinity of the formation surface in some cases. Further, when an impurity is added to the CAAC-OS film, a region to which the impurity is added may be altered and the proportion of the c-axis aligned crystal parts in the CAAC-OS film might vary depending on regions.

Note that when the CAAC-OS film with an InGaZnO₄ crystal is analyzed by an out-of-plane method, a peak of 2θ may also be observed at around 36°, in addition to the peak of 2θ at around 31°. The peak of 2θ at around 36° indicates that a crystal having no c-axis alignment is included in part of the CAAC-OS film. It is preferable that in the CAAC-OS film, a peak of 2θ appear at around 31° and a peak of 2θ do not appear at around 36°.

The CAAC-OS film is an oxide semiconductor film having low impurity concentration. The impurity is an element other than the main components of the oxide semiconductor film, such as hydrogen, carbon, silicon, or a transition metal element. In particular, an element that has higher bonding strength to oxygen than a metal element included in the oxide semiconductor film, such as silicon, disturbs the atomic arrangement of the oxide semiconductor film by depriving the oxide semiconductor film of oxygen and causes a decrease in crystallinity. Further, a heavy metal such as iron or nickel, argon, carbon dioxide, or the like has a large atomic radius (molecular radius), and thus disturbs the atomic arrangement of the oxide semiconductor film and causes a decrease in crystallinity when it is contained in the oxide semiconductor film. Note that the impurity contained in the oxide semiconductor film might serve as a carrier trap or a carrier generation source.

The CAAC-OS film is an oxide semiconductor film having a low density of defect states. In some cases, oxygen vacancies in the oxide semiconductor film serve as carrier traps or serve as carrier generation sources when hydrogen is captured therein.

The state in which impurity concentration is low and density of defect states is low (the number of oxygen vacancies is small) is referred to as a “highly purified intrinsic” or “substantially highly purified intrinsic” state. A highly purified intrinsic or substantially highly purified intrinsic oxide semiconductor film has few carrier generation sources, and thus can have a low carrier density. Therefore, a transistor including the oxide semiconductor film rarely has negative threshold voltage (is rarely normally on). The highly purified intrinsic or substantially highly purified intrinsic oxide semiconductor film has a low density of defect states, and thus has few carrier traps. Accordingly, the transistor including the oxide semiconductor film has little variation in electrical characteristics and high reliability. Electric charge trapped by the carrier traps in the oxide semiconductor film takes a long time to be released and might behave like fixed electric charge. Thus, the transistor including the oxide semiconductor film having high impurity concentration and a high density of defect states has unstable electrical characteristics in some cases.

With the use of the CAAC-OS film in a transistor, variation in the electrical characteristics of the transistor due to irradiation with visible light or ultraviolet light is small.

Next, a microcrystalline oxide semiconductor film will be described.

In an image obtained with the TEM, crystal parts cannot be found clearly in the microcrystalline oxide semiconductor film in some cases. In most cases, a crystal part in the microcrystalline oxide semiconductor film ranges from 1 nm to 100 nm, or from 1 nm to 10 nm. A microcrystal with a size ranging from 1 nm to 10 nm or from 1 nm to 3 nm is specifically referred to as nanocrystal (nc). An oxide semiconductor film including nanocrystal is referred to as an nc-OS (nanocrystalline oxide semiconductor) film. In an image obtained with the TEM, a crystal grain cannot be found clearly in the nc-OS film in some cases.

In the nc-OS film, a microscopic region (e.g., a region with a size ranging from 1 nm to 10 nm, in particular, a region with a size ranging from 1 nm to 3 nm) has a periodic atomic order. Further, there is no regularity of crystal orientation between different crystal parts in the nc-OS film; thus, the orientation of the whole film is not observed. Accordingly, in some cases, the nc-OS film cannot be distinguished from an amorphous oxide semiconductor film depending on an analysis method. For example, when the nc-OS film is subjected to structural analysis by an out-of-plane method with an XRD apparatus using an X-ray having a diameter larger than that of a crystal part, a peak indicating a crystal plane does not appear. Further, a halo pattern is shown in a selected-area electron diffraction pattern of the nc-OS film obtained by using an electron beam having a probe diameter (e.g., 50 nm or larger) larger than the diameter of a crystal part. Meanwhile, spots are shown in a nanobeam electron diffraction pattern of the nc-OS film obtained by using an electron beam having a probe diameter close to or smaller than the diameter of a crystal part. Further, in a nanobeam electron diffraction pattern of the nc-OS film, regions with high luminance in a circular (ring) pattern are shown in some cases. Moreover, in a nanobeam electron diffraction pattern of the nc-OS film, a plurality of spots are shown in a ring-like region in some cases (see FIG. 28B).

Since the nc-OS film is an oxide semiconductor film having more regularity than the amorphous oxide semiconductor film, the nc-OS film has a lower density of defect levels than the amorphous oxide semiconductor film. However, there is no regularity of crystal orientation between different crystal parts in the nc-OS film; hence, the nc-OS film has a higher density of defect states than the CAAC-OS film.

Note that an oxide semiconductor film may be a stacked film including two or more films of an amorphous oxide semiconductor film, a microcrystalline oxide semiconductor film, and a CAAC-OS film, for example.

In the case where the oxide semiconductor film has a plurality of structures, nanobeam electron diffraction enables analysis of the structure in some cases.

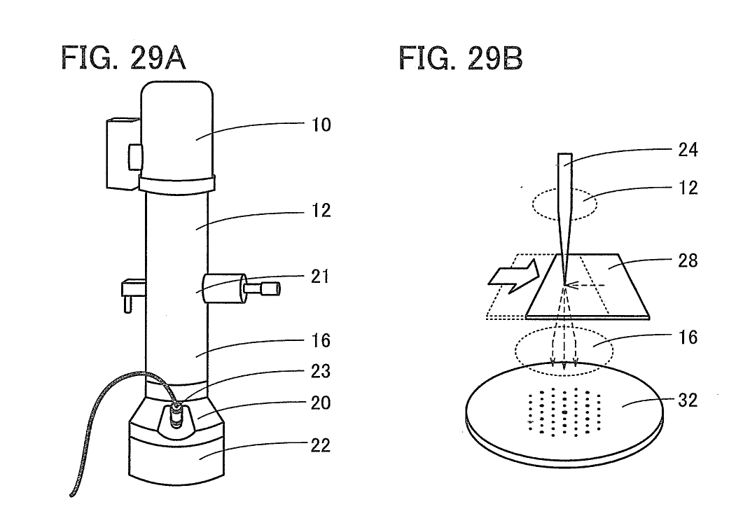

FIG. 29A illustrates a transmission electron diffraction measurement apparatus. The transmission electron diffraction measurement apparatus includes an electron gun chamber 10, an optical system 12 below the electron gun chamber 10, a sample chamber 21 below the optical system 12, an optical system 16 below the sample chamber 21, an observation chamber 20 below the optical system 16, a camera 23 provided for the observation chamber 20, and a film chamber 22 below the observation chamber 20. The camera 23 is toward the inside of the observation chamber 20. Note that the film chamber 22 is not necessarily provided.

FIG. 29B illustrates the inside structure of the transmission electron diffraction measurement apparatus illustrated in FIG. 29A. In the transmission electron diffraction measurement apparatus, a substance 28 provided in the sample chamber 21 is irradiated with electrons ejected from an electron gun provided in the electron gun chamber 10 through the optical system 12. Electrons passing through the substance 28 enter a fluorescent plate 32 provided in the observation chamber 20 through the optical system 16. On the fluorescent plate 32, a pattern corresponding to the intensity of entered electron appears, which allows measurement of a transmission electron diffraction pattern.

The camera 23 is set toward the fluorescent plate 32 so that a pattern on the fluorescent plate 32 can be taken. An angle formed by a straight line which passes through the center of a lens of the camera 23 and the center of the fluorescent plate 32 and an upper surface of the fluorescent plate 32 is, for example, 15° or more and 80° or less, 30° or more and 75° or less, or 45° or more and 70° or less. The smaller the angle becomes, the larger the distortion of a transmission electron diffraction pattern taken by the camera 23 becomes. Note that if the angle is obtained in advance, the distortion of an obtained transmission electron diffraction pattern can be corrected. Note that the camera 23 can be provided in the film chamber 22 in some cases. For example, the camera 23 may be provided in the film chamber 22 so that the lens of the camera 23 faces the direction to where an electron 24 enters. In this case, a transmission electron diffraction pattern with less distortion can be taken from the rear surface of the fluorescent plate 32.

A holder for fixing the substance 28 which is a sample is provided in the sample chamber 21. The holder transmits electrons passing through the substance 28. The holder may have, for example, a function of moving the substance 28 in the direction of the X, Y, and Z axes. The movement function of the holder may have an accuracy of moving the substance in the range of, for example, 1 nm to 10 nm, 5 nm to 50 nm, 10 nm to 100 nm, 50 nm to 500 nm, and 100 nm to 1 μm. The range is preferably determined to be an optimal range for the structure of the substance 28.

Then, a method for measuring a transmission electron diffraction pattern of a substance by the transmission electron diffraction measurement apparatus described above will be described.

For example, as illustrated in FIG. 29B, by changing (scanning) a portion irradiatied with of the electron 24, which is nanobeam, on the substance, change in the structure of the substance can be checked. At this time, when the substance 28 is a CAAC-OS film, a diffraction pattern shown in FIG. 28A can be observed. When the substance 28 is an nc-OS film, a diffraction pattern shown in FIG. 28B can be observed.

Even when the substance 28 is a CAAC-OS film, a diffraction pattern similar to that of an nc-OS film or the like is partly observed in some cases. Therefore, whether or not a CAAC-OS film is favorable can be determined by the prorportion of a region where a diffraction pattern of a CAAC-OS film is observed in a predetermined area (also referred to as proportion of CAAC). For example, in the case of a favorable CAAC-OS film, the proportion of CAAC is 60% or higher, preferably 80% or higher, further preferably 90% or higher, still preferably 95% or higher. Note that a region where a diffraction pattern different from that of a CAAC-OS film is observed is referred to as the proportion of not-CAAC.

As an example, transmission electron diffraction patterns were obtained by scanning the top surfaces of samples. One of the samples had a CAAC-OS film immediately after film formation (referred to as as-depo), after heat treatment at 350° C., or after heat treatment at 450° C. Here, the proportion of CAAC was obtained in such a manner that diffraction patterns were observed by scanning for 60 seconds at a rate of 5 nm/second and the obtained diffraction patterns were converted into still images every 0.5 seconds. Note that as an electron beam, a nanobeam with a probe diameter of 1 nm was used.

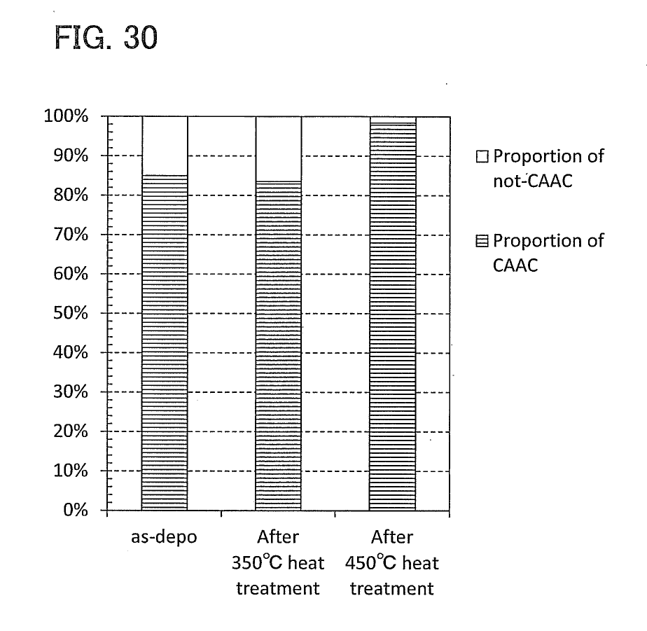

FIG. 30 shows the proportion of CAAC of the samples. The proportion of CAAC of the sample after heat treatment at 450° C. is high compared to those of the sample of as-depo and the sample after heat treatment at 350° C. That is, by heat treatment at a temperature higher than 350° C. (for example, 400° C. or higher), the proportion of not-CAAC is lowered (the proportion of CAAC is increased). Here, most of diffraction patterns different from that of a CAAC-OS film are diffraction patterns similar to that of an nc-OS film. Accordingly, by heat treatment, a region having a structure similar to an nc-OS film is affected by the structure of an adjacent region, and becomes a CAAC region.

With such a measurement method, the structure of an oxide semiconductor film having a plurality of structures can be analyzed in some cases.

With the use of the CAAC-OS film in a transistor, change in electric characteristics of the transistor due to irradiation with visible light or ultraviolet light is small. Thus, the transistor has high reliability.

For example, a CAAC-OS film can be deposited by sputtering using a polycrystalline oxide semiconductor sputtering target. When ions collide with the sputtering target, a crystal region included in the sputtering target may be separated from the target along an a-b plane; in other words, a sputtered particle having a plane parallel to an a-b plane (flat-plate-like sputtered particle or pellet-like sputtered particle) may flake off from the sputtering target. In this case, the flat-plate-like sputtered particle or the pellet-like sputtered particle reaches a surface where the CAAC-OS film is to be deposited while maintaining its crystal state, whereby the CAAC-OS film can be deposited.

The flat-plate-like sputtered particle has, for example, an equivalent circular diameter of a plane parallel to the a-b plane of 3 nm to 10 nm, and a thickness (length in the direction perpendicular to the a-b plane) of 0.7 nm or more and less than 1 nm. Note that in the flat-plate-like sputtered particle, the plane parallel to the a-b plane may be a regular triangle or a regular hexagon. Here, the term “equivalent circular diameter” refers to a diameter of a perfect circle having the same area as the plane.

For the deposition of the CAAC-OS film, the following conditions are preferably used.

By increasing the substrate temperature during the deposition, migration of the flat-plate-like sputtered particle that has reached the substrate occurs, so that a flat plane of the sputtered particle is attached to the substrate. At this time, the sputtered particle is charged positively, whereby sputtered particles are attached to the substrate while repelling each other; thus, the sputtered particles do not overlap with each other randomly, and a CAAC-OS film with a uniform thickness can be deposited. Specifically, the substrate temperature during the deposition ranges preferably from 100° C. to 740° C., more preferably from 200° C. to 500° C.

Decay of the crystal state due to impurities can be prevented by a reduction in the amount of impurities entering the CAAC-OS film during the deposition, for example, by a reduction in the concentration of impurities (e.g., hydrogen, water, carbon dioxide, and nitrogen) in the deposition chamber or in a deposition gas. Specifically, a deposition gas with a dew point of −80° C. or lower, preferably −100° C. or lower is used.

It is preferable that the proportion of oxygen in the deposition gas be increased and the power be optimized in order to reduce plasma damage during the deposition. The proportion of oxygen in the deposition gas is 30 vol % or higher, preferably 100 vol %.

After the CAAC-OS film is deposited, heat treatment may be performed. The temperature of the heat treatment ranges from 100° C. to 740° C., preferably from 200° C. to 500° C. Further, the heat treatment is performed for 1 minute to 24 hours, preferably 6 minutes to 4 hours. The heat treatment can be performed in an inert atmosphere or an oxidation atmosphere. It is preferable to perform heat treatment in an inert atmosphere and then perform heat treatment in an oxidation atmosphere. The heat treatment in an inert atmosphere can reduce the concentration of impurities in the CAAC-OS film in a short time. At the same time, the heat treatment in an inert atmosphere may generate oxygen vacancies in the CAAC-OS film. In this case, the heat treatment in an oxidation atmosphere can reduce the oxygen vacancies. The heat treatment can further increase the crystallinity of the CAAC-OS film. Note that the heat treatment may be performed under a reduced pressure of 1000 Pa or less, 100 Pa or less, 10 Pa or less, or 1 Pa or less. The heat treatment under a reduced pressure can reduce the concentration of impurities in the CAAC-OS film in a shorter time.

As an example of the sputtering target, an In—Ga—Zn—O compound target is described below.

The polycrystalline In—Ga—Zn—O compound target is made by mixing InOₓ powder, GaO_{Y} powder, and ZnO_{Z} powder in a predetermined molar ratio, applying pressure, and performing heat treatment at a temperature of 1000° C. to 1500° C. Note that X, Y, and Z are each a given positive number. Here, the predetermined molar ratio of InO_{X} powder to GaO_{Y} powder and ZnO_{Z} powder is, for example, 1:1:1, 1:1:2, 1:3:2, 1:9:6, 2:1:3, 2:2:1, 3:1:1, 3:1:2, 3:1:4, 4:2:3, 8:4:3, or a ratio close to these ratios. Note that the kinds of powder and the molar ratio for mixing powder can be determined as appropriate depending on the desired sputtering target.

Alternatively, the CAAC-OS film may be formed in the following manner.

First, a first oxide semiconductor film is formed to a thickness of greater than or equal to 1 nm and less than 10 nm. The first oxide semiconductor film is formed by sputtering. Specifically, the substrate temperature during the deposition ranges from 100° C. to 500° C., preferably from 150° C. to 450° C., and the proportion of oxygen in the deposition gas is 30 vol % or higher, preferably 100 vol %.

Next, the first oxide semiconductor film is subjected to heat treatment to be a first CAAC-OS film with high crystallinity. The heat treatment is performed at a temperature ranging from 350° C. to 740° C., preferably from 450° C. to 650° C. Further, the heat treatment is performed for 1 minute to 24 hours, preferably 6 minutes to 4 hours. The heat treatment can be performed in an inert atmosphere or an oxidation atmosphere. It is preferable to perform heat treatment in an inert atmosphere and then perform heat treatment in an oxidation atmosphere. The heat treatment in an inert atmosphere can reduce the concentration of impurities in the first oxide semiconductor film in a short time. At the same time, the heat treatment in an inert atmosphere may generate oxygen vacancies in the first oxide semiconductor film. In this case, the heat treatment in an oxidation atmosphere can reduce the oxygen vacancies. Note that the heat treatment may be performed under a reduced pressure of 1000 Pa or less, 100 Pa or less, 10 Pa or less, or 1 Pa or less. The heat treatment under a reduced pressure can reduce the concentration of impurities in the first oxide semiconductor film in a shorter time.

The first oxide semiconductor film with a thickness of greater than or equal to 1 nm and less than 10 nm can be easily crystallized by heat treatment compared to the case where the first oxide semiconductor film has a thickness of 10 nm or greater.

Next, a second oxide semiconductor film that has the same composition as the first oxide semiconductor film is formed to a thickness of 10 nm to 50 nm. The second oxide semiconductor film is formed by sputtering. Specifically, the substrate temperature during the deposition ranges from 100° C. to 500° C., preferably from 150° C. to 450° C., and the proportion of oxygen in the deposition gas is 30 vol % or higher, preferably 100 vol %.

Then, heat treatment is performed so that solid phase growth of the second oxide semiconductor film from the first CAAC-OS film occurs, whereby the second oxide semiconductor film is turned into a second CAAC-OS film having high crystallinity. The heat treatment is performed at a temperature ranging from 350° C. to 740° C., preferably from 450° C. to 650° C. Further, the heat treatment is performed for 1 minute to 24 hours, preferably 6 minutes to 4 hours. The heat treatment can be performed in an inert atmosphere or an oxidation atmosphere. It is preferable to perform heat treatment in an inert atmosphere and then perform heat treatment in an oxidation atmosphere. The heat treatment in an inert atmosphere can reduce the concentration of impurities in the second oxide semiconductor film in a short time. At the same time, the heat treatment in an inert atmosphere may generate oxygen vacancies in the second oxide semiconductor film. In this case, the heat treatment in an oxidation atmosphere can reduce the oxygen vacancies. Note that the heat treatment may be performed under a reduced pressure of 1000 Pa or less, 100 Pa or less, 10 Pa or less, or 1 Pa or less. The heat treatment under a reduced pressure can reduce the concentration of impurities in the second oxide semiconductor film in a shorter time.

As described above, the CAAC-OS film with a total thickness of 10 nm or greater can be formed.

Further, as described above, the oxide semiconductor film may have a structure in which a plurality of oxide semiconductor films are stacked.

For example, a structure may be employed in which, between an oxide semiconductor film (referred to as a first layer for convenience) and a gate insulating film, a second layer that is formed of constituent elements of the first layer and has an electron affinity lower than that of the first layer by 0.2 eV or more is provided. In this case, when an electric field is applied from the gate electrode, a channel is formed in the first layer but not formed in the second layer. Since the elements contained in the first layer are the same as those in the second layer, interface scattering at the interface between the first layer and the second layer hardly occurs. Thus, providing the second layer between the first layer and the gate insulating film can increase the field-effect mobility of the transistor.

When a silicon oxide film, a silicon oxynitride film, a silicon nitride oxide film, or a silicon nitride film is used as the gate insulating film, silicon included in the gate insulating film may be mixed into the oxide semiconductor film. If silicon is included in the oxide semiconductor film, crystallinity and carrier mobility of the oxide semiconductor film are decreased, for example. Thus, the second layer is preferably provided between the first layer and the gate insulating film to reduce the silicon concentration in the first layer where a channel is formed. For the same reason, it is preferable that a third layer which is formed of the constituent elements of the first layer and has an electron affinity lower than that of the first layer by 0.2 eV or more be provided and the first layer be sandwiched between the second layer and the third layer.

Such a structure makes it possible to reduce and even prevent diffusion of impurities such as silicon to a region where a channel is formed, so that a highly reliable transistor is obtained.

In order to form a CAAC-OS film as an oxide semiconductor film, the concentration of silicon in the oxide semiconductor film is set to 2.5×10²¹/cm³ or less. Preferably, the concentration of silicon in the oxide semiconductor film is less than 1.4×10²¹/cm³, preferably less than 4×10¹⁹/cm³, more preferably less than 2.0×10¹⁸/cm³. This is because the field-effect mobility of the transistor might be reduced when the concentration of silicon in the oxide semiconductor film is 1.4×10²¹/cm³ or more, and because the oxide semiconductor film might be made amorphous at the interface with a film in contact with the oxide semiconductor film when the concentration of silicon in the oxide semiconductor film is 4.0×10¹⁹/cm³ or more. Further, when the concentration of silicon in the oxide semiconductor film is less than 2.0×10¹⁸/cm³, improvement in reliability of the transistor and a reduction in the density of state (DOS) in the oxide semiconductor film can be expected. Note that the concentration of silicon in the oxide semiconductor film can be measured by secondary ion mass spectroscopy (SIMS).

This embodiment can be implemented in combination with any of the other embodiments described in this specification as appropriate.

### Embodiment 11

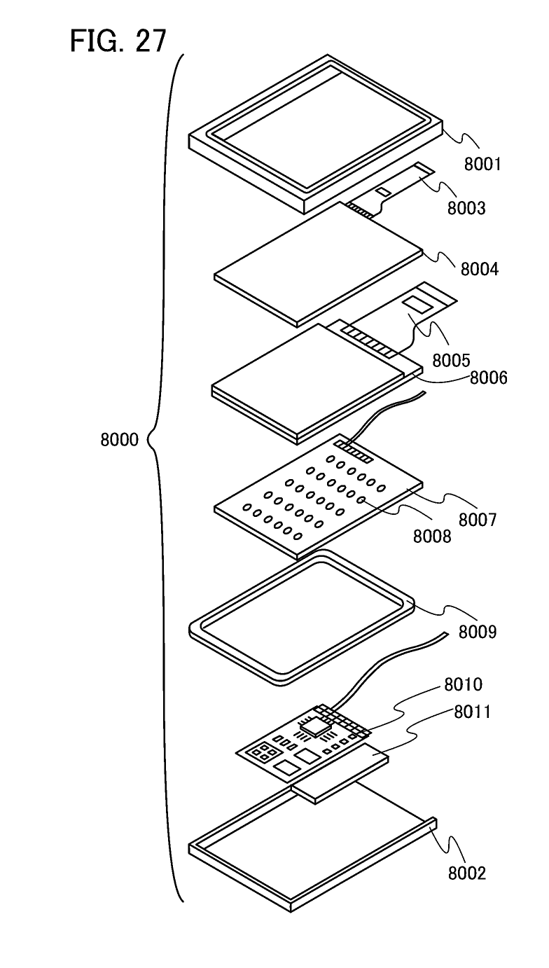

Next, a display module that can be formed using a display device of one embodiment of the present invention will be described with reference to FIG. 27.

In a display module 8000 in FIG. 27, a touch screen 8004 connected to an FPC 8003, a display panel 8006 connected to an FPC 8005, a backlight unit 8007, a frame 8009, a printed board 8010, and a battery 8011 are provided between an upper cover 8001 and a lower cover 8002.

The shapes and sizes of the upper cover 8001 and the lower cover 8002 can be changed as appropriate in accordance with the sizes of the touch screen 8004 and the display panel 8006.

The touch screen 8004 can be a resistive touch screen cell or a capacitive touch screen cell and may be formed to overlap with the display panel 8006. As the touch screen, the touch screen described in Embodiment 8 can be used. A counter substrate (sealing substrate) of the display panel 8006 can have a touch screen function. A photosensor may be provided in each pixel of the display panel 8006 and the touch screen 8004 can be an optical touch screen.

The backlight unit 8007 includes a light source 8008. The light source 8008 may be provided at an end portion of the backlight unit 8007 and a light diffusing plate may be used.

The frame 8009 protects the display panel 8006 and functions as an electromagnetic shield for blocking electromagnetic waves generated by the operation of the printed board 8010. The frame 8009 can function as a radiator plate.

The printed board 8010 is provided with a power supply circuit and a signal processing circuit for outputting a video signal and a clock signal. As a power source for supplying power to the power supply circuit, an external commercial power source or a power source using the battery 8011 provided separately may be used. The battery 8011 can be omitted in the case of using a commercial power source.

The display module 8000 can be additionally provided with a member such as a polarizing plate, a retardation plate, or a prism sheet

Note that the structures and the like described in this embodiment can be combined as appropriate with any of the structures and the like described in the other embodiments and example.

### Embodiment 12

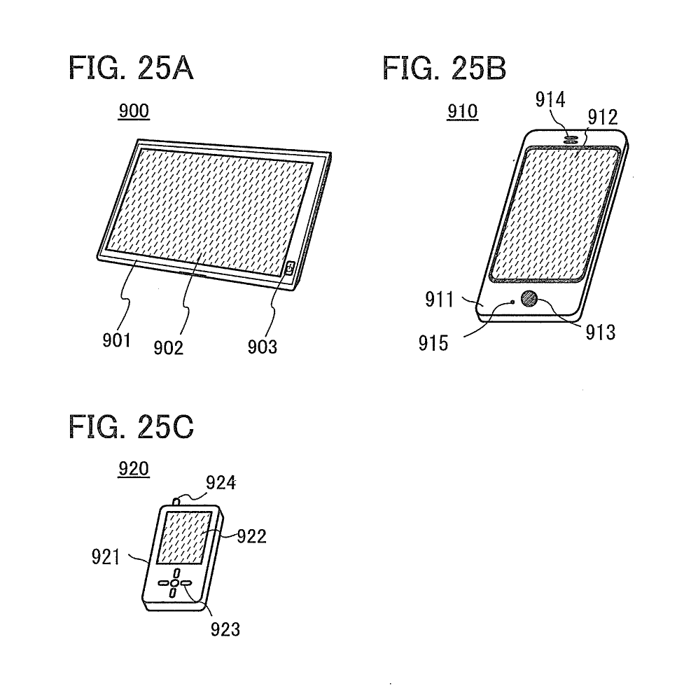

In this Embodiment, specific examples of electronic devices including the display device described in the above embodiment will be described with reference to FIGS. 25A to 25C.

Examples of electronic devices to which the display device of the present invention can be applied include a television device (also referred to as a television or a television receiver), a monitor of a computer and the like, cameras such as a digital camera and a digital video camera, a digital photo frame, a mobile phone, a portable game machine, a portable information terminal, a music reproducing device, a game machine (e.g., a pachinko machine and a slot machine), and a game console. Specific examples of these electronic devices are shown in FIGS. 25A to 25C.

FIG. 25A illustrates a portable information terminal 900 including a display portion. The portable information terminal 900 includes a display portion 902 and an operation button 903 that are incorporated in a housing 901. The display device of one embodiment of the present invention can be used for the display portion 902. By using the display device of one embodiment of the present invention for the display portion 902, the portable information terminal 900 where the frequency of rewriting images can be changed is obtained. Thus, the frequency of rewriting images can be once every several seconds. This enables the user to see the same one image as long as possible, so that flicker on the screen recognized by the user is reduced. Further, since the frequency at which the signal for selecting a pixel is output is reduced, the power consumption of the portable information terminal 900 can be reduced. This enables long-time use of the portable information terminal 900.

FIG. 25B illustrates a mobile phone 910. The mobile phone 910 includes a display portion 912, an operation button 913, a speaker 914, and a microphone 915 that are incorporated in a housing 911. The liquid crystal display device of one embodiment of the present invention can be used for the display portion 912. By using the display device of one embodiment of the present invention for the display portion 912, the mobile phone 910 where the frequency of rewriting images can be changed is obtained. Thus, the frequency of rewriting images can be once every several seconds. This enables the user to see the same one image as long as possible, so that flicker on the screen recognized by the user is reduced. Further, since the frequency at which the signal for selecting a pixel is output is reduced, the power consumption of the mobile phone 910 can be reduced. This enables long-time use of the mobile phone 910.

FIG. 25C illustrates a music reproducing device 920. The music reproducing device 920 includes a display portion 922, an operation button 923, and an antenna 924 that are incorporated in a housing 921. The antenna 924 transmits and receives data via a wireless signal. The liquid crystal display device of one embodiment of the present invention can be used for the display portion 922. By using the display device of one embodiment of the present invention for the display portion 922, the music reproducing device 920 where the frequency of rewriting images can be changed is obtained. Thus, the frequency of rewriting images can be once every several seconds. This enables the user to see the same one image as long as possible, so that flicker on the screen recognized by the user is reduced. Further, since the frequency at which the signal for selecting a pixel is output is reduced, the power consumption of the music reproducing device 920 can be reduced. This enables long-time use of the music reproducing device 920.

The display portions 902, 912, and 922 each have a touch input function. When a user touches a display button (not illustrated) that is displayed on the display portion 902, 912, or 922 with a finger or the like, the user can carry out operation on the screen and input of information.

The display portions 902, 912, and 922 each using the liquid crystal display device shown in the above embodiment can have higher display quality. As described above, usage of the display device shown in the above embodiment to the display portions 902, 912, and 922 enables the portable information terminal 900, the mobile phone 910, and the music reproducing device 920 with higher display quality.

This embodiment can be implemented in appropriate combination with any of the structures described in the other embodiments.

### Embodiment 13

In Embodiment 13, the significance of the reduction in the frame frequency (also referred to as refresh rate) described in the above embodiments will be explained.

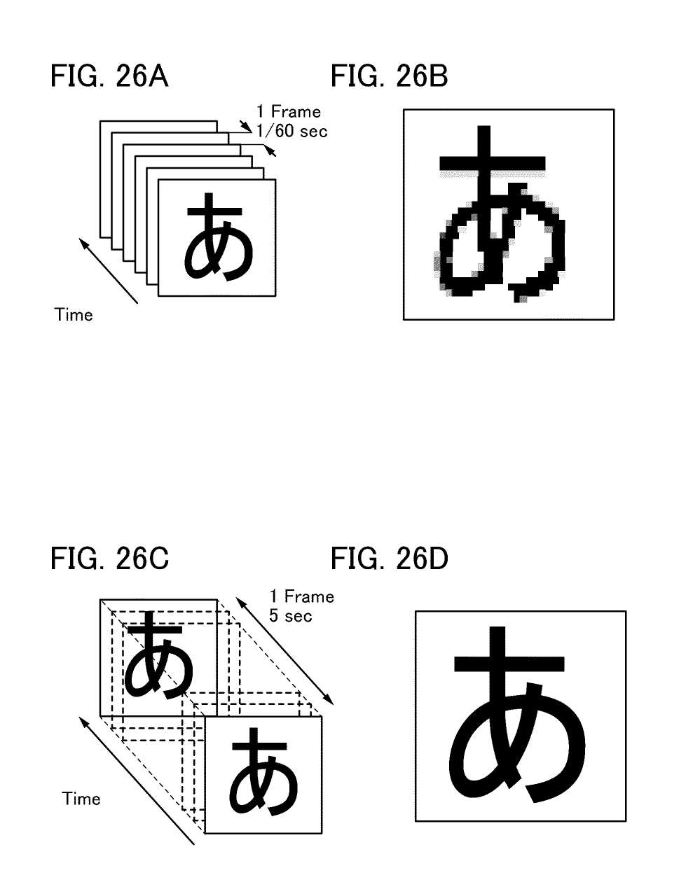

Eye fatigue is classified into two categories: nervous asthenopia and muscular asthenopia. FIGS. 26A and 26B are schematic diagrams used for describing eye fatigue.

Nervous asthenopia is fatigue caused when a user keeps seeing continuous or blinking display of a liquid crystal display device for a long time so that the brightness stimulates the retina and nerve of the eye and the brain. Frequent blinking of fluorescent light or a display portion of a conventional display device, which is called flicker, causes nervous asthenopia.

Muscular asthenopia is fatigue caused by overuse of the ciliary muscle, which is used to adjust the focus.

FIG. 26A is a schematic diagram showing display on a conventional liquid crystal display device. Images are rewritten 60 times per second for display on the conventional liquid crystal display device. When a user keeps watching such display for a long time, the retina and nerve of the eye and the brain may be stimulated and eye fatigue might be caused as a result.

When the size of one pixel is large (e.g., when the resolution is less than 150 ppi), a character displayed on the display portion of the display device is blurred as shown in FIG. 26B. When the user keeps watching blurred characters displayed on the display portion for a long time, difficulty in focusing persists even though the ciliary muscle keeps moving to focus on the characters; thus, strain might be put on the eyes.

There have been considered methods of measuring eye fatigue quantitatively. A known example of an evaluation index of nervous asthenopia is critical flicker (fusion) frequency (CFF). Examples of an evaluation index of muscular asthenopia are accommodation time and near point distance.

Other examples of a method of measuring eye fatigue are electroencephalography, thermography, measurement of the number of blinks, measurement of tear volume, evaluation of pupillary response speed, and a questionnaire to identify a subjective symptom.

The display of the display device of one embodiment of the present invention is described. FIGS. 26C and 26D are schematic diagrams used for describing the effect for less eye fatigue.

In the display device of one embodiment of the present invention, the frequency at which the signal for selecting a pixel is output can be changed. In particular, a transistor with extremely low off-state current is used in a pixel portion of a display portion; thus, frame frequency can be lowered while flicker is reduced. For example, an image can be rewritten as less frequently as once every five seconds. This enables the user to see the same one image, so that flicker on the screen recognized by the user is reduced. Thus, stimuli to the retina or nerve of the eye or the brain of the user are reduced, and nervous asthenopia is reduced accordingly (see FIG. 26C). Note that a transistor including an oxide semiconductor, particularly a transistor including a CAAC-OS is suitably used as a transistor with extremely low off-state current.

The display device of one embodiment of the present invention has pixels with a small size. Specifically, the display device is capable of display with a resolution as high as 150 ppi or more, preferably 200 ppi or more; thus, smooth, high-resolution images can be displayed. Consequently, the ciliary muscle can easily adjust focus on display, so that muscular asthenopia of the user is reduced (see FIG. 26D). Note that resolution can be expressed by pixel density (pixel per inch (ppi)). Pixel density is the number of pixels per inch. A pixel is a unit composing an image.

According to one embodiment of the present invention, an eye-friendly display device can be provided.

This application is based on Japanese Patent Application serial no.

2012-286865 filed with Japan Patent Office on Dec. 28, 2012, the entire contents of which are hereby incorporated by reference.

What is claimed is:

1. A display device comprising:
a display portion configured to display a still image at a frame frequency of 30 Hz or lower,
wherein the display portion comprises a driver circuit, a plurality of wirings, and a pixel portion,
wherein the pixel portion comprises a plurality of pixels,
wherein each of the plurality of pixels comprises a transistor, a display element, and a capacitor,
wherein a channel is formed in an oxide semiconductor layer included in the transistor,
wherein a gate of the transistor is electrically connected to one of the plurality of wirings, and
wherein the driver circuit performs scanning where the plurality of wirings in one of odd-numbered rows and even-numbered rows are sequentially selected and scanning where the plurality of wirings in the other of the odd-numbered rows and the even-numbered rows are sequentially selected.

2. The display device according to claim 1, wherein frame frequency is 0.2 Hz or lower.

3. The display device according to claim 1, wherein the display element is a liquid crystal element.

4. A display device comprising:
a display portion configured to display a still image at a frame frequency of 30 Hz or lower,
wherein the display portion comprises a first driver circuit, a second driver circuit, a plurality of first wirings, a plurality of second wirings, and a pixel portion,
wherein the pixel portion comprises a plurality of pixels,
wherein each of the plurality of pixels comprises a transistor, a display element, and a capacitor,
wherein a channel is formed in an oxide semiconductor layer included in the transistor,
wherein a gate of the transistor is electrically connected to one of the plurality of first wirings,
wherein a source or a drain of the transistor is electrically connected to one of the plurality of second wirings, and
wherein the first driver circuit performs scanning where the plurality of first wirings are sequentially selected and the second driver circuit performs scanning where the plurality of second wirings are sequentially selected.

5. The display device according to claim 2, wherein frame frequency is 0.2 Hz or lower.

6. The display device according to claim 2, wherein the display element is a liquid crystal element.

7. A display device comprising:
a display portion configured to display a still image at a frame frequency of 30 Hz or lower,
wherein the display portion comprises a first driver circuit, a second driver circuit, a plurality of wirings, and a pixel portion,
wherein the pixel portion comprises a plurality of pixels,
wherein each of the plurality of pixels comprises a transistor, a display element, and a capacitor,
wherein a channel is formed in an oxide semiconductor layer included in the transistor,
wherein a gate of the transistor is electrically connected to one of the plurality of wirings, and
wherein the first driver circuit performs scanning where the plurality of wirings in odd-numbered rows are sequentially selected, and
wherein the second driver circuit performs scanning where the plurality of wirings in even-numbered rows are sequentially selected.

8. The display device according to claim 7, wherein frame frequency is 0.2 Hz or lower.

9. The display device according to claim 7, wherein the display element is a liquid crystal element.
